(19) United States
(12) Patent Application Publication
(10) Pub. No.: US 2025/0345745 A1
(43) Pub. Date: Nov. 13, 2025

(54) Atmospheric Water Capturing Device, And Systems And Methods Of Using Same

(71) Applicant: The Board of Regents of the Nevada System of Higher Education on Behalf of the University of Nevada,, Las Vegas, NV (US)

(72) Inventors: Han-Jae Cho, Las Vegas, NV (US); Yiwei Gao, Las Vegas, NV (US); Ryan Phung, Las Vegas, NV (US)

(21) Appl. No.: 19/203,935

(22) Filed: May 9, 2025

Related U.S. Application Data
(60) Provisional application No. 63/644,758, filed on May 9, 2024.

(51) Int. Cl. B01D 53/26; B01D 3/02; B01D 53/28

(52) U.S. Cl. CPC B01D 53/268; B01D 3/02; B01D 53/28; B01D 2221/16; B01D 2257/80

(57) ABSTRACT

An atmospheric water capturing device for transforming water vapor into liquid water has a plurality of channels. The device further includes a plurality of hydrogel membranes. Each hydrogel membrane having a surface that at least partly defines a respective channel of the plurality of channels. A liquid desiccant is in contact with a side of each hydrogel membrane opposite the surface of the hydrogel membrane that at least partly defines the respective channel.

### CROSS-REFERENCE TO RELATED APPLICATIONS

This application claims priority to and the benefit of the filing date of U.S. Provisional Patent Application No. 63/644,758, filed May 9, 2024, the entirety of which is hereby incorporated by reference herein.

### FIELD

This disclosure relates to devices that are used to capture water vapor from ambient air and transform the water vapor into liquid form.

### BACKGROUND

Parts of the world are experiencing low water levels. For example, the Southwestern United States is experiencing the lowest water levels in 1,200 years. Atmospheric water harvesting, wherein water vapor from the ambient air is transformed into liquid form, may be used to compensate for low water levels. On a global scale, solar-powered atmospheric water harvesting may have the potential to provide water to around one billion people. Despite the availability of water vapor, there have been no demonstrated water capturing rates that near the solar or thermodynamic capabilities of water capturing, which indicates that there is a transport-limit issue restricting potential capturing rates. Here, transport may refer to the movement of water, energy, and chemicals through various media. Existing atmospheric water capturing approaches, rely on a single sorbent material that performs multiple roles of water capturing and/or harvesting sequentially. Because roles are performed sequentially rather than simultaneously, capture and/or harvesting rates are delayed. Clearly, atmospheric water capturing and/or harvesting may be improved to increase capture and/or harvesting rates.

### SUMMARY

Disclosed herein, in various aspects, an atmospheric water capturing device for transforming water vapor into liquid water, the device comprising a plurality of channels. The device further comprises a plurality of porous water-permeable membranes, each porous water-permeable membrane having a surface that at least partly defines a respective channel of the plurality of channels. A liquid desiccant is in contact with a side of each porous water-permeable membrane opposite the surface of the porous water-permeable membrane that at least partly defines the respective channel.

Also disclose herein is an atmospheric water capturing device for transforming water vapor into liquid water. The device may comprise a housing and a basin disposed within the housing. The housing may include an inlet configured to receive ambient atmosphere. The basin may comprise a first section, at least one channel, and a second section. The first section may be configured to wick water from the received ambient atmosphere. The at least one channel may be configured to store an ionic solution and the water wicked by the first section. The second section may be configured to evaporate water stored in the at least one channel.

A method of capturing atmospheric water with the atmospheric capturing device is also disclosed herein.

### BRIEF DESCRIPTION OF THE DRAWINGS

FIG. 1 is a drawing of a section of an exemplary atmospheric water capturing device as disclosed herein.

FIG. 2 is a graph of thermodynamic analysis of the exemplary atmospheric water capturing device of FIG. 1.

FIG. 3 is a diagram of an exemplary solar-powered water capturing device in a desert.

FIG. 4 is a diagram of performance goals of an exemplary atmospheric water capturing device as compared to existing atmospheric water capturing approaches.

FIG. 5a is a diagram of example natural models for capturing and evaporating water. FIB. 5b is a diagram showing the approach to capture and evaporator gels in an exemplary atmospheric water capturing device as inspired by natural membranes.

FIG. 6 shows an example custom environmental chamber to characterize the transport processes and 3D geometries of hydrogel samples.

FIG. 7 is a graph showing inverse trends between stiffness and permeability with changing crosslinker ratio of synthesized hydrogel samples.

FIGS. 8a and 8b are photographs of preliminary prototypes of water capturing setups.

FIG. 9 is a graph depicting historically low levels of water volume of Lake Mead.

FIG. 10a is a diagram of the mean daily rainfall in the United States. FIG. 10b shows a theoretical ideal water capturer. FIG. 10c shows potential water capture.

FIG. 11a is a graph showing existing atmospheric water capturing approaches are unable to capture water at rates or humidities that would impact dry communities and reach maximum solar limits. FIG. 11b is a graph showing that preliminary work of a prototype of the atmospheric water capturing device disclosed herein demonstrated capture at the lowest humidities of 10% RH.

FIG. 12 shows that existing approaches with solid-sorbent that fill up at nighttime and releases water in the daytime miss a capture opportunity during the daytime.

FIG. 13a is a diagram of example natural models for capturing and evaporating water. FIB. 13b is a diagram showing the approach to capture and evaporator gels in an exemplary atmospheric water capturing device as inspired by natural membranes. FIG. 13c shows at nighttime, water is captured through a gel and is stored in a basin filled with ionic solution. FIG. 13d shows in the daytime, the captured water is distilled through the evaporator gel via solar heating.

FIG. 14 is a diagram showing an approach to atmospheric water capturing as disclosed herein.

FIGS. 15a and 15b are graphs showing the chemical potentials at the capture gel (C), basin (B), and evaporator gel (E), and the captured liquid state (H). FIG. 15b shows that saturated ionic solution (e.g. LiBr) can lower the chemical potential of water and raise its boiling point.

FIG. 16 shows an example hydrogel, wherein hydrogels are a mesh of polymer strands with a pore size equivalent to the average spacing between strands, ¿.

FIGS. 17a-17c show results of a simplified multiphysics finite element method (FEM) simulation. FIG. 17a shows an ion concentration map which shows salt is distributed more at the evaporator. FIG. 17b shows a temperature map which shows there is a slight increase in temperature in the capture gel (due to exothermic condensation) and an elevated temperature at the evaporator from solar radiation. FIG. 17c shows a gel strain map which shows the accumulation of water leads to positive strain (swelling) at the capture gel and a release of water leads to a negative strain (shrinkage) at the evaporator.

FIG. 18 shows a custom environmental chamber that may enable characterization of the heat transfer and 3D geometry of hydrogel membranes.

FIG. 19 shows a photograph of preliminary observations of dropwise condensation on a prototype capture gel—an unexplored ion and hydrogel-mediated mechanism of vapor condensation.

FIGS. 20a and 20b show mechanical and permeability testing set ups suited for hydrogel characterization. FIG. 20c is a graph showing observed inverse trends between stiffness and permeability with changing crosslinker ration of a unique hydrogel formulation, polyacrylamide copolymerized with N-Isopropylacrylamide (PNI-co-AAm).

FIG. 21 shows a graph of preliminary modeling of condensation rate, evaporate rate and net water flux on a typical Las Vegas day in July considering temperature, humidity, and solar radiation.

FIGS. 22a and 22b are photographs of preliminary prototypes of water capturing setups.

FIG. 23 shows Table 1: Expected transport processes around gels and their comparisons quantified by dimensionless number.

FIG. 24 shows conventional approaches to conditioning air within an aircraft's environmental control system (ECS), including an air-water separator as a physical means to remove moisture from incoming air. FIG. 24 further shows a proposed solution utilizing high-surface area, fin-like structure of hydrogels to effectively capture moisture, dehumidify, and control temperature in a small footprint.

FIG. 25 shows a humidity-dependent dew point (red curve) determines whether moisture forms on surfaces. As long any surfaces inside the aircraft remain above the dew point, no moisture can form via condensation. Here, the air (dry-bulb) temperature is 25° C.

FIG. 26 shows ideal air conditions (temperature and relative humidity) as defined by standards listed in Table 2.

FIGS. 27A-27C show an overview of ECS systems. The proposed-gel-based system has a smaller footprint due to its multifunctional nature.

FIGS. 28A-28B show a working principle behind liquid desiccants for use as dehumidifiers (FIG. 28A and FIG. 28B humidifiers. This two-way phenomenon provides a natural, autonomic multifunctional behavior for self-regulation of humidity. Water vapor can condense into the salt solution when its relative humidity is higher than the equilibrium relative humidity of the solution (vapor chemical potential is higher than liquid chemical potential). The liquid water can evaporate in the opposite case. Here, the liquid is a saturated sodium bromide solution with an equilibrium humidity of 60%.

FIG. 29 shows a saturated potassium acetate solution (red curve) as a potential candidate for a liquid desiccant that could condition air to ideal air conditions.

FIGS. 30A-30B show a comparison between typical liquid desiccant systems for dehumidification versus the disclosed system. In the shown system, hydrogels are employed as a solid-state desiccant and allow background liquid desiccant to serve two roles: (1) providing the chemical potential sink for dehumidification (FIG. 30A) and (2) providing cooling (FIG. 30B. In typical systems, liquid desiccant must be sprayed through a complex heat exchanger design that flows water for cooling and allows for air to flow through it. The typical design is dependent on the orientation of gravity while the disclosed approach is independent of it.

FIG. 31 shows results of dehumidification through LiCl iongels indicating captured water increase.

FIGS. 32A-32C show a proposed iongel condenser concept with bulb geometry for dehumidification. FIG. 32A shows salt solution allows water to be condensed from the ambient.

FIG. 32B shows the iongels are attached to the substrate by pillars with embedded flow channels.

FIG. 32C shows iongels swell up in higher humidities, captured water from the humid air is osmotically driven into the solution.

FIG. 33 shows preliminary results of 2D FEM simulations of an iongel bulb at different relative humidities (RH) and with different relative permeabilities as quantified by the dimensionless group II (Equation 9). Below the equilibrium RH of 50%, the gel is shrunk (s<0) from its equilibrium state and water evaporates from it, humidifying the air. Above the equilibrium RH, the gel is swollen (s>0) and water condenses into the gel, dehumidifying the air.

FIG. 34 shows an overview of preliminary work with gels. (a) Gels and iongels are synthesized, and several material properties can be tuned. Developed capabilities allow for characterizing (b) mechanical stiffness with indentation testing, (c) water uptake at different humidities, and (d) wetting contact angle using custom imaging and image processing routines.

FIG. 35 shows an overview of multiphysics FEM simulation procedure that can be performed to solve transport within gels.

FIG. 36 shows a demonstration of extruded gel bulb array concept through polymer substrate.

FIG. 37 shows a map of a bio-inspired water harvesting concept. (a) None of the existing solar-based AWH state-of-the-art research or commercial devices meet the required performance to provide safely managed drinking water to 1 billion people as modeled by Lord et al. (green line; Eq. 11 Example 4). (b) Current (Gen I) AWH devices use a single monolithic material that only capture/store or release water at a time. To improve AWH performance, it is contemplated that (c) Gen II and (d) Gen III AWH devices can utilize a segregated, multi-material architecture as bio-inspired by (e) tree frogs and Tillandsia “airplants”. Here, a hydrogel membrane was developed for continuous and fast capture into a liquid-desiccant storage medium (bottom of (c) and (d))—a mass-transfer process was modeled using a (f) circuit analogy with a convective resistance in the ambient air (Rᵥₐₚ), a permeation resistance (R_{gel}) and a convective resistance in the liquid solution (Rₛₒₗ). Coupling capture/storage with a solar-powered release, such as a (c) single-stage distillation process or a (d) thermodynamically-limited distillation device, constitutes a complete AWH system where the harvesting rate is the minimum of capture and release rates. With some Gen II approaches already approaching the solar limit, the disclosed fast capture/storage approach is an important component that can enable solar-limited AWH.

FIG. 38 illustrates a schematic of lab-controlled water capture tests confirm near-convection-limited performance. (a) A scheme of indoor capture testing. Dry air is first humidified to a desired RH level using PID control. Humidified air with 10% to 60% RH flows into the 3D-printed wind tunnel, located underneath a gel membrane in contact with the liquid desiccant solution above it. (b) A clear volume change of the solution at a steady rate (57%, 0.9 m s⁻¹, 75 min) is shown (Supplementary Video). (c) A cross 12 individual indoor vapor capture tests with varied humidities and wind speeds, all data points collapse along predicted capture rates (dashed lines) within the range of uncertainties in velocity (+0.07 m s⁻¹ (1 SD); semi-transparent areas). Error bars represent 1 SD. The results confirm that the water capture and storage system is operating with convection-limited behavior and that mass transfer resistance through the gel can be neglected.

FIG. 39 shows outdoor water capture tests demonstrated high water capture in Las Vegas—the driest city in the United States. (a) Outdoor capture testing with a 50 mm diameter fan resulted in (b) 5.50 kgₘ_{²}d₋₁ over a 24 h period in late November of 2022. Only relying on natural wind without a fan resulted in 1.99 kg m⁻²d⁻¹. Throughout the testing periods, temperature and humidity varied as shown in (c) and (d).

FIG. 40 shows global implications of convection-limited water capture. (a) Simulated year-round water capture rates of a convection-limited water harvesting device with the same width as the disclosed prototype (W=38 mm) in Las Vegas relying on natural wind (blue) is within 88% of the solar limit (black). Doubling the wind speed (red), (e.g., forced convection) can result in capture fluxes that exceed the solar limit. Thus, a hypothetical one-square-meter device could provide two to three adults' daily drinking water. Plotted weather data from KLAS airport is obtained from Wolfram Research. (b) Convection-limited water capture potential globally was simulated, with certain regions exceeding 70 kg m⁻²d⁻¹ (dark green regions). (c) Lord et al. (8) presented a benchmark curve (green; Eq. 11, Example 5) for the required performance of an AWH device to provide safely managed drinking water (SMDW) to one billion people. Relying on natural wind at 1 m height, convection-limited water capture with a disclosed prototype width results in a range of fluxes (blue shaded region representing 95% of the global flux range) that generally exceed the performance required by Lord's curve. Error bars represent 1 SD.

FIG. 41 shows FTIR result of high-entanglement PAAm hydrogel sample. The crosslinker ratio of the sample is 0.1%.

FIG. 42 shows a schematic diagram of an atmospheric water capturing device as disclosed herein, the atmospheric water capturing device having multiple layers for capturing water.

FIG. 43 shows a perspective view of the atmospheric water capturing device as in FIG. 42.

FIG. 44 shows a 3D schematic diagram of an atmospheric water capturing device having a single layer and indicating certain components.

FIG. 45 shows a 3D schematic diagram of an atmospheric water capturing device having multiple layers and indicating direction of airflow.

FIG. 46 shows a schematic diagram of a full atmospheric water harvesting concept device that is simplified for illustrative purposes. A powered fan forces air through air channels. Hydrogel membranes that constitute the top and bottom surfaces of the air channels condense and transport captured water into the liquid desiccant solution. The liquid desiccant is circulated through a pump. Captured water adds to the volume of the liquid desiccant. At the top of the device, distillation occurs to produce distilled water from the captured water in desiccant. The desiccant is boiled with a cartridge heater and subsequently condensed into a condenser tube. The heat of condensation is removed via the liquid desiccant basin being circulated by the pump, which are ultimately cooled by the flowing air. Thus, the stack acts as both a capture device and a heat exchanger with the ambient environment.

FIG. 47 shows a perspective view of a complete atmospheric water harvesting device with fan, pump, and heater depicted.

FIGS. 48A-48C show sequential steps of a control scheme to ensure that distillation occurs only when the liquid level is above a minimum amount and capture occurs only when the liquid level is below a maximum amount.

FIG. 49 shows an operating principle of a single-layer capture device and a physical prototype already built that performs in this manner.

FIG. 50 is a schematic diagram of a hydrogen hub with electrolytic production, biochar-based storage, water-recovering fuel cell for power delivery, and low-impact, intelligent control.

FIG. 51 illustrates a prototype of air-sourced water-to-hydrogen electrolyzer operating in dry Las Vegas conditions and a plot showing measured performance with wind matches boundary layer theory without fitting.

### DETAILED DESCRIPTION

The present disclosure can be understood more readily by reference to the accompanying detailed description, which includes examples, claims and drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout. It is to be understood that this invention is not limited to the particular methodology and protocols described, as such may vary. It is also to be understood that the terminology used herein is for the purpose of describing particular embodiments only, and is not intended to limit the scope of the present invention.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

As used herein the singular forms “a,” “an,” and “the” can optionally include plural referents unless the context clearly dictates otherwise. For example, use of the term “a channel” can represent disclosure of embodiments in which only a single channel is provided, and unless the context dictates otherwise, can also represent disclosure of embodiments in which a plurality of such channels are provided.

All technical and scientific terms used herein have the same meaning as commonly understood to one of ordinary skill in the art to which this invention belongs unless clearly indicated otherwise.

As used herein, the terms “optional” or “optionally” mean that the subsequently described event or circumstance may or may not occur, and that the description includes instances where said event or circumstance occurs and instances where it does not.

As used herein, the term “at least one of” is intended to be synonymous with “one or more of.” For example, “at least one of A, B and C” explicitly includes only A, only B, only C, and combinations of each.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. Optionally, in some aspects, when values are approximated by use of the antecedent “about,” it is contemplated that values within up to 15%, up to 10%, up to 5%, or up to 1% (above or below) of the particularly stated value can be included within the scope of those aspects. Similarly, use of “substantially” (e.g., “substantially parallel”) or “generally” (e.g., “generally planar”) should be understood to include embodiments in which angles are within ten degrees, or within five degrees, or within one degree.

The word “or” as used herein means any one member of a particular list and, in alternative embodiments, unless context dictates otherwise, can include any combination of members of that list.

It is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

The following description supplies specific details in order to provide a thorough understanding. Nevertheless, the skilled artisan would understand that the apparatus, system, and associated methods of using the apparatus can be implemented and used without employing these specific details. Indeed, the apparatus, system, and associated methods can be placed into practice by modifying the illustrated apparatus, system, and associated methods and can be used in conjunction with any other apparatus and techniques conventionally used in the industry.

In the following description, various examples of atmospheric water capturing devices and methods are disclosed. It is contemplated that each of these embodiments can also be used for atmospheric water harvesting devices and methods. Further, it is understood that embodiments and examples of atmospheric water harvesting devices and methods can also be used for purposes of water capture.

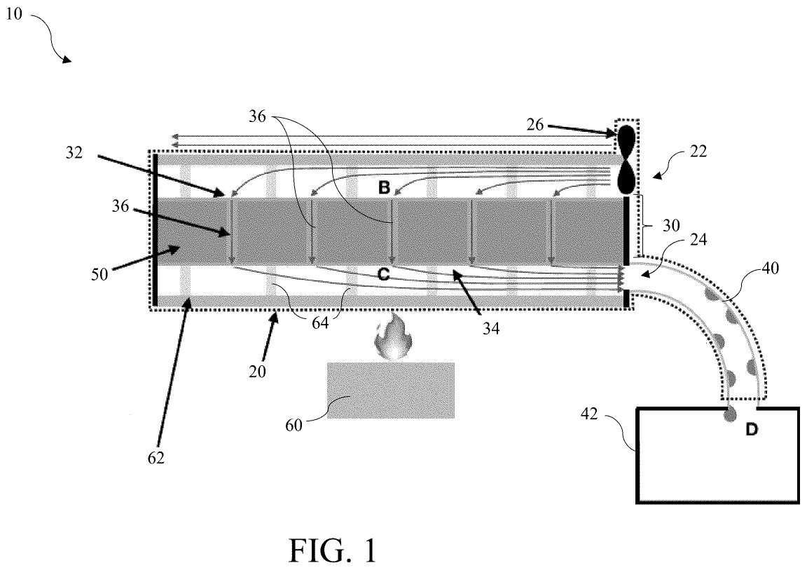

FIG. 1 shows an example atmospheric water capturing device 10. The atmospheric water capturing device 10 may be configured to transform water vapor into liquid water. Optionally, the device 10 may be powered by natural solar energy. In one aspect, the device may not comprise an electric power adapter. The device 10 may include vertically stacked components enabling simultaneous or substantially simultaneous water capture and distillation.

The device 10 may comprise a housing 20 including an inlet 22. The inlet 22 may be configured to receive ambient atmosphere. The housing 20 may include an air cooling device, such as a fan 26. The fan 26 can be proximate to the inlet 22 to cool the ambient atmosphere entering the housing. Optionally, the cooling device may be battery powered, solar powered, or thermoelectric-generator powered. In exemplary aspects, the housing can have a volume of about 0.7 liters. However, other volumes are contemplated.

The device 10 may further comprise a basin 30 disposed within the housing. The basin 30 may be configured to distill water vapor from the received ambient atmosphere. The basin 30 may include a first section 32 (e.g., on a first side of the basin 30) facing the ambient atmosphere that enters the housing. The first section 32 may be configured to wick water from the ambient atmosphere in the housing. Alternatively, the first section 32 may include a first membrane configured to wick water from the ambient atmosphere in the housing. The first section 32 (optionally, the first membrane) may comprise a capturing gel. The basin 30 may include at least one channel 36 configured to store an ionic solution and the water wicked by the first section (optionally, the first membrane). In some optional aspects, the basin 30 may have only a single channel 36. Optionally, the boundaries or perimeter of the single channel 36 may be the same or substantially the same as the basin 30 and/or housing 20. In other aspects, the basin 30 may include a plurality of channels 36. Optionally, the channel(s) 36 may include a porous hydrogel infused with the ionic solution. In one example, the ionic solution is lithium bromide. The channel(s) 36 may be surrounded by a thermal insulator 50. The thermal insulator can include, for example polystyrene foam. The basin 30 may include a second section 34 (e.g., positioned on a second side of the basin 30). The second section 34 may include a second membrane. The second section or the second membrane may comprise an evaporating gel. The second section 34 (e.g., optionally, the second membrane) may be configured to evaporate water stored in the at least one channel. Optionally, the second section may be oppositely disposed relative to the first section. For example, the first section 32 can be on a first side, and the second section 34 can be on the second side, wherein the second side is positioned opposite the first side.

The housing 20 of the device 10 may further comprise an outlet 24 configured to dispense the evaporated water. The device 10 may also include a condensing tube 40 connected to the outlet and configured to condense the evaporated water from the outlet 24. The device 10 may further comprise a reservoir 42 configured to store the condensed water. The reservoir 42 may be connected to the condensing tube 40.

The device 10 may also include an air heating device, such as a heater 60. The air heating device may be configured to heat the second section 34 (e.g., the second side) of the basin 30. In exemplary aspects, the heater 60 can comprise a fuel stove (e.g., a plurality of camping stoves, such as, for example STERNO camping stoves). In exemplary aspects, the heater can provide at least 100 watts (e.g., at least 150 watts, about 200 watts, or greater than 200 watts). The second section 34 can therefore be relatively hot, having a higher vapor pressure than the reservoir 42. In further aspects, the first section 32 can have a lower vapor pressure than ambient air. The device 10 can further comprise a heat spreader 62. The heat spreader 62 can comprise a plurality of fins 64. The heat spreader 62 can comprise a thermally conductive material (e.g., copper).

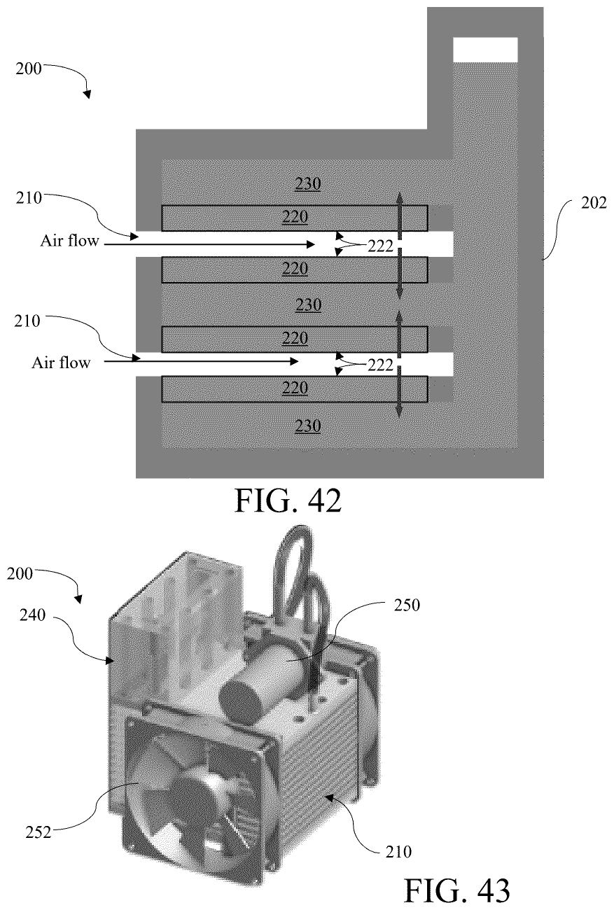

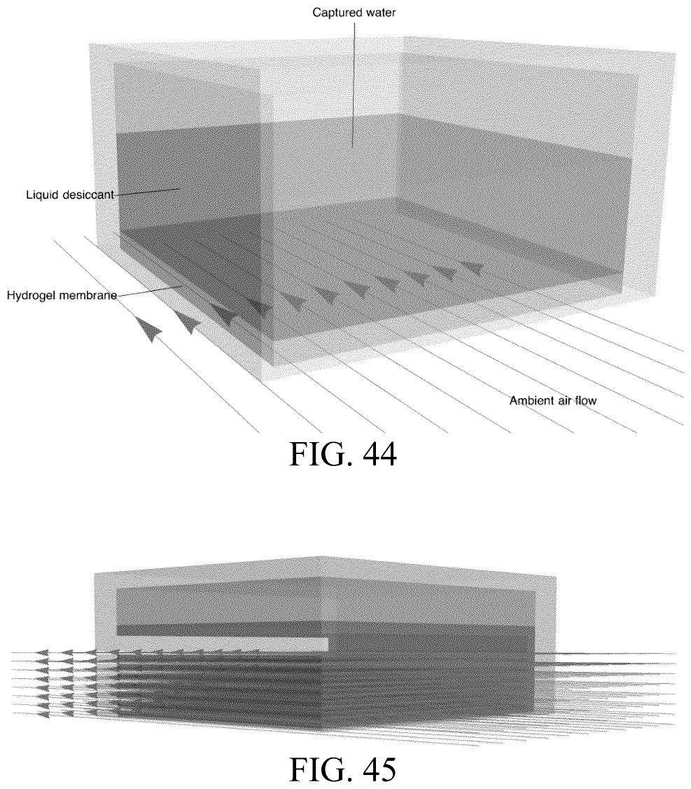

FIG. 42-45 illustrate embodiments for including multiple layers of water-harvesting structures. Each structure can include a passage for receiving airflow. One or both sides of the passage can be bounded by a hydrogel membrane. A liquid desiccant can be on a side of the hydrogel membrane opposite the passage for receiving airflow. Optionally, the liquid desiccant can extend between two adjacent hydrogel membranes. Accordingly, a single passage with hydrogel membranes on both sides can double water capture relative to that of a single hydrogel membrane over the same cross sectional area. As one example, sixteen passages can provide 32 air-membrane interfaces. In some aspects, such an embodiment can provide 480 L/m²/day, and 7.1 L per day per liter volume of the device. This can compare to two passages, providing 60 L/m²/day, and 2.3 L per day per liter volume of the device.

As shown in FIG. 42, an exemplary multi-layer capture device 200 can define a plurality of passages 210 for receiving airflow. For example, the multi-layer capture device 200 can define two passages, three passages, four passages, five passages, six passages, seven passages, eight passages, nine passages, ten passages, or more. The passages 210 can each be bounded by at least water permeable membrane. The water-permeable membrane can be, for example, a porous membrane. The water permeable membrane 220 can be a solid-state iongel condense. Optionally, the each water permeable membrane can be a hydrogel membrane 220. For example, the passages 210 can be defined between opposed surfaces 222, each surface defined by a respective hydrogel membrane 220. A liquid desiccant 230 can be provided on a side of each hydrogel membrane 220 opposite the passage 210. Although hydrogel membranes are used herein in the illustrated examples, other suitable solid-state iongel condensers can be used.

In some aspects, the multi-layer capture device 200 can comprise a housing 202. The housing can contain the liquid desiccant 230. In further aspects, the housing can define a chamber for storing captured water. For example, the chamber can enable levels of the liquid desiccant 230 to rise with capture of water.

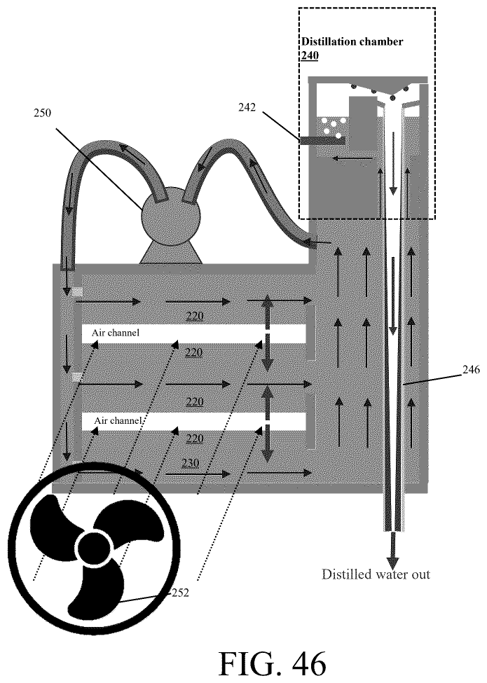

Referring to FIG. 46, the multi-layer capture device 200 can comprise a pump 250 (e.g., a peristaltic pump) for circulating the liquid desiccant 230 (e.g., throughout the housing 202). The multi-layer capture device 200 can comprise at least one fan 252 that is configured to circulate air through the passages (e.g., across the opposed surfaces 222 of the hydrogel).

In further aspects, the multi-layer capture device 200 can comprise a distillation chamber 240 that is configured to extract water from the liquid desiccant 230. The distillation chamber 240 can comprise a heater 242 (e.g., a cartridge heater) that is configured to heat the liquid desiccant 230 to release the water. For example, the heater can be configured to boil the liquid desiccant 230. In some aspects, the desiccant can boil above 100 C, such as, for example, above 140 C, or about 150 C. The distillation chamber can further comprise one or more surfaces (e.g., an upper surface 244) that are configured to guide condensed water vapor to a conduit 246 (e.g., a condenser tube). The conduit 246 can carry the captured, condensed water to an outlet or storage chamber. As shown in FIG. 46, in some aspects, the conduit 246 can be configured to provide counterflow relative to the liquid desiccant 230. For example, the conduit 246 can have an outer surface in thermal communication with the liquid desiccant 230 flowing to the distillation chamber 240 and an inner surface communicating condensation in a counterflow direction relative to the liquid desiccant. In this way, heat exchange between condensation and liquid desiccant can preheat incoming desiccant using heat from condensation to reduce heater energy input. The conduit can provide for laminar film condensation within the conduit from heat exchange with liquid desiccant 230.

The pump 250 can have an inlet on a first side of the plurality of channels and an outlet on a second side of the plurality of channels. In some aspects, the inlet can be proximate to the distillation chamber. In this way, less saturated desiccant can be provided to the plurality of channels.

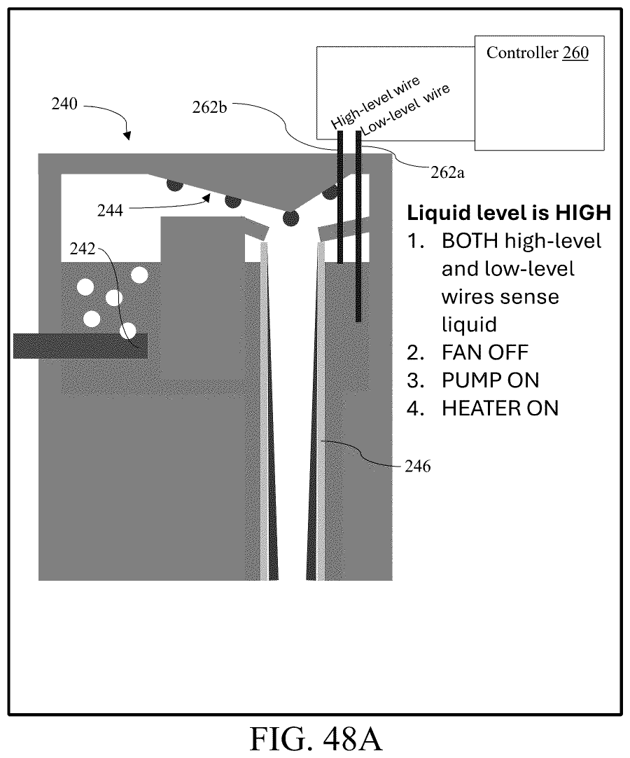

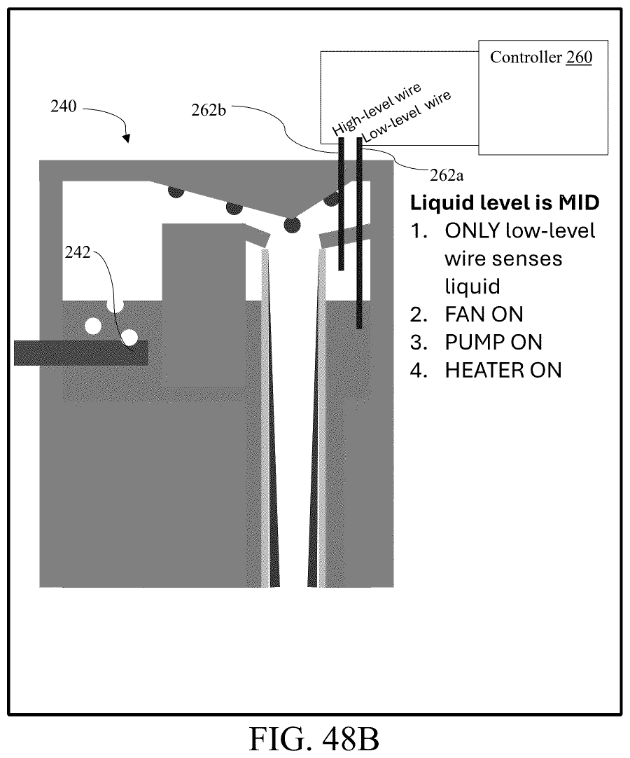

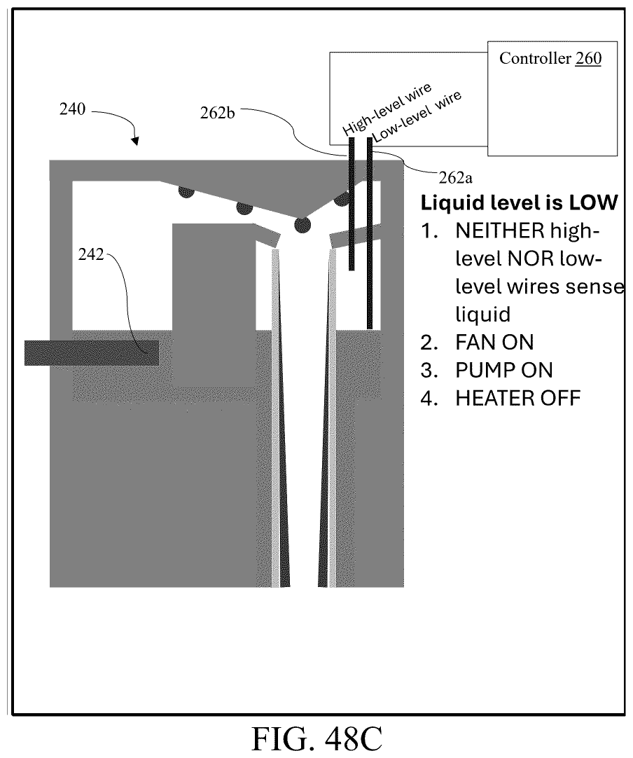

Referring to FIGS. 48A-48C, in some aspects, a controller 260 can be configured to operate one or more of the fan 252, the pump 250, or the heater 242. The controller 260 can be in communication with one or more level sensors. For example, the one or more level sensors can comprise a first sensor 262a that is configured to detect a first, low level of the liquid desiccant 230 and a second sensor 262b that is configured to detect a second, high level of the liquid desiccant. Optionally, one or both of the first and second sensors 262a,b can be positioned to measure levels within the distillation chamber 240.

In some aspects, the controller 262 can be configured to slow or stop the fan if the liquid desiccant rises above a threshold (e.g., above the second sensor 262b, shown in FIG. 48A). In this way, the controller can cause the multi-layer capture device 200 to slow water capture. In some aspects, the controller 262 can be configured to slow or stop the heater if the liquid desiccant falls below a threshold (e.g., below the first sensor 262a, shown in FIG. 48C). In this way, the controller 262 can inhibit damage to the heater 242.

In some aspects, the plurality of passages can be defined between planar surfaces. The planar surfaces can be spaced by a predetermined spacing. In some aspects, the plurality of passages 210 can be vertically stacked. In other aspects, the plurality of passages 210 can be arranged horizontally. In still additional aspects, the plurality of passages can be arranged in any way. For example, the plurality of passages need not be rectangular prisms. Optionally, in these aspects, the plurality of passages can be cylindrical or any suitable shape. For example, the plurality of passages can have curving, wavy, or undulating profiles to increase surface area of the passages.

The plurality of passages 210 can provide a cumulative surface area of the surfaces 222 of the surfaces 222 of the permeable membranes (e.g., hydrogel 220). The plurality of passages 210 can further provide a cumulative volume. In some optional aspects, the cumulative surface area to cumulative volume can be from about 10 m²/m³ to about 100 m²/m³. The multi-layer capture device 200 can have an increased surface area per unit volume as compared to a single-layer capture device.

A method may comprise capturing atmospheric water with an atmospheric capturing device. The atmospheric capturing device may include any and all details and embodiments described herein. The method may comprise receiving ambient atmosphere through the inlet. The method may also comprise cooling the received ambient atmosphere. The method may further comprise diffusing water from the received ambient atmosphere via the first section (e.g., optionally, the first membrane) of the basin. The method may also include storing the water in the at least one channel of the basin. The method may include heating the second side of the basin. The method may comprise evaporating water stored in the at least one channel via the second section (e.g., optionally, the second membrane). The method may also include condensing the evaporated water. In one aspect, the steps of diffusing water from the received ambient atmosphere and condensing evaporated water occur concurrently or substantially concurrently.

### EXEMPLARY EMBODIMENTS

Additional features and details that can be included in the disclosed embodiments are provided in the following disclosure.

### Example 1

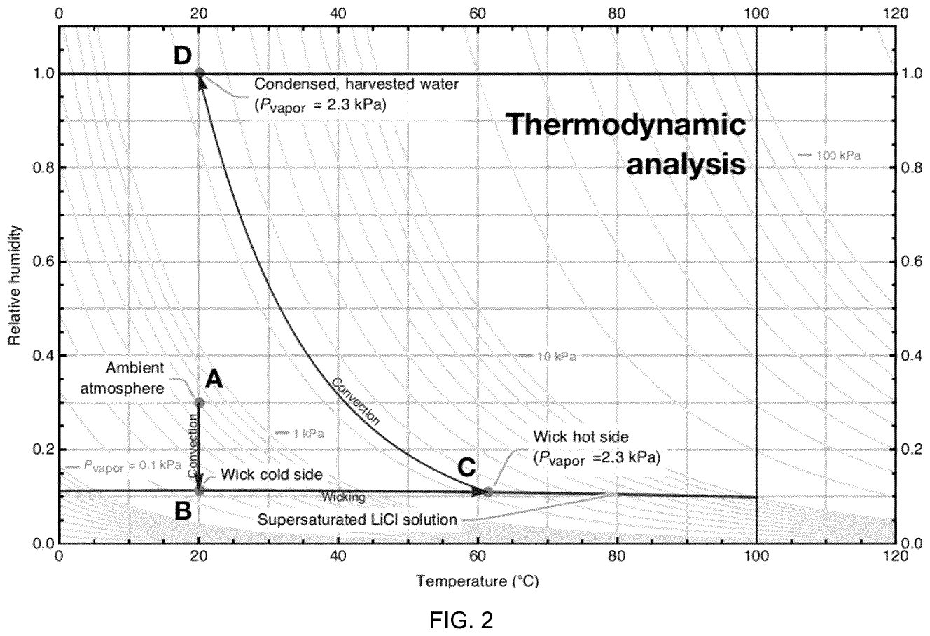

A prototype of an atmospheric water capturing device was produced as disclosed herein and based on FIG. 1. The proposed device may operate continuously. The device may use available heat resources to pump moisture from dry ambient into the reservoir. Device can comprise a pump, the pump including a super-absorbent porous hydrogel wick infused with a supersaturated salt solution. The porous, moisture-absorbent gels may be synthesized. The water to fuel ratio may exceed the Defense Advanced Research Projects Agency metric of 7. The design may be based on detailed heat and mass transfer and thermodynamic analysis (see FIG. 2).

### Example 2

### Introduction

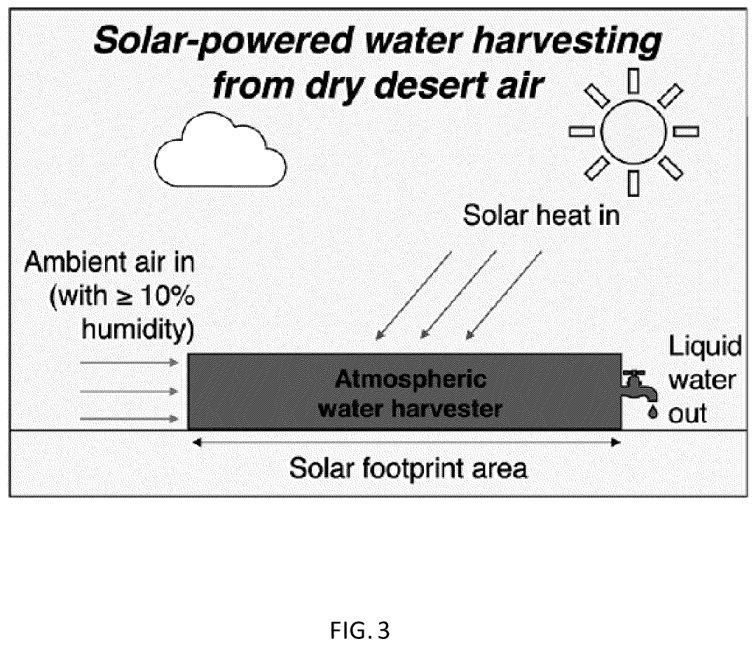

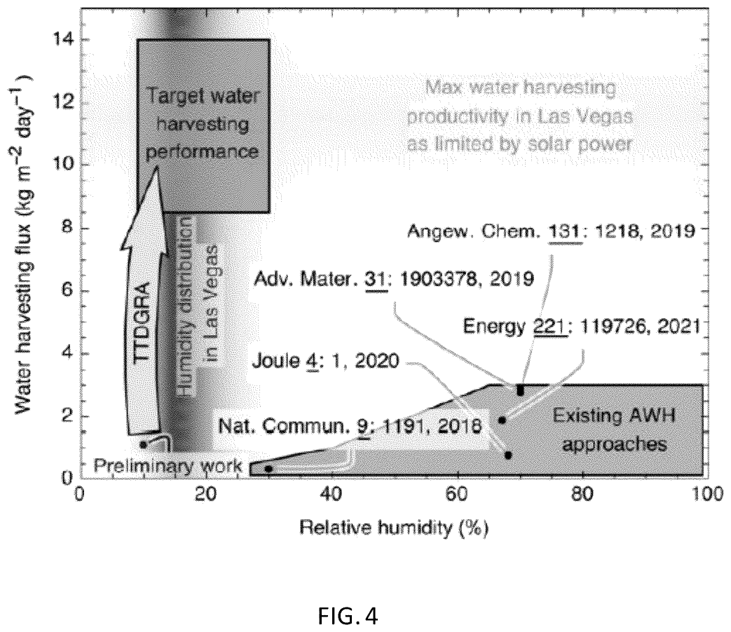

With the lowest water levels in the Southwestern US in 1,200 years, it is compelling to seek alternative water sources. See A. P. Williams, B. I. Cook, J. E. Smerdon, Nature Climate Change 12 (2022) 232-234. One source is tantalizingly close: there is a hidden ocean of water vapor in the air. Even in such a dry environment as Clark County where 260 million gallons of water per day are used, this same quantity of water could be sourced from just 0.1% of the atmosphere. With Southern Nevada's nearly uninterrupted access to solar irradiation, approximately 10 kg of water per day could be harvest over a device footprint of 1 m² with solar energy (FIG. 3)—equivalent to a PV-panel-sized device providing more than one's daily drinking requirement. On a global scale, solar-powered atmospheric water harvesting (AWH) could provide water to around one billion people according to a recent Nature study. J. Lord, A. Thomas, N. Treat, M. Forkin, R. Bain, P. Dulac, C. H. Behroozi, T. M amutov, J. Fongheiser, N. Kobilansky, S. Washburn, C. Truesdell, C. Lee, P. H. Schmaelzle, Nature 598 (2021) 611-617. However, despite the availability of water vapor, recent research of new AWH approaches have yet to demonstrate this solar-limited water harvesting of 10 kg m⁻² day⁻¹ (FIG. 4, yellow) in such dry environments as Las Vegas where the average humidity is around 20% relative humidity (RH) and can dip to below 10% RH (FIG. 4, red). See R. Tu, Y. Hwang, Energy 201 (2020) 117630; X. Zhou, H. Lu, F. Zhao, G. Yu, ACS Materials Letters 2 (2020) 671-684. The fact that there is enough water vapor and no demonstrated harvesting rate near the solar limit of 10 kg m⁻² day⁻¹ indicates that this is a transport-limited problem as opposed to a thermodynamically limited problem-here, transport refers to the movement of water, energy, and chemicals through various media. The driest conditions demonstrated the current state of the art is 30% RH where researchers measured less than 0.25 kg m⁻² day⁻¹ while the highest rates of 2.9 kg m⁻² day⁻¹ were recorded at a high humidity of 70% RH near a lake—a region with little need for AWH. H. Kim, S. R. Rao, E. A. Kapustin, L. Zhao, S. Y ang, O. M. Y aghi, E. N. Wang, Nature Communications 9 (2018) 1-8; X. Wang, X. Li, G. Liu, J. Li, X. Hu, N. Xu, W. Zhao, B. Zhu, J. Zhu, Angewandte Chemie-International Edition 58 (2019) 12054-12058; H. Qi, T. Wei, W. Zhao, B. Zhu, G. Liu, P. Wang, Z. Lin, X. Wang, X. Li, X. Zhang, J. Zhu, Advanced Materials 31 (2019) 1-9. The limitations of the current state of the art are recognized and a completely new approach that is inspired by water absorption processes that can be found in nature has been identified. In preliminary work, the bio-inspired approach shows promise by harvesting water at humidities lower than any other published work and at rates faster than any other published work (FIG. 4, blue). However, there is still much research to be done to achieve 10 kg m⁻² day⁻¹ at humidities as low as 10% RH (FIG. 4, green box). To achieve that goal, a new technology could be developed that can address a vital regional need.

### Approach

Existing AWH approaches, rely on a single sorbent material that performs multiple roles sequentially. As an analogy, imagine being ONLY allowed to charge a cell phone OR use it-NOT use it and charge it at the same time. On the other hand, nature, as exemplified by Australian tree frogs and air plants, takes a completely different approach of using separate, specialized materials to capture water and use water at the same time. C. R. Tracy, N. Laurence, K. A. Christian, The American Naturalist 178 (2011) 553-558; P. S. Raux, S. Gravelle, J. Dumais, Nature Communications 11 (2020) 396. Here, soft membranes (like a skin or a cuticle) enable water to transfer through them continuously and be captured within the extra cellular fluid (ECF) region (FIG. 5a). At the same time, that water stored in the ECF region can be used for biochemical processes. Thus, nature's approach is analogous to being able to use a phone and charge it at the same time. Inspired by nature, a skin-like hydrogel membrane encapsulating a liquid basin of ions (lithium bromide) can provide a more effective and elegant AWH approach (FIG. 5b). Here, water is captured through a capture gel, then it is stored in the liquid basin where the humidity-lowering lithium bromide serves as a chemical potential sink. L. Greenspan, Humidity Fixed Points of Binary Saturated Aqueous Solutions, n.d. During the daytime, the stored water can be evaporated through an evaporator gel and subsequently condensed into fresh liquid water. Each of these components can be stacked in a vertically oriented design enabling simultaneous water capture and distillation. The central hypothesis is that through the disclosed bio-inspired design, the disclosed separate, specialized material approach should outperform the single-sorbent state of the art, paving the way for impactful water harvesting performance at the solar limit of 10 kg m⁻² day⁻¹ at humidities as low as 10% RH.

### Tasks

To achieve performance goals (FIG. 4, yellow box), there may be three studies: (1) transport processes, (2) material science, and (3) system prototyping.

### Study 1: Water, Energy, and Chemical Transport Processes

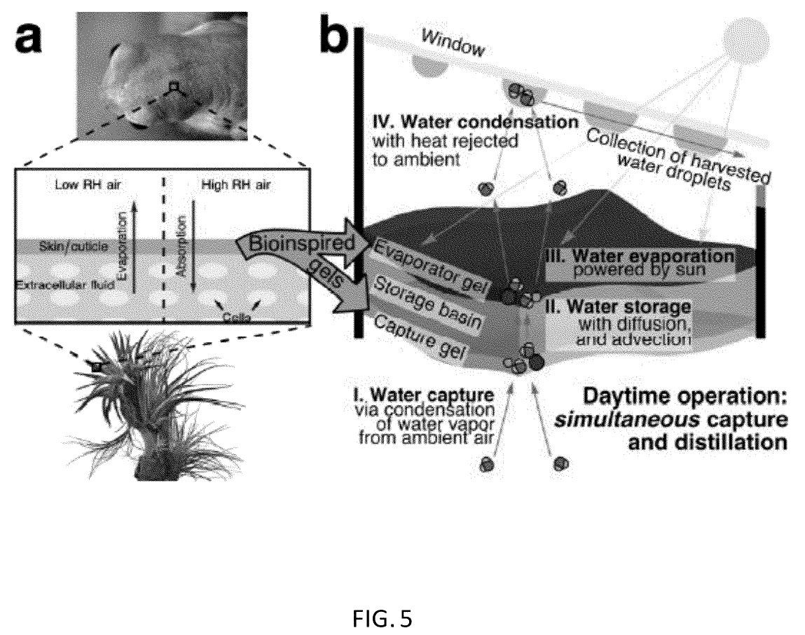

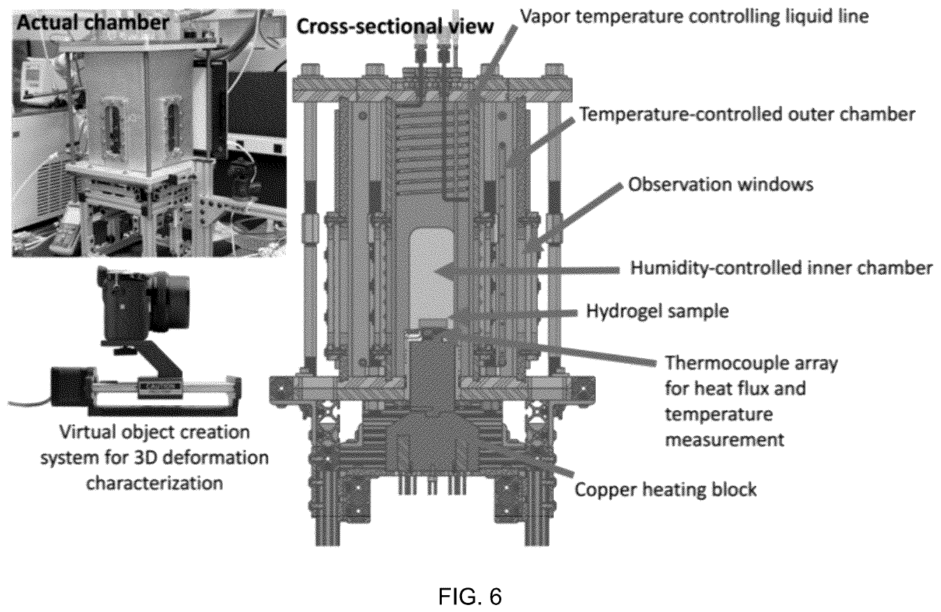

The transport processes that occur in the proposed design may be modeled in order to predict and experiment with new AWH designs. High air flows into the capture gel and low thermal conductivities in the evaporator gel may enable high water throughput. It may be assumed a poroelastic Darcy flow to exist within the gel such that the superficial velocity is related to a gradient in volumetric strain: u=Dₚₑ∇ε. With this superficial velocity, steady-state conservation of mass (∇·u=0), ions (u·∇c=∇·(Dᵢₒₙ∇_{c})), and heat energy (ρ_{gel}c_{p,gel}u·∇T=∇·(k_{gel}∇T)) may be expressed. Gel deformation may be solved according to finite strain theory. Only very recently have there been attempts to couple some of these PDEs together to understand transport through hydrogels—however, a more complete model does not currently exist that incorporates deformation and swelling-dependent properties; thus, the disclosed work can contribute knowledge to the liquid-vapor transport field. C. D. Díaz-Marín, L. Zhang, B. El Fil, Z. Lu, M. Alshrah, J. C. Grossman, E. N. Wang, International Journal of Heat and Mass Transfer 195 (2022) 123103. Leveraging experience in building heat transfer experiments, a custom environmental chamber may be used to perform steady-state heat transfer and cyclic tests with in situ 3D observation using virtual object creation imaging (FIG. 6). This way, a rich set of validation data may be provided with simultaneous mechanical and heat-transfer measurements.

### Study 2: Material Science of Hydrogels

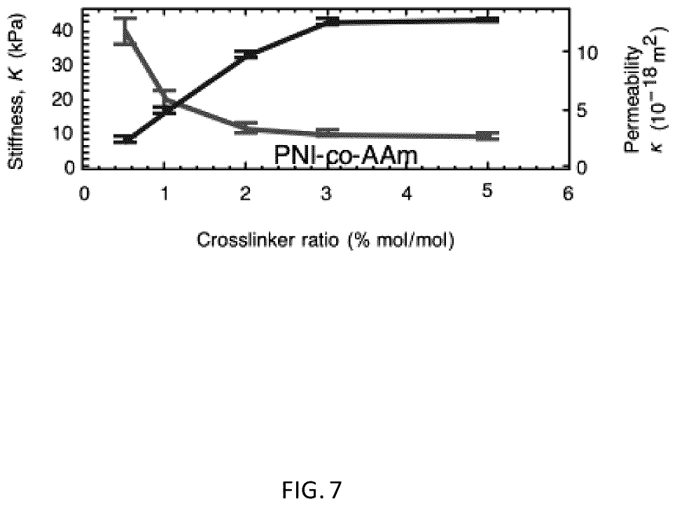

Hydrogels are networks of strand-like polymer molecules that swell or shrink depending on environmental conditions such as osmotic pressure and temperature. Based on preliminary analysis, a composite material property termed the poroelastic diffusivity, Dₚₑ, may be maximized such that

$${D}_{pe} = \frac{κ K}{μ}$$

where κ is the absolute permeability of the gel (m²), K is the elastic bulk modulus of the gel (Pa), and μ is the dynamic viscosity (Pa*s) of the liquid. However, maximizing this quantity may be challenging since there may be a fundamental trade off between permeability and stiffness: increasing one property necessarily decreases the other (FIG. 7). If this is true, then ways to break this trade-off through functionalization and incorporation of micron-scale channels and pores through freeze-thaw and freeze-dry processing may be explored, contributing knowledge to the polymer science field. N. Annabi, J. W. Nichol, X. Zhong, C. Ji, S. Koshy, A. Khademhosseini, F. Dehghani, Tissue Engineering—Part B: Reviews 16 (2010) 371-383. The idea is to use the nucleation of ice crystals to create large voids in the gel. In addition to increasing Dₚₑ, gels should be highly stretchable in order to facilitate thin membranes since decreasing thickness improves overall transport. Inspired by recent work on highly entangled gels, preliminary work on how maximum strain can be improved to produce strong, stretchable, thin gels has begun. J. Kim, G. Zhang, M. Shi, Z. Suo, Science (1979) 374 (2021) 212-216. In addition, the evaporator gel should be as thermally insulating as possible to minimize heat losses. Maxwell effective thermal conductivity rules may apply for hydrogels, enabling conductivity to be tuned via composites. K. Pietrak, T. Wiśniewski, Journal of Power of Technologies 95 (2015) 14-24. Incorporation of low-density insulators could provide low thermal conductivities, respectively. Thermal conductivities may be tested by imposing temperature boundary conditions via custom apparatuses and lab chillers.
Study 3: Prototyping and Crowdsourcing of Data from Local High Schools

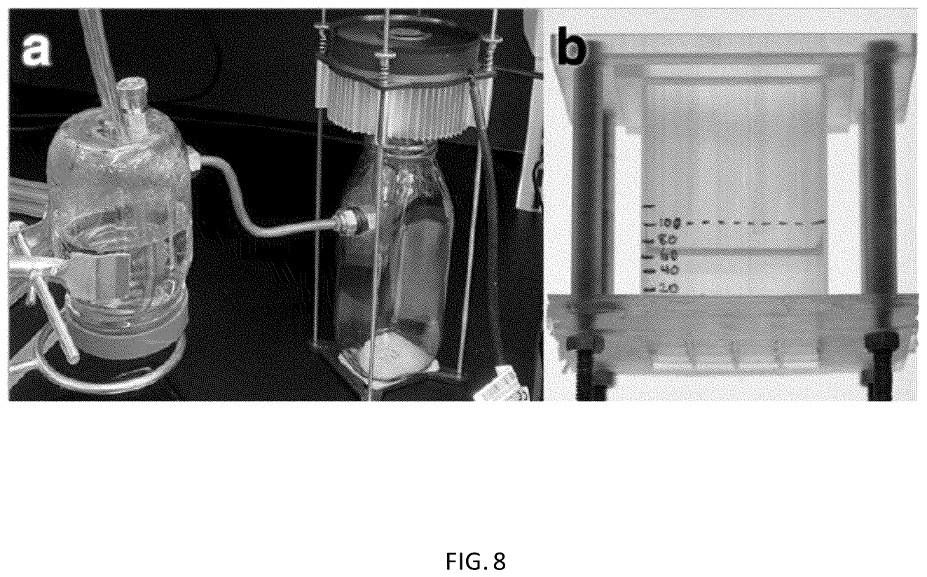

Preliminary prototypes may be built to demonstrate certain aspects of the water harvesting system (FIG. 8). Through prototyping, the effects of separately controlling the capture and evaporator conditions may be understood.

A science kit may be designed that could be built cheaply with a 3D printer and easily accessible materials. Early iterations of the kit may be a simple solar distillation device for water filtration made of polystyrene and fabric, resembling the evaporator gel in the disclosed system. A Raspberry-Pi-based data logging system may provide the means to crowd source data from these harvesting stations. The performance and weather data, sent to the cloud, may inform research activities to understand system performance in varied conditions. Y early updates to the design may be implemented with future iterations incorporating new materials and designs. Contribution of new knowledge to existing fields: This work demonstrates how nature can inspire better designs by separately incorporating components with specialized functions. How complexities in soft, polymeric materials can be exploited for advantageous behaviors may also be demonstrated. How polymer transport properties and liquid-vapor phase-change behavior responds to complex environments of various gradients that have not been studied previously may be uncovered.

### Example 3

### Background

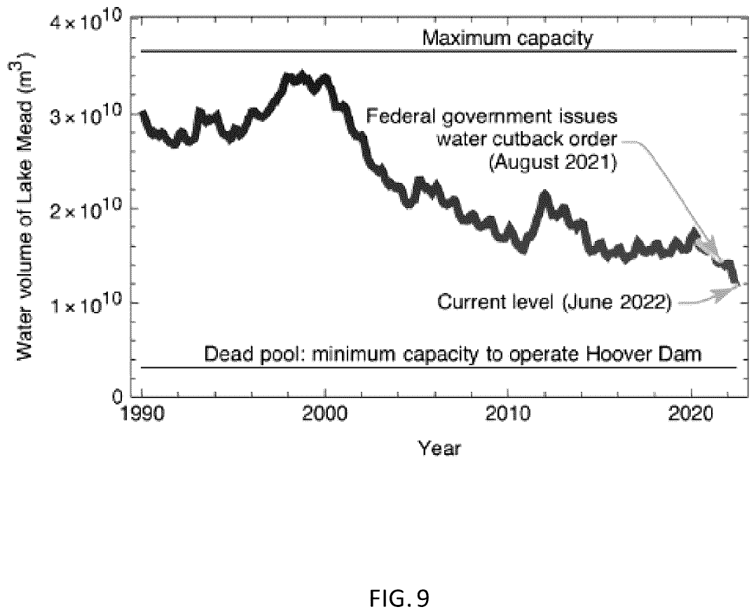

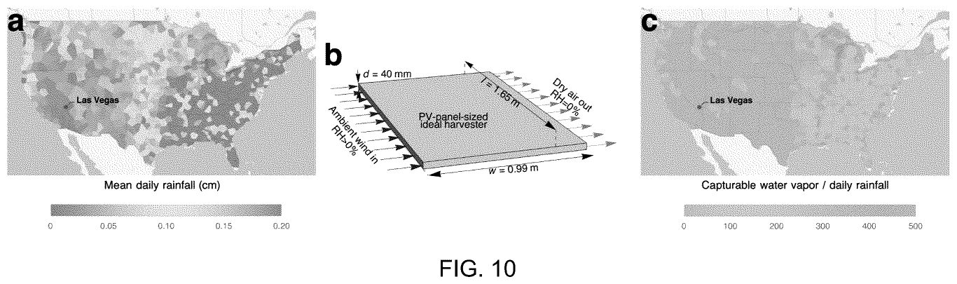

Water is a vital substance typically collected from freshwater surface resources (e.g., lakes and rivers), and, in the context of climate change, arid regions are facing severe water scarcity from these resources. Konapala G, Mishra A K, Wada Y, Mann M E Climate change can affect global water availability through compounding changes in seasonal precipitation and evaporation. https://doi.org/10.1038/s41467-020-16757-w. In Southern Nevada, the fragility of the water supply has driven aggressive conservation efforts since 2002 that have cut per-capita consumption by one half. Y et, despite these conservation efforts, population growth and climate change continue to diminish the region's water supply (FIG. 9) to the lowest levels in 1,200 years. Brelsford C, Abbott J K (2017) Growing into Water Conservation? Decomposing the Drivers of Reduced Water Consumption in Las Vegas, NV. Ecological Economics, 133:99-110. https://doi.org/10.1016/j.ecolecon.2016.10.012; US Bureau of Reclamation (2022); LAKE MEAD AT HOOVER DAM, END OF MONTH ELEVATION (FEET); National Park Service (2019) Storage Capacity of Lake Mead; Williams A P, Cook B I, Smerdon J E (2022) Rapid intensification of the emerging southwestern North American megadrought in 2020-2021. Nature Climate Change, 12 (3): 232-234 https://doi.org/10.1038/s41558-022-01290-z. Las Vegas, like much of the western US, has extremely little rainfall (FIG. 10a)—a mere 6 cm per year. Tapping into typical alternative sources is not feasible as groundwater sources are limited, especially with increased contamination from anthropogenic activities, and seawater desalination would be prohibitively expensive and impractical for inland regions. Mays L W Groundwater Resources Sustainability: Past, Present, and Future, https://doi.org/10.1007/s11269-013-0436-7; Pazouki P, Stewart R A, Bertone E, Helfer F, Ghaffour N (2020) Life cycle cost of dilution desalination in off-grid locations: A study of water reuse integrated with seawater desalination technology. Desalination, 491:114584. https://doi.org/10.1016/j.desal.2020.114584.

There is one hidden and virtually limitless source of water, however, in the air around us: water vapor. In Southern Nevada the 260 million gallons of water used daily could be harvested from just 0.1% of the air above Southern Nevada, despite being one of the driest regions in the world. Even at low humidities of around 20% (the average for Las Vegas), the amount of water vapor in the atmosphere far exceeds the amount that is precipitated as rain. From preliminary analysis, if water vapor is captured through a hypothetical ideal harvesting device the size of a residential photovoltaic (PV) panel (FIG. 10b) the maximum rate of water capture is about 47 kg m⁻² day⁻¹ in Las Vegas—about 300× more than what could be captured from rain (FIG. 10c). Existing AWH approaches, however, have only demonstrated harvesting at around ˜1 kg m⁻² day⁻¹; thus, current harvesting approaches are not thermodynamically limited—there is more than enough water in the air. Rather, capturing this water at meaningful rates requires solving a transport-limited problem. The conventional way to harvest this water is to thermally condense water vapor into using sub-ambient temperatures below the dew point. These approaches involve energy-intensive, bulky refrigeration devices such as vapor compression cycles. Tu R, Hwang Y (2020) Reviews of atmospheric water harvesting technologies. Energy, 201:117630. https://doi.org/10.1016/j.energy.2020.117630. Furthermore, in some very dry regions like Las Vegas, thermal condensation is not practical as the dew point temperature is below the freezing point.

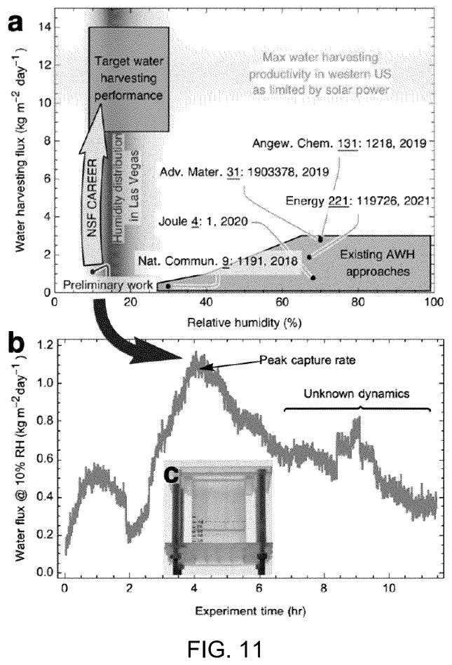

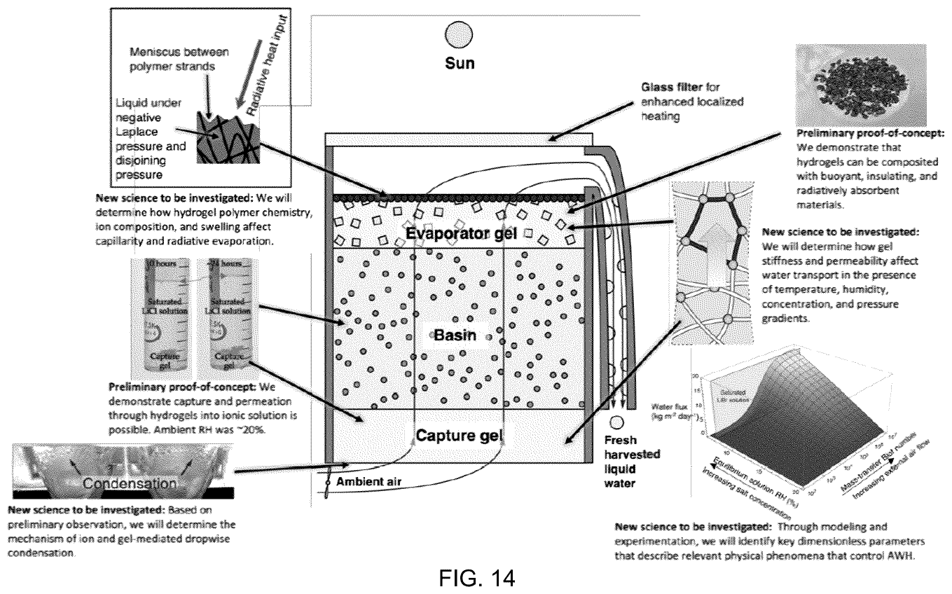

Recent AWH approaches capture water physicochemically into a sorbent and subsequently use solar power to release it via evaporation (distillation) or lower critical solution temperature phase separation. Tu R, Hwang Y (2020) Reviews of atmospheric water harvesting technologies. Energy, 201:117630, https://doi.org/10.1016/j.energy.2020.117630; Zhou X, Lu H, Zhao F, Y u G (2020) Atmospheric Water Harvesting: A Review of Material and Structural Designs. ACS Materials Letters, 2 (7): 671-684. https://doi.org/10.1021/acsmaterialslett.0c00130; Zhao F, Zhou X, Liu Y, Shi Y, Dai Y, Yu G (2019) Super Moisture-Absorbent Gels for All-Weather Atmospheric Water Harvesting. Advanced Materials, 31 (10): 1-7. https://doi.org/10.1002/adma.201806446; Haddad A Z, Menon A K, Kang H, Urban J J, Prasher R S, Kostecki R (2021) Solar Desalination Using Thermally Responsive lonic Liquids Regenerated with a Photonic Heater. Environ. Sci. Technol, 55:52. https://doi.org/10.1021/acs.est.0c06232. A recent Nature study showed that these solar-powered approaches could supply drinking water to around one billion people. Lord J, Thomas A, Treat N, Forkin M, Bain R, Dulac P, Behroozi C H, Mamutov T, Fongheiser J, K obilansky N, Washburn S, Truesdell C, Lee C, Schmaelzle P H (2021) Global potential for harvesting drinking water from air using solar energy. Nature, 598 (7882): 611-617. https://doi.org/10.1038/s41586-021-03900-w. However, existing AWH approaches have very low yield of around ˜1 kg m⁻² day⁻¹—much smaller than typical rainwater capture systems and the solar limit of ˜10 kg m⁻² day⁻¹ (preliminary analysis shown in FIG. 14). Lawrence D, Lopes V L (2016) Reliability Analysis of Urban Rainwater Harvesting for Three Texas Cities. Journal of Urban and Environmental Engineering, 10(1):124-134. https://doi.org/10.4090/juee.2016.v10n1.124134. This solar limit may be achieved for distillation since recent work on evaporator hydrogels have demonstrated >90% efficiency and water fluxes that exceed this solar limit. Shi Y, Ilic O, Atwater H A, Greer J R (2021) All-day fresh water harvesting by microstructured hydrogel membranes. Nature Communications, 12(1):2797. https://doi.org/10.1038/s41467-021-23174-0; Guo Y, Zhao F, Zhou X, Chen Z, Y u G (2019) Tailoring Nanoscale Surface Topography of Hydrogel for Efficient Solar Vapor Generation. Nano Letters, 19 (4): 2530-2536. https://doi.org/10.1021/acs.nanolett.9b00252; Zhao F, Zhou X, Shi Y, Qian X, Alexander M, Zhao X, Mendez S, Y ang R, Qu L, Y u G (2018) Highly efficient solar vapour generation via hierarchically nanostructured gels. Nature Nanotechnology, (6):489-495. https://doi.org/10.1038/s41565-018-0097-z. Thus, existing AWH approaches are clearly limited at the capture stage and not the distillation stage. To achieve the solar limit for harvesting (capture+distillation), the approach focuses on developing a novel, highly effective, continuous capture approach while incorporating and improving upon the best in evaporative techniques in a completely new flow-through architecture. This unique combination of novel and proven materials and techniques, enabled by new science, can provide a transformative new approach to AWH. Another issue with existing approaches is the favorable relative humidity conditions (>50% RH) that are hardly representative of where AWH is needed the most (FIG. 10c, 11a). Thus, no existing AWH approach would be appropriate in a dry region like Las Vegas (20% RH average; as low as 5%). The approach is highly promising since preliminary testing demonstrated water capture rates of ˜1 kg m⁻² day⁻¹ in a relative humidity of 10%-drier conditions than any existing work (FIG. 11). However, the rates are still well below the solar limit. Achieving this great leap in performance at low humidities is possible but requires extensive scientific study and a completely new approach.

### New Approach

The steps involved in AWH can be generally summarized in the following steps:
I. The first step is water capture where ambient water vapor (humidity) is condensed into an absorbent or liquid form. This is an exothermic process releasing the latent heat of condensation/absorption.
II. The next step is water storage where water remains inside an absorbent or as a solution until it can be released for further processing.
III. Once a heat source is available (e.g., the sun), water evaporation takes in the heat source and converts it to latent heat to vaporize the stored water.
IV. Finally, water condensation releases the latent heat to the environment, resulting in nearly pure liquid water. Any subsequent filtering to remove contaminants would occur after this step.

Note that “water harvesting” is sometimes used to describe water distillation (steps III and IV) to purify water from salty or contaminated liquid sources (e.g., Shi Y, Ilic O, Atwater H A, Greer J R (2021) All-day fresh water harvesting by microstructured hydrogel membranes. Nature Communications, 12(1):2797. https://doi.org/10.1038/s41467-021-23174-0). In the definition of atmospheric water harvesting herein, the entire four-step process above is included.

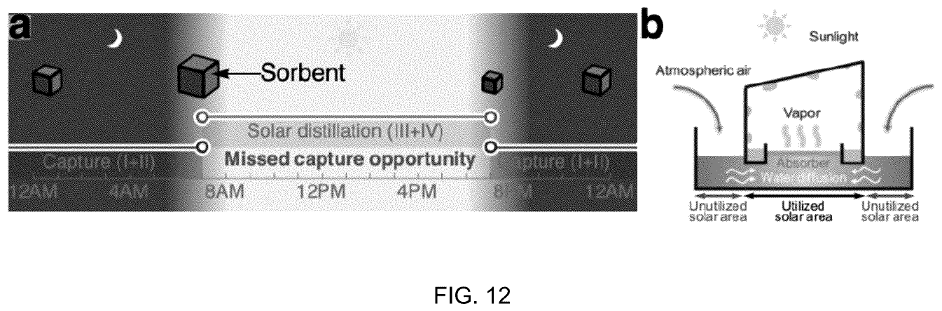

The current paradigm of AWH involves a single sorbent material performing steps I, II, and III. Many of these approaches rely on solid-state sorbents such as a metal-organic frameworks (MOFs), zeolites, and gels. Kim H, Y ang S, Rao S R, Narayanan S, Kapustin E A, Furukawa H, Umans A S, Yaghi O M, Wang E N (2017) Water harvesting from air with metal-organic frameworks powered by natural sunlight. Science, 356 (6336): 430-434. https://doi.org/10.1126/science.aam8743; LaPotin A, Zhong Y, Zhang L, Zhao L, Leroy A, Kim H, Rao S R, Wang E N (2021) Dual-Stage Atmospheric Water Harvesting Device for Scalable Solar-Driven Water Production. Joule, 5 (1): 166-182. https://doi.org/10.1016/j.joule.2020.09.008; Zhao F, Zhou X, Liu Y, Shi Y, Dai Y, Yu G (2019) Super Moisture-Absorbent Gels for A II-Weather Atmospheric Water Harvesting. Advanced Materials, 31(10):1-7. https://doi.org/10.1002/adma.201806446; Matsumoto K, Sakikawa N, Miyata T (2018) Thermo-responsive gels that absorb moisture and ooze water. Nature Communications, 9(1) https://doi.org/10.1038/s41467-018-04810-8; Kallenberger P A, Fröba M (2018) Water harvesting from air with a hygroscopic salt in a hydrogel-derived matrix. Communications Chemistry, 1(1):28. https://doi.org/10.1038/s42004-018-0028-9; Guo Y, Guan W, Lei C, Lu H, Shi W, Y u G (2022) Scalable super hygroscopic polymer films for sustainable moisture harvesting in arid environments. Nature Communications, 13(1):1-7. https://doi.org/10.1038/s41467-022-30505-2. Typically, these technologies have the sorbent capturing and storing water (I+II) at nighttime when humidities are higher. In daytime, the sorbents are switched to a desorption mode, closed off from the ambient environment, and allowed to heat up using a heat source (e.g., solar). As the sorbent heats up, it evaporates the stored water, which can be subsequently condensed into fresh liquid water through heat exchange with the ambient temperature (III+IV). Some gel-based sorbents utilize the temperature-induced volume change at elevated temperatures to directly secrete stored liquid water. Zhao F, Zhou X, Liu Y, Shi Y, Dai Y, Y u G (2019) Super Moisture-Absorbent Gels for All-Weather Atmospheric Water Harvesting. Advanced Materials, 31(10):1-7. https://doi.org/10.1002/adma.201806446; Matsumoto K, Sakikawa N, Miyata T (2018) Thermo-responsive gels that absorb moisture and ooze water. Nature Communications, 9(1) https://doi.org/10.1038/s41467-018-04810-8; Guo Y, Guan W, Lei C, Lu H, Shi W, Y u G (2022) Scalable super hygroscopic polymer films for sustainable moisture harvesting in arid environments. Nature Communications, 13 (1): 1-7. https://doi.org/10.1038/s41467-022-30505-2. In all these cases, harvesting performance relies on a single sorbent to perform capture, storage, and removal. As such, it is a challenge to maximize all three behaviors in a single material. Furthermore, solid sorbents can only perform either capture or removal at a given time (FIG. 12a)—similar to how early portable electronics could not be charged and used at the same time. As an alternative to solid sorbents, recent work with liquid sorbents of highly-concentrated salt solutions demonstrate water capture in one location and evaporation in another simultaneously. Wang X, Li X, Liu G, Li J, Hu X, Xu N, Zhao W, Zhu B, Zhu J (2019) An Interfacial Solar Heating Assisted Liquid Sorbent Atmospheric Water Generator. Angewandte Chemie-International Edition, 58(35):12054-12058. https://doi.org/10.1002/anie.201905229; Qi H, Wei T, Zhao W, Zhu B, Liu G, Wang P, Lin Z, Wang X, Li X, Zhang X, Zhu J (2019) An Interfacial Solar-Driven Atmospheric Water Generator Based on a Liquid Sorbent with Simultaneous Adsorption-Desorption. Advanced Materials, 31(43):1-9. https://doi.org/10.1002/adma.201903378. However, there are questions of robustness due to the exposure of liquids to the environment and limited performance as the requirement of liquid containment in separate basins precludes the full utilization of solar footprint. It is contemplated that existing liquid sorbent approaches can capture and distill simultaneously, but they are unable to fully utilize solar footprint in the manner of the disclosed devices, systems, and methods.

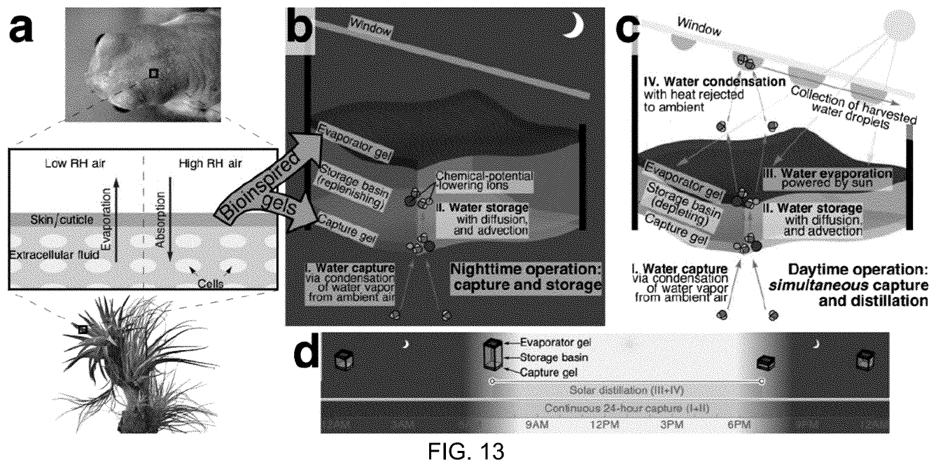

However, nature—as demonstrated by tree frogs and air plants—takes a vastly different approach of using separate, specialized materials to capture water. Soft membranes (a single surface such as a skin or a cuticle; FIG. 13a) continuously and autonomously capture water—like simultaneously charging and using a battery. These membranes surround the extracellular fluid, act as a protective barrier to the organism, and are permeable to water. The extracellular fluid, necessary for proper hydration and survival, serves as a chemical potential sink allowing water to flow through the skin/cuticle into the fluid. As long as the chemical potential of the extracellular fluid is lower than that of the ambient water vapor, the organism will hydrate. In other cases when the ambient has a lower chemical potential (dry conditions), then the skin/cuticle will act as an evaporation membrane (FIG. 13b). Inspired by nature, it is contemplated that a skin-like gel membrane encapsulating a liquid basin can provide a more effective and elegant AWH approach. As opposed to existing approaches, a unique architecture is proposed to segregate water capture, storage, and evaporation into three components (FIG. 13b,c) with the idea that separate, specialized materials should outperform a single material that performs all tasks. A hydrogel membrane on the bottom—a capture gel of a completely new material and design—captures water from ambient (step I) faster. Another membrane on the top serves as an efficient evaporator where existing work is leveraged and improved upon. Shi Y, Ilic O, Atwater H A, Greer J R (2021) All-day fresh water harvesting by microstructured hydrogel membranes. Nature Communications, 12(1):2797. https://doi.org/10.1038/s41467-021-23174-0; Guo Y, Zhao F, Zhou X, Chen Z, Y u G (2019) Tailoring Nanoscale Surface Topography of Hydrogel for Efficient Solar Vapor Generation. Nano Letters, 19 (4): 2530-2536. https://doi.org/10.1021/acs.nanolett.9b00252; Zhao F, Zhou X, Shi Y, Qian X, Alexander M, Zhao X, Mendez S, Y ang R, Qu L, Y u G (2018) Highly efficient solar vapour generation via hierarchically nanostructured gels. Nature Nanotechnology, 13 (6): 489-495. https://doi.org/10.1038/s41565-018-0097-z. Sandwiched between these two gels is a storage basin of ionic solution with extremely high salinity (liquid desiccants) to ensure absorption in even the driest conditions. Thus, the role of the gel membranes is to permeate water as quickly as possible into or out of the basin while the basin's role is to provide the deepest possible chemical potential sink and ample storage. With three specialized materials optimized at performing capture, storage, and evaporation, transport limitations can be studied to achieve solar-limited water fluxes of ˜10 L m⁻² day⁻¹ in dry environments.

### The Science

To unlock solar-limited flux in dry environments, it is necessary to uncover the science that dictates bottlenecks in flow. Specifically, the focus is on the material and thermal transport limitations during capture and evaporation.

### Transport Considerations During Capture

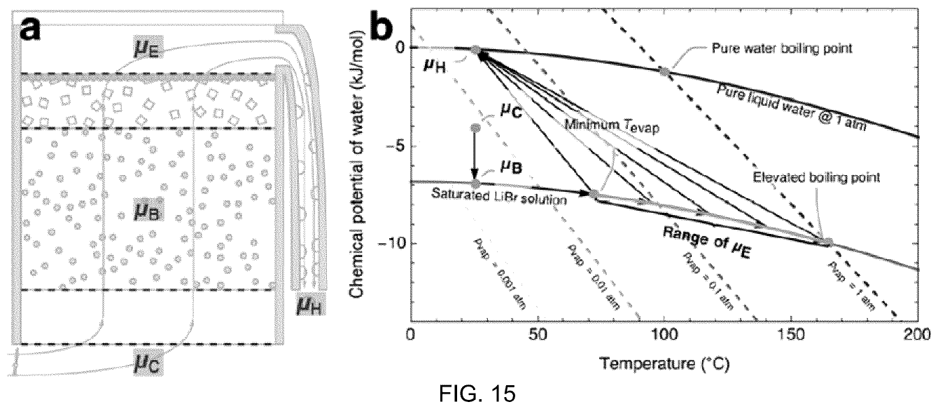

To understand transport in the capture gel, first consider as illustrated in FIG. 15 that the ionic solution in the basin represents a chemical potential sink, elevating the boiling point of water, depressing the freezing point, and lowering the equilibrium relative humidity (RH). Greenspan L Humidity Fixed Points of Binary Saturated Aqueous Solutions. Journal of Research of the National Bureau of Standards-A. Physics and Chemistry, 81(1). As RH near the solution is lowered, the density of water vapor, p, is also lowered. If the RH of the ambient is greater than the RH of the solution at similar temperatures, then water vapor will spontaneously migrate towards and condense into the solution—a known phenomenon utilized by liquid desiccants. Chen X, Riffat S, Bai H, Zheng X, Reay D (2020) Recent progress in liquid desiccant dehumidification and air-conditioning: A review. Energy and Built Environment, 1(1):106-130. https://doi.org/10.1016/j.enbenv.2019.09.001. Rather than directly expose the liquid desiccant (basin) to ambient air, captured gel can be incorporated as a membrane facilitating transport, providing protection from outside elements, and enabling a vertically-oriented design for full utilization of the solar footprint. Wang X, Li X, Liu G, Li J, Hu X, Xu N, Zhao W, Zhu B, Zhu J (2019) An Interfacial Solar Heating Assisted Liquid Sorbent Atmospheric Water Generator. Angewandte Chemie-International Edition, 58(35):12054-12058. https://doi.org/10.1002/anie.201905229; Qi H, Wei T, Zhao W, Zhu B, Liu G, Wang P, Lin Z, Wang X, Li X, Zhang X, Zhu J (2019) An Interfacial Solar-Driven Atmospheric Water Generator Based on a Liquid Sorbent with Simultaneous Adsorption-Desorption. Advanced Materials, 31(43):1-9. https://doi.org/10.1002/adma.201903378. The gel, being permeable to both ions and water, will also lower the RH of vapor near the gel-air interface, ρₛ, enabling atmospheric water capture—a phenomenon that can be confirmed with preliminary results (FIG. 14, left). As a result, water vapor flows from the ambient to gel-air interface in the direction of lower vapor pressure or, equivalently, water vapor density, ρ, since they are proportional. Thus, from the perspective of external water vapor mass transfer, the rate of water mass flux captured, j, is:

$$j = {h}_{mt} ( {ρ}_{amb} - {ρ}_{s} )$$

where j is the capture rate that should be maximized, hₘₜ is the water vapor mass transfer coefficient just outside the gel and is set by advection and liquid vapor condensation, ρ_{amb} is set by ambient, and ρₛ is set by gel properties. To maximize water capture, hₘₜ can be increased. To quantify and increase hₘₜ requires a study of the air flow and boundary layer effects, as well as an investigation of a new hydrogel-mediated dropwise condensation mode driven by salinity-induced chemical potential difference (instead of typical thermal-induced condensation) that were discovered in preliminary testing (Task 1). ρ_{amb} cannot be changed as is set by the ambient temperature and humidity. Lastly, the gel surface vapor density, ρₛ, may be lowered through manipulation of the capture gel and the basin. To accurately quantify and control ρₛ may require a deep investigation of the complex multiphysical transport phenomena occurring within and around the capture gel (Task 2).

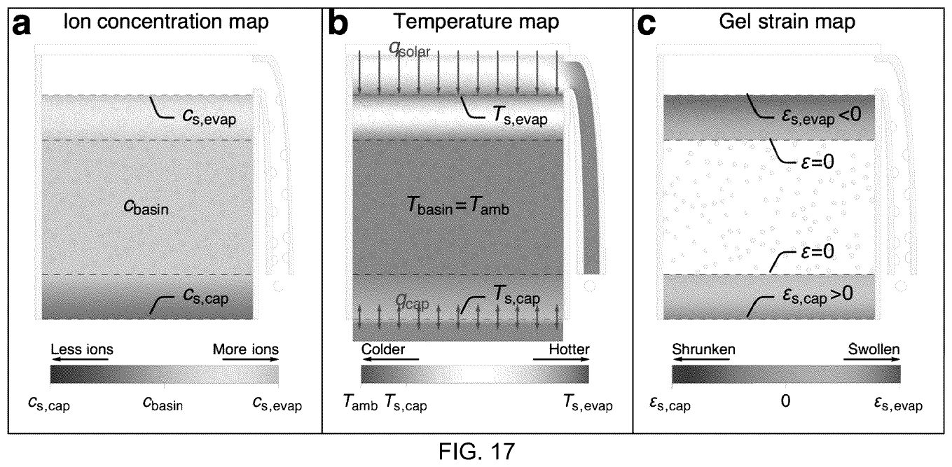

Chemically, ρₛ can be lowered by using highly desiccating salts such as lithium bromide (LiBr) at their saturation concentrations. Chen X, Riffat S, Bai H, Zheng X, Reay D (2020) Recent progress in liquid desiccant dehumidification and air-conditioning: A review. Energy and Built Environment, 1(1):106-130. https://doi.org/10.1016/j.enbenv.2019.09.001. Since saturated LiBr has an equilibrium RH of 6-7% for typical ambient temperatures, this represents the lowest RH at which atmospheric water harvesting would be possible with LiBr—enabling water capture in Las Vegas 95% of the time. Thermally, ρₛ can be lowered by ensuring the gel surface temperature is as low as possible. Without resorting to active refrigeration, the lowest possible temperature is the ambient temperature. However, the true surface temperature would be slightly elevated due to absorption/condensation releasing latent heat as water is being captured (preliminary finite-element method (FEM) modeling illustrates this heating in FIG. 17). Kim H, Cho H-JJ, Narayanan S, Y ang S, Furukawa H, Schiffres S, Li X, Zhang Y-B, Jiang J, Yaghi O M, Wang E N (2016) Characterization of Adsorption Enthalpy of Novel Water-Stable Zeolites and Metal Organic Frameworks. Scientific Reports, 1-8. Due to condensation of water vapor, a heat amount equal to the mass flow rate times specific latent heat, \dot{m} h_{fg}, would need to be removed via convection with the ambient and conduction through the gel. Thus, forced air flows (also aiding vapor mass transfer via hₘₜ) and high gel thermal conductivity would remove latent heat to the environment. Preliminary modeling has shown that increasing a vapor mass transfer Biot number can increase capture rate (FIG. 14, bottom right).

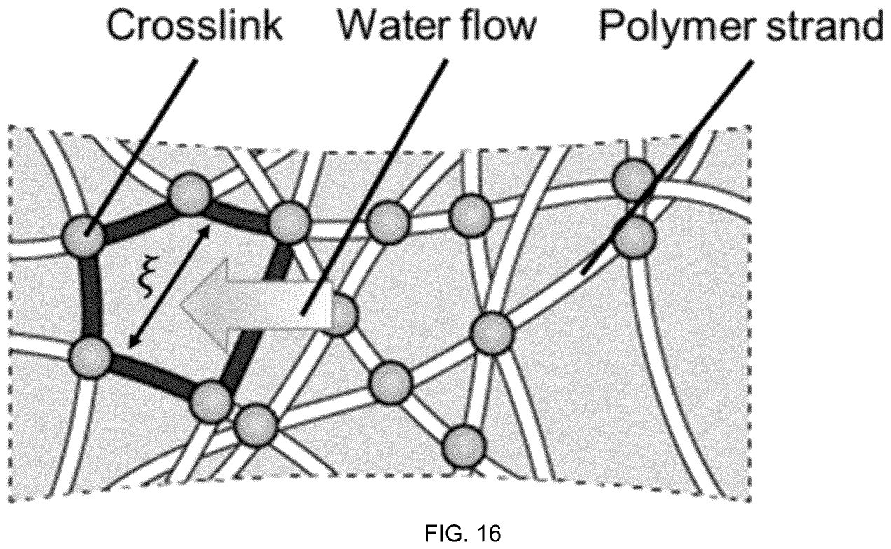

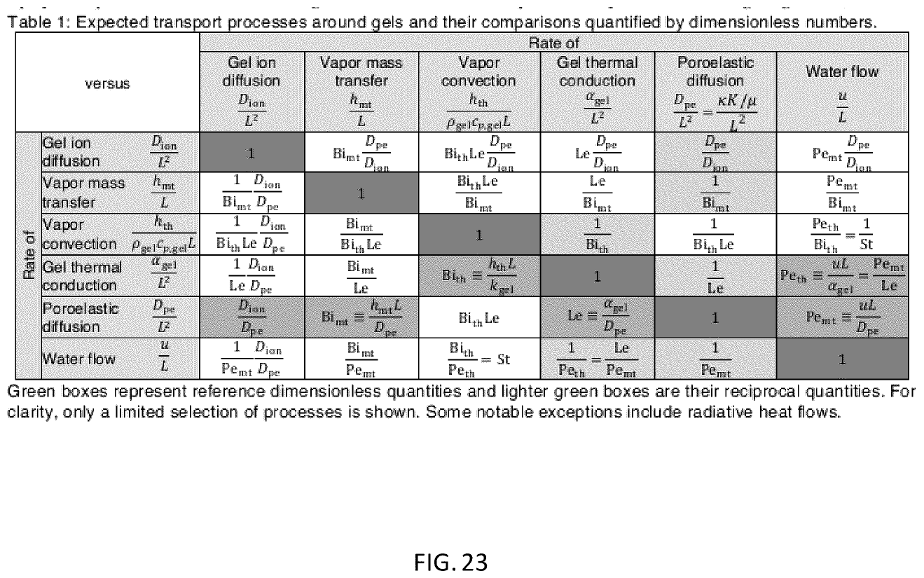

Finally, understanding the mass transfer through the gel will inform how to lower ρₛ and maximize capture. Within the gel, water permeates toward the basin due to a driving liquid pressure gradient, ∇p₁. Treating the gel as a porous medium (FIG. 16), the effective “pores” are the spacings between polymer strands where the mesh size, ξ, is on the order of ˜10 nm depending on the state of swelling—as such, there is an effective permeability, κ, of the gel. Gennes P-G de (1979) Scaling Concepts in Polymer Physics. http://books.google.com/books?id=ApzfJ2LYwGUC&printsec=frontcover&dq=intitle:Scaling+Concepts+inauthor:de+gennes&hl=&cd=1&source=gbs_api; Offeddu G S, Axpe E, Harley B A C, Oyen M L (2018) Relationship between permeability and diffusivity in polyethylene glycol hydrogels. AIP Advances, 8(10) https://doi.org/10.1063/1.5036999. Treating the gel as an elastic deformable material, the driving pressure gradient can be related to a gradient in volumetric (swelling) strain, ∇ε, as Δp; =K∇ε where K is the gel bulk modulus. In recently published work, it was confirmed that this poroelastic description applies to hydrogels in equilibrium contexts; the proposed study will investigate how this poroelastic description continues to apply when gradients of stress/strain, pressure, salt concentration, and temperature are present. Gao Y, Chai N K K, Garakani N, Datta S S, Cho H J (2021) Scaling laws to predict humidity-induced swelling and stiffness in hydrogels. Soft Matter, 17(43):9893-9900. https://doi.org/10.1039/D1SM01186C. Combining this poroelastic description with Darcy's law, water moves down a gradient of volumetric strain, approximated in 1D as

$$j \approx {ρ}_{1} \frac{κ K}{μ} \frac{Δε}{L}$$

where is the ρ₁ is the liquid density, μ is the liquid dynamic viscosity, and L is the gel thickness. Here, the quantity of κK/μ [m²s⁻¹] forms a composite transport quantity called poroelastic diffusivity, Dₚₑ, describing the speed of permeation—preliminary experiments have determined a value of around ˜10⁻¹⁰ m²/s for simple hydrogels. Louf J-F, Datta S S (2021) Poroelastic shape relaxation of hydrogel particles. Soft Matter, 17 (14): 3840-3847. https://doi.org/10.1039/D0SM02243H. From this analysis, the gel permeability and stiffness should be maximized while remaining as thin as possible to capture water at fast rates. To aid understanding of such a complex multiphysical transport problem in and around gels, dimensional analysis is employed to identify important dimensionless parameters. This way, an organized, intuitive map of the complex multiphysical transport space as shown in Table 1 (FIG. 23) can be built. Some of these multiphysical processes in and around gels is illustrated in preliminary FEM modeling (FIG. 17).

### Transport Considerations During Evaporation

At the evaporator gel, the same balance of fluxes between liquid permeation and vapor transport as the condenser gel applies. Here, the vapor driving force is a result of higher vapor pressure at the evaporator versus the saturated vapor condition at the colder, ambient-temperature condenser (dew condensation). Similar to the capture gel, to maximize u, it is important to maximize κ, K, and hₘₜ as well as minimize L. The main limitation at the evaporator, however, will be utilizing as much solar heat as possible to drive evaporation. From the energy balance at the evaporator gel-air interface,

$${q}_{solar}^{″} \approx u {ρ}_{1} {h}_{fg} + {k}_{gel} \frac{Δ T}{L} + ε σ ( {T}_{s}^{4} - {T}_{surr}^{4} )$$

Some of the radiative solar input,

$${q}_{solar}^{″} ,$$

goes toward evaporation, uρ₁h_{fg}, While some is lost toward conduction,

$${k}_{gel} \frac{Δ T}{L}$$

and emission,

$$εσ ( {T}_{s}^{4} - {T}_{surr}^{4} ) ,$$

where ΔT is the temperature difference across the evaporator gel. Thus, to maximize water flux for a given solar heat input, it is important to lower conductivity of the evaporator gel as much as possible. Since low thermal conductivity is the opposite of what is required for the capture gel, how hydrogel properties can be tuned should be investigated. The intent is to modify properties through functionalization and incorporate composite materials. For instance, a floating hydrogel composite with thermally insulating solar absorptive properties shown in FIG. 14 (top right) has been preliminarily fabricated.

There are also further scientific questions involved in phase-change heat transfer mediated by polymeric gels that can be investigated. Given the nanoporous nature of these gels, it is expected capillarity can play a significant role during evaporation. Presumably, these surface tension effects would significantly compress hydrogels at the evaporative interface affecting transport behavior. Recent investigations with solar distillation using hydrogels have shown surprisingly efficient conversion of solar heat to evaporation, approaching kinetic limits that are not attainable for normal liquid-vapor interfaces. Shi Y, Ilic O, Atwater H A, Greer J R (2021) All-day fresh water harvesting by microstructured hydrogel membranes. Nature Communications, 12(1):2797. https://doi.org/10.1038/s41467-021-23174-0; Guo Y, Zhao F, Zhou X, Chen Z, Y u G (2019) Tailoring Nanoscale Surface Topography of Hydrogel for Efficient Solar Vapor Generation. Nano Letters, 19(4):2530-2536. https://doi.org/10.1021/acs.nanolett.9b00252; Zhao F, Zhou X, Shi Y, Qian X, Alexander M, Zhao X, Mendez S, Y ang R, Qu L, Yu G (2018) Highly efficient solar vapour generation via hierarchically nanostructured gels. Nature Nanotechnology, 13(6):489-495. https://doi.org/10.1038/s41565-018-0097-z. This suggests that gel mediation could provide beneficial effects localized to the evaporative interface.

### Research Plans

To investigate the proposed gel-based water harvesting approach, three main research tasks may be completed: (1) study the heat and mass transport bottlenecks, (2) uncover the transport-relevant material physics that dictate material bottlenecks, and (3) study system behavior and discover prototype designs that operate in a wide variety of conditions.

### Task 1: Study the Heat and Mass Transport

In Task 1, heat and mass transfer topics specific to the proposed AWH approach may be studied. Important bottlenecks may be identified and different transport regimes may be classified in the context of dimensionless variables that quantify competitions between different physical phenomena (Table 1, FIG. 23).

Task 1a: Modeling and simulating transport in various domains. It may be assumed a poroelastic Darcy flow to exist within the gel such that the superficial velocity is related to a gradient in volumetric strain: u=Dₚₑ∇ε. With this superficial velocity, steady-state conservation of mass (∇·u=0), ions (u·∇c=∇·(Dᵢₒₙ∇c)), and heat energy (ρ_{gel}c_{p,gel}u·∇T=∇·(k_{gel}∇T)) may be expressed. Preliminary FEM results of these equations are shown in FIG. 17. Simultaneously, gel deformation according to finite strain theory may be solved for. Only very recently have there been attempts to couple some of these PDEs together to understand transport through hydrogels—however, a more complete model does not currently exist that, for instance, incorporates deformation and swelling-dependent properties. Díaz-Marín CD, Zhang L, Fil B El, Lu Z, Alshrah M, Grossman J C, Wang E N (2022) Heat and mass transfer in hygroscopic hydrogels. International Journal of Heat and Mass Transfer, 195:123103. https://doi.org/10.1016/J.IJHEATMASSTRANSFER.2022.123103. As such, the final forms of the PDEs can evolve as the best way to treat certain complexities are determined. For instance, the poroelastic diffusion coefficient can varie nonlinearly with other properties and gradients in humidity, osmotic pressure, concentration, and capillary pressure. Thus, new theoretical ground in how to model transport through soft polymeric materials with spatially varying properties can be broken. In any case, the governing equations can be solved using a bespoke finite-element method (FEM) approach, leveraging expertise in solving custom PDEs to solve challenging transport problems in non-conventional, soft matter systems. Cho H J, Lu N B, Howard M P, Adams R A, Datta S S (2019) Crack formation and self-closing in shrinkable, granular packings. Soft Matter, 15(23):4689-4702. https://doi.org/10.1039/C9SM00731H. Due to the intricacies of this modeling, one additional set of physics (essentially a PDE) can be coupled approximately every year, allowing ample time to perform experimental validation.

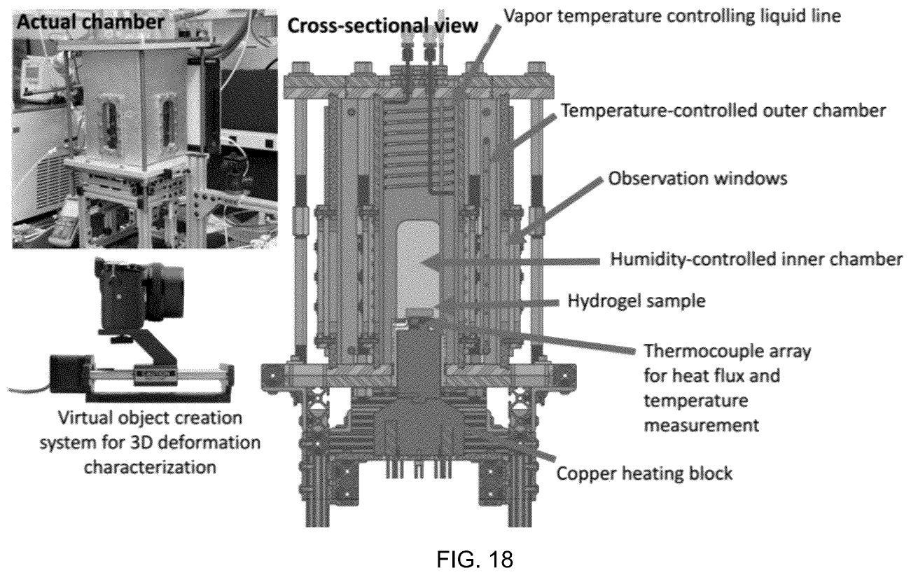

Task 1b: Validate transport model with experiments. Models of transport through the capture and evaporator gels by varying gel material properties (Task 2) and exposing them to varying temperature and humidity conditions may be tested. Leveraging experience in building heat transfer experiments, a custom environmental chamber to perform steady-state heat transfer and cyclic tests with in situ 3D observation using virtual object creation imaging (FIG. 18) may be used. This way, a rich set of validation data with simultaneous mechanical and heat-transfer measurements may be provided. The timing of validations can follow new additions to the computational model (Task 1a) and newly discovered material property relations (Task 2). With well-controlled experiments the unknown transport dynamics observed in preliminary work (FIG. 11b) may be determined.

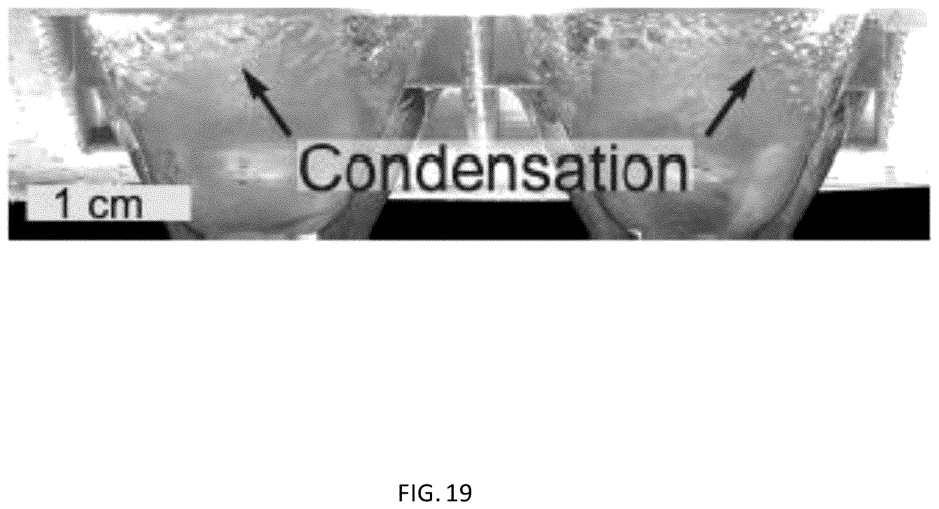

Task 1c: Investigate localized phase-change effects. The liquid-vapor phase-change processes occurring at the gel-air interfaces represent the least understood set of phenomena to be encountered. Preliminary testing has shown that dropwise condensation could be occurring at the capture gel, complicating evaluation of the mass-transfer and heat-transfer coefficients (FIG. 19). If the observed effects are true dropwise condensation, then wettability and droplet nucleation would play an important role. Based on preliminary results, it is indicated that wetting properties significantly change between highly swollen and partially swollen states, signifying that dropwise to filmwise transitions could be humidity dependent. Furthermore, unlike traditional condensation where removal must occur, here, droplets are “removed” via absorption and permeation through the gel itself—a very different, un-studied process that is likely encountered in nature. On the evaporator side, it is expected that capillarity can play an important role in setting the outlet boundary condition of water. Currently, it is an open question as to how certain hydrogels are effectively mediating thermal conversion at near-kinetic-limit rates. Zhao F, Zhou X, Shi Y, Qian X, Alexander M, Zhao X, Mendez S, Y ang R, Qu L, Y u G (2018) Highly efficient solar vapour generation via hierarchically nanostructured gels. Nature Nanotechnology, 13(6):489-495. https://doi.org/10.1038/s41565-018-0097-z. One risk of the study is that one sun of radiation may not be able to sufficiently heat the evaporation surface to above the elevated boiling point of the ionic solution-however, preliminary analysis indicates this is possible. Nonetheless, a contingency plan may be to fall back to a solar-assisted solution where additional heating power would be provided by external power. Following the trajectory of preliminary investigation, study of capture gels may be continued before studying evaporator gels. Results of Task 1c can feed into the model of Task 1a.

### Task 2: Uncover the Material Physics Unlock New Harvesting Capabilities

The hypothesis is that the poroelastic diffusivity,

$${D}_{pe} = \frac{κ K}{μ} ,$$

must be as high as possible for high water throughput through the gel. This involves increasing permeability, κ, and stiffness, K. On the other hand, thermal conductivity needs to be tuned separately for capture and evaporator gels. All of these behaviors need to be studied in the context of varying gradients.

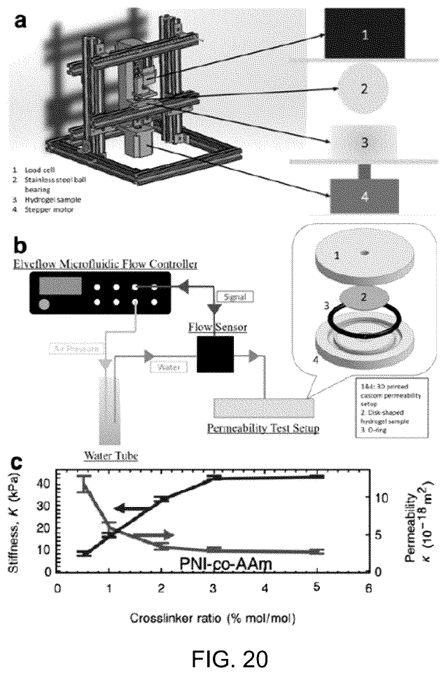

Task 2a: Playing with polymer chemistry and structure to increase poroelastic diffusivity. Typically, hydrogels can be modified through crosslinking. Gao Y, Chai N K K, Garakani N, Datta S S, Cho H J (2021) Scaling laws to predict humidity-induced swelling and stiffness in hydrogels. Soft Matter, 17(43):9893-9900. https://doi.org/10.1039/D1SM01186C. Using a custom-built permeation cell, preliminary results indicate that lower crosslinking can increase permeability (FIG. 20). To better guide permeability optimization, the microstructure of gels using scanning electron microscopy (SEM) may be characterized. Like permeability, stiffness can also be modified through crosslinking (e.g., methylenebisacrylamide in polyacrylamide). However, using a custom-built indentation tester, preliminary results indicate that stiffness responds inversely with permeability (FIG. 20). Gao Y, Chai N K K, Garakani N, Datta S S, Cho H J (2021) Scaling laws to predict humidity-induced swelling and stiffness in hydrogels. Soft Matter, 17(43):9893-9900. https://doi.org/10.1039/D1SM01186C. This trade-off effect may be fundamentally rooted in the average spacings between polymer gels. Semi-dilute polymer physics may be incorporated to confirm this relationship. Gennes P-G de (1979) Scaling Concepts in Polymer Physics. http://books.google.com/books?id=ApzfJ2LYwGUC&printsec=frontcover&dq=intitle:Scaling+Concepts+inauthor:de+gennes&hl=&cd=1&source=gbs_api. If this is true, ways to break this trade-off behavior through functionalization and incorporation of micron-scale channels and pores through freeze-thaw and freeze-dry processing may be explored. Annabi N, Nichol J W, Zhong X, Ji C, Koshy S, Khademhosseini A, Dehghani F (2010) Controlling the porosity and microarchitecture of hydrogels for tissue engineering. Tissue Engineering-Part B: Reviews, 16(4):371-383. https://doi.org/10.1089/ten.teb.2009.0639. The idea is to use the nucleation of ice crystals to create large voids in the gel. Based on preliminary measurements of permeability and stiffness, Dₚₑ is ˜10⁻¹⁰ m² s⁻¹. Based on geometric and fluid flow arguments, incorporation of large-scale channels could increase this by an order of magnitude, in alignment with the order-of-magnitude capture rate improvement target (FIG. 11a). Hence, a target metric of ˜10⁻⁹ m² s⁻¹ may be set. In addition to increasing Dₚₑ, gels should be highly stretchable in order to facilitate thin membranes since decreasing thickness, L, improves overall transport. Inspired by recent work on highly entangled gels, preliminary work on how maximum strain can be improved to produce strong, stretchable, thin gels has begun. Kim J, Zhang G, Shi M, Suo Z (2021) Fracture, fatigue, and friction of polymers in which entanglements greatly outnumber cross-links. Science, 374(6564):212-216. https://doi.org/10.1126/science.abg6320.

Task 2b: Characterizing responses to thermal, humidity, pressure, and ion concentration gradients. Under AWH operation, gels can be subjected to a variety of different gradients. Extending previous work where semi-dilute polymer physics were applied to develop scaling laws that describe dependencies on humidity and swelling, it is expected that similar scaling laws may result for thermal and ion concentration differences. Gao Y, Chai N K K, Garakani N, Datta S S, Cho H J (2021) Scaling laws to predict humidity-induced swelling and stiffness in hydrogels. Soft Matter, 17(43):9893-9900. https://doi.org/10.1039/D1SM01186C. When these conditions are spatially varying, the way the material will respond can be investigated (e.g.: does stiffness respond to the gradient in in local swelling or ion-mediated osmotic pressure; are there differences between humidity gradients versus ion-concentration gradients with respect to permeability and stiffness responses) that may be investigated. With high salt concentrations, there is a possibility for salt fouling to occur. This can be prevented by ensuring the poroelastic diffusivity is greater than the diffusivity of ions

$$( \frac{{D}_{pe}}{{D}_{ion}} > 1 ;$$

Table 1, FIG. 23); however, how ion diffusivity changes at high concentrations within hydrogels may be investigated as this is currently unknown.

Task 2c: Discover ways to modify and tune thermal conductivity. As explained previously, the capture gel should be as conductive as possible in order lower ρₛ and maximize water throughput. On the other hand, the evaporator gel should be as insulating as possible to minimize heat losses. Maxwell effective thermal conductivity rules may apply for hydrogels, enabling conductivity to be tuned via composites. Pietrak K, Wiśniewski T (2015) A review of models for effective thermal conductivity of composite materials. Journal of Power of Technologies, 95(1):14-24. Incorporation of low-density insulators or conductive metal meshes could provide low and high thermal conductivities, respectively. Thermal conductivities may be tested by imposing temperature boundary conditions via custom apparatuses and lab chillers. Specific heat capacity and latent heat changes may be tested using differential scanning calorimetry (DSC) along with characterization techniques. Kim H, Cho H-JJ, Narayanan S, Y ang S, Furukawa H, Schiffres S, Li X, Zhang Y-B, Jiang J, Y aghi OM, Wang E N (2016) Characterization of Adsorption Enthalpy of Novel Water-Stable Zeolites and Metal Organic Frameworks. Scientific Reports, 1-8. The biggest risk with Task 1 may be that the tunability in thermal conductivity may be very limited. The contingency plan may be to look into geometric means (e.g., surface area increases and thinner gels), rather than material properties, to achieve desired heat transfer characteristics.

### Task 3: Model System Dynamics in Varied Environments and Discover New Prototype Designs

In Task 3, understanding the behavior of the total system may be the focus, providing valuable insight on how to design and operate the AWH approach in different environments.

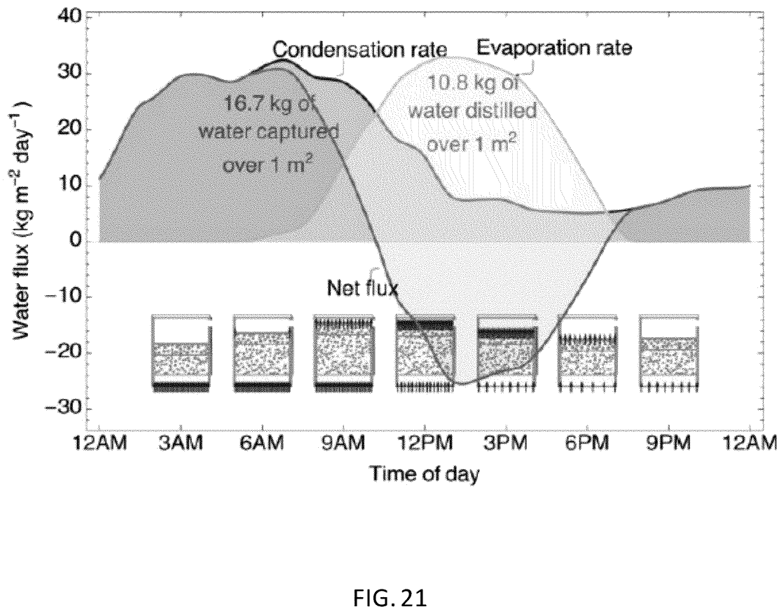

Task 3a: Model system behavior at different conditions. The approach comprises a transistor-like system where system behavior changes completely depending on operating conditions. Thus, using weather data curated from Wolfram Research and the National Solar Radiation Database, performance in locations throughout the country (a demonstration of an ability to perform these types of calculations is shown in FIG. 10) may be simulated. WolframResearch, Research W (2014) WeatherData. https://reference.wolfram.com/language/ref/WeatherData.html; NREL (2021) National Solar Radiation Database. https://nsrdb.nrel.gov/. Variations in condensation and evaporation rates can be calculated using time-dependent data as shown in FIG. 21. The system can be controlled and regulated to ensure that the liquid basin does not deplete to low levels or accumulate beyond the container capacity. Ideally, this control scheme could be done passively wherein a fixed amount of salt ensures that condensation rates slow down as the basin fills up (since concentration would decrease and RH would increase). Conversely, if evaporation is too fast, depleting the basin, concentration would increase, raising the boiling point to slow down evaporation. Thus, there are potential passive control mechanisms through design of the basin and amount of ions that can be investigated and modeled.

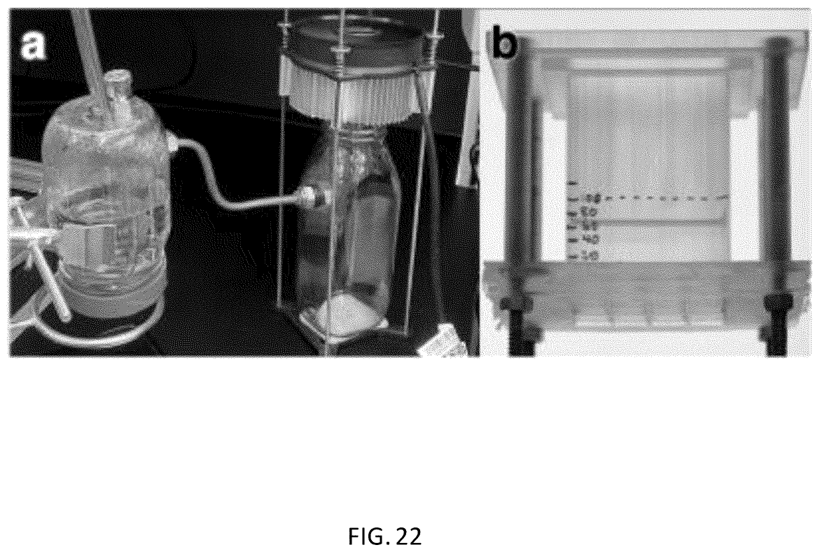

Task 3b: Build and test prototype devices to test in the lab and the field. I have often found students to learn more rapidly from physical prototypes and experiments over models and descriptions alone. Preliminary prototypes to demonstrate certain aspects of the water harvesting system (FIG. 22) have been built. With successive iterations, capture rate in controlled environments, geometric features such as surface area enhancement, evaporator performance under a heater and solar simulator, incorporating composite evaporator gels, understand dynamics of day/night cycles in different environments, etc. may be the focus. Thus, the effects of separately controlling the capture and evaporator conditions may be understood.

Task 3c: Water quality testing. To demonstrate the broader impact on solving a water scarcity issue, the harvester should be safe to use. The quality of the harvest water may be tested. One risk of this Task is that distillation may not be able to fully remove ions or other contaminants to potable levels. For instance, lithium ion content in water should be less than <10 μg/L—an evaluation metric target. Lindsey B D, Belitz K, Cravotta C A, Toccalino P L, Dubrovsky N M (2021) Lithium in groundwater used for drinking-water supply in the United States. Science of The Total Environment, 767:144691. https://doi.org/10.1016/J.SCITOTENV.2020.144691. The contingency would be to incorporate further filtration, reverse osmosis, or consider non-potable usage for harvested water. In any case, the results of this water quality testing may also guide further study on how to refine the approach or incorporate further filtering/purification.

### Example 4

The following example containing additional details regarding the disclosed systems and methods. The example describes an aspect of the disclosure describing the pathway of water traversal through a gel material from vapor to liquid form for purposes of humidity control in an aircraft carrier. The example describes a process by which water existing in vapor form (in this case water vapor in an aircraft cockpit), moves toward and through a condensing gel. In one aspect, the condensing gel is a solid-state iongel condenser. In one aspect the condensing gel may be a hydrogel material (e.g., water-absorbing polymeric material) that condenses the water vapor on or within the hydrogel material. The condensed water moves through the condensing gel to a liquid desiccant. In one aspect, the liquid desiccant may be a salt solution. The atmospheric water harvesting device disclosed herein may similarly capture water vapor from the ambient air and transfer the condensed vapor to a liquid desiccant (i.e. salt solution) using the same or similar materials and processes disclosed in the appendix. However, whereas the atmospheric water harvesting device may further distill, filter, and/or purify/separate the captured water to create pure liquid water form, the example describes further processes to discard the captured water for purposes of aircraft humidity removal.

In the example, research on multifunctional iongel condenser materials for thermal and humidity control is performed. Proper temperature control, moisture removal, and dehumidification of air supplied to the cabin or cockpit is necessary to develop lightweight and reliable aircraft, as well as provide a safe operating environment for the crew. It is contemplated that a hydrogel material embedded with salt—termed an iongel—be used to effectively control temperature, remove moisture, and regulate humidity. The iongel provides thermophysical properties similar to liquid water, but with the mechanical properties of a solid. This solid-state, water-like material opens up a new design space where transport can be maximized through high-surface-area geometries and system complexity can be reduced through the leveraging of multifunctional behavior inherent in the gel. Specifically, the gel is multifunctional in that it can act as a filter trap to remove small droplet moisture in air, a high-surface-area heat exchanger for temperature control, a condenser to dehumidify humid air, and an evaporator to humidify dry air. To investigate this potential technology, the following objectives are explored.
1. Synthesize and optimize material properties of iongel materials where it is contemplated that polyacrylamide-based hydrogels with high crosslinking and porous cavities can provide high water throughput
2. Model and simulate water, salt and thermal transport through iongel materials where it is contemplated that high mechanical stiffness, high permeability, high thermal conductivity, and small condenser length scale can provide optimal performance
3. Fabricate and optimize iongel condensers in a bulb array using materials synthesized and design parameters obtained from models and simulations.

This work can pave the way for responsive hydrogels for autonomic thermal, moisture, and humidity control, enabling safer, more maneuverable aerospace vehicles and platforms with unprecedented performance characteristics for Air Force applications.

### Research Effort

### 4.1 Unmet Needs

Proper air conditioning in aircraft is critical for pilot performance and safety [1], as well as aircraft reliability [2]. This conditioning includes temperature control, moisture removal, and humidity regulation. Traditionally, air conditioning is performed in the environmental control system (ECS) [3]—a complex system of mixers, pumps, and heat exchangers that combines ram air (cold air from outside) and bleed air (hot air from the engine) to provide conditioned air into the cockpit and/or cabin. Moisture removal is a critical task of the ECS as moisture poses significant dangers such as corrosion that can hamper the structural integrity of aircraft [4]. Specific to the Air Force, a previous study identified that moisture routinely enters F-16 cockpits through condensation, open canopies, the ECS, and other routes [5]. This moisture is absorbed and retained within insulation blankets, which is a common hindrance in aircraft [6]. Without proper drainage, water can break down protective coatings, cause corrosion, and even promote damaging microbial growth [5].

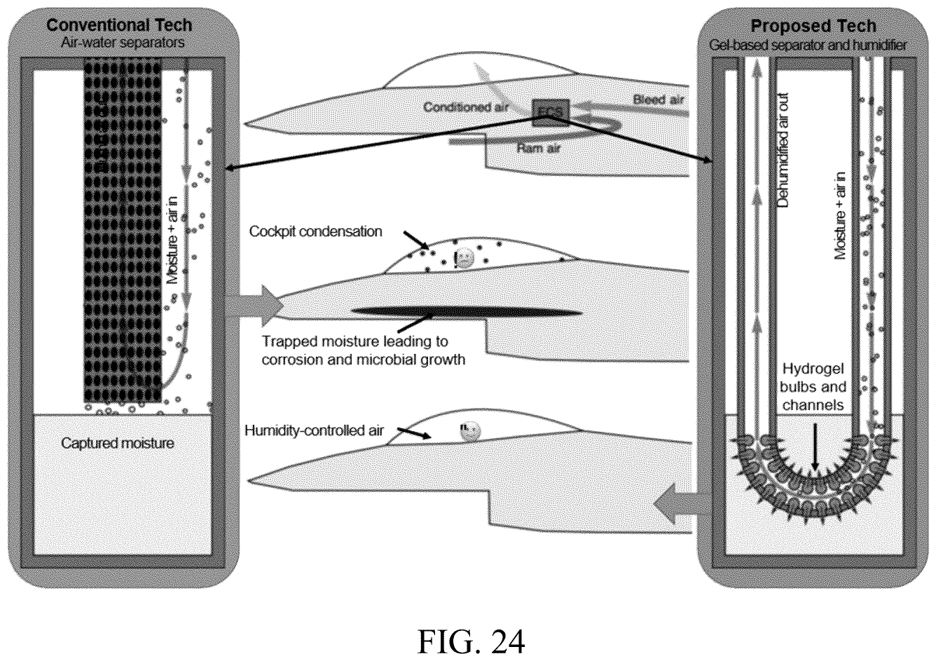

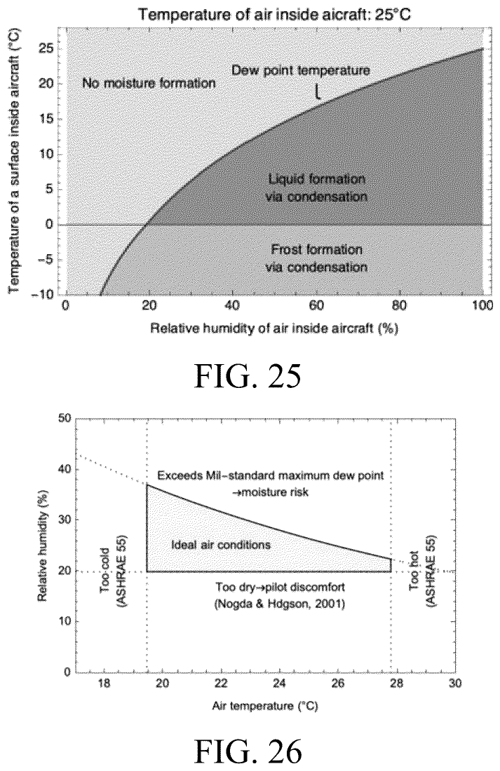

Moisture can occur from two sources: (1) small droplets flowing in air and (2) humid air that can condense liquid water on cold surfaces. Traditional ECS systems only implement moisture removal of the first type, what is called call moisture removal as opposed to dehumidification, which addresses the second type. This moisture removal occurs at the water separator (FIG. 24), which is a physical filter/barrier that removes small liquid droplets. However, water separators do not dehumidify the air; thus, air can remain humid and can condense on any surfaces that are below the dew point. The dew point is the temperature below which water condenses (FIG. 25). As long as surfaces inside the aircraft are maintained above the dew point, moisture does not form. Since the dew point increases with humidity, to provide the largest protection against moisture formation, relative humidity should be as low as possible. Thus, dehumidifying air can increase the safety margin of operating aircraft. However, for optimal crew comfort and performance, humidity should not be too low (<20%) [7, 8]. There is therefore a need to regulate humidity around a target level, in a simple lightweight package. To fulfill this need, it is contemplated that using an iongel-based condenser with a solid-state design that provides multifunctional behavior: (1) regulation of humidity to a target level, (2) direct removal of moisture droplets in air, and (3) control of air temperature to a desired level. Additionally, since the condenser design relies on the natural behavior of iongel materials, the regulation of humidity in the disclosed approach is autonomic.

### 4.2 Background

Background information on ideal air conditions for aircraft is provided, followed by a discussion of the existing approaches to achieve those conditions, and a subsequent discussion the physical principles of the approach disclosed below.

### 4.2.1 Ideal Air Conditions

The U.S. military sets standards and requirements for cabin air conditions as laid out in Mil standard MIL-E-18927E(AS). Some key requirements are listed in Table 1 below.

TABLE 1
Air delivery requirements according
to Mil standard MIL-E-18927E(AS)

| Description | Quantity | Notes |
|---|---|---|
| Cabin air pressure | 753 mbar (8,000 | Isobaric zone when |
| | ft altitude equivalent) | altitude is between |
| | | 8,000 and 23,000 ft |
| Cabin wet-bulb globe | 15.6° C.-26.7° C. | Can be outside of |
| temperature (WBGT) | (comfort zone) | this zone temporarily |
| Cabin dew point | 4.4° C. | |
| temperature | | |

The Mil standard uses an effective temperature known as the wet-bulb globe temperature (WBGT) to evaluate thermal comfort. The WBGT takes into account humidity and radiation. Specifically, the WBGT is a weighted average of the wet-bulb temperature, black-globe temperature, and dry-bulb temperature (all measured in Celsius):

$$WBGT = {0.7}_{{w}^{b}} + 0 . {2}_{bg} + {0.1}_{db} \qquad ( 1 )$$

Developed in the 1950s to combat heat stress in soldiers, the WBGT is known to have flaws and limitations with regard to capturing the effects of humidity and perspiration [9]. The WBGT heavily weights the wet-bulb temperature over the true temperature of the air (dry-bulb temperature). WBGT requirements are also not consistent with humidity requirements inside aircraft where the dew point must be greater than 4.4° C. For instance, operating at a web-bulb temperature of 20° C., a black-globe temperature of 0° C. (no radiation), and a dry-bulb temperature of 21° C. results in an acceptable WBGT of 16.1° C. but an unacceptably high dew point temperature of 19.4° C., leading to a high-humidity environment. The wet-bulb temperature could even be increased beyond saturation, all but ensuring damaging condensation within the cockpit, and still be within the defined comfort levels for WBGT. Due to the WBGT's substantial weighting on the wet-bulb temperature, to meet the requirement for a maximum dew point temperature of 4.4° C., the true (dry-bulb) air temperature would need to be 39° C., which is incredibly warm for human comfort and well exceeds the ASHRA E 55 standard maximum indoor temperature of 28° C. In fact, in the absence of a significant radiant heat source (e.g. night-time flying or crew in a covered section), there is absolutely no way to satisfy the Mil-standard WBGT requirements, Mil-standard dew point requirements, and maintain comfortable temperatures (as defined by ASHRAE). Thus, based on this incompatibility of standards, reports of moisture build-up in military aircraft [5], and the fact that traditional ECS systems have no means to dehumidify air, it highly likely that humidity levels in practice exceed design specifications.

Rather than rely on the Mil-spec defined WBGT requirements to find optimal air conditions, the disclosed methods rely on Mil-spec defined dew point requirements (cannot exceed 4.4° C.) for maximum humidity, ASHRAE 55 temperature specifications, and the results of numerous studies showing that substantial crew discomfort can occur below humidities of approximately −20% [8]. Within these specifications, there is a region of ideal air conditions as shown in FIG. 36 and detailed below in Table 2.

TABLE 2
Ideal air conditions as defined by a
collection of standards and studies

| Description | Quantity | Source |
|---|---|---|
| Maximum dew point | 4.4° C. | MIL-E-18927E(AS) |
| temperature | | |
| Air temperature range | 19.4° C.-27.8° C. | ASHRAE 55 |
| Maximum humidity range | 37.2% at 19.4° C. | Calculated from |
| | 22.5% at 27.8° C. | MIL-E-18927E(AS) |
| | | and ASHRAE 55 |
| Minimum humidity | −20% | Nagda & Hodgson, |
| | | 2001 [8] (review) |

### 4.2.2 Existing Approaches for Air Conditioning

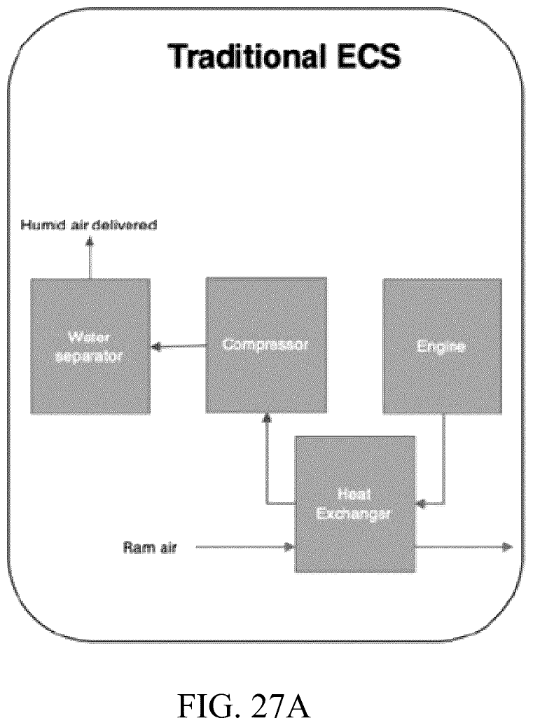

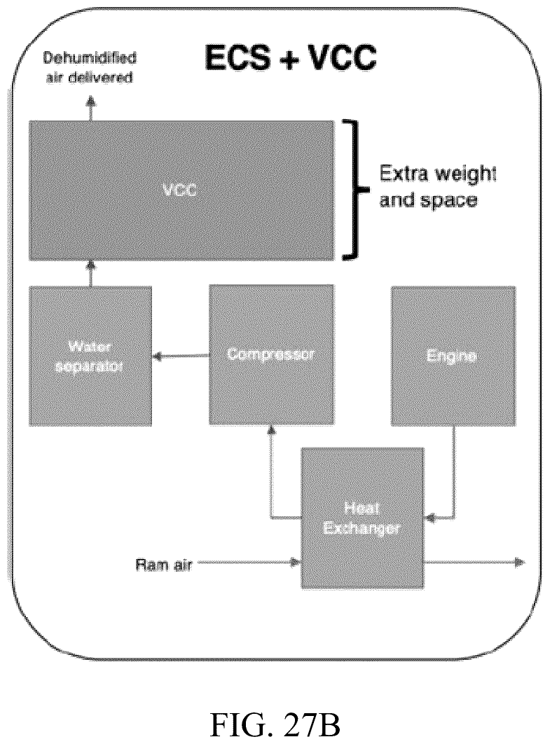

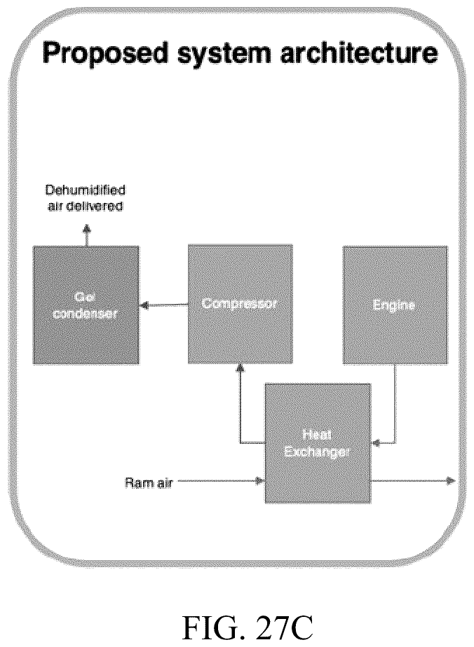

As mentioned previously, traditional ECS systems employ physical separation techniques to remove moisture in air, but cannot directly dehumidify the air itself [3] (FIG. 24), leading to documented instances of moisture and corrosion [5]. One way to dehumidify the air is to use a thermal separation technique wherein water vapor in humid air condenses on a cold condenser before being delivered to the cockpit/cabin. This thermal separation requires that the cold condenser be below the dew point temperature. To do so, a cold source (such as from ram air) needs to be routed into the ECS via one or more heat exchangers, adding to system complexity and weight. In newer ECS systems, electronically-controlled vapor compression cycles (VCCs) are often employed to achieve this cold temperature [10]. VCCs—commonly employed in refrigeration and HVAC—use the evaporation and condensation of a refrigerant to achieve these low temperatures. However, VCCs add substantial system weight, volume, and complexity as shown in FIG. 27. Therefore, there is a need for a smaller-footprint, simple moisture removal and dehumidification system for cabin/cockpit air delivery.

### 4.2.3 the Liquid Desiccation Approach

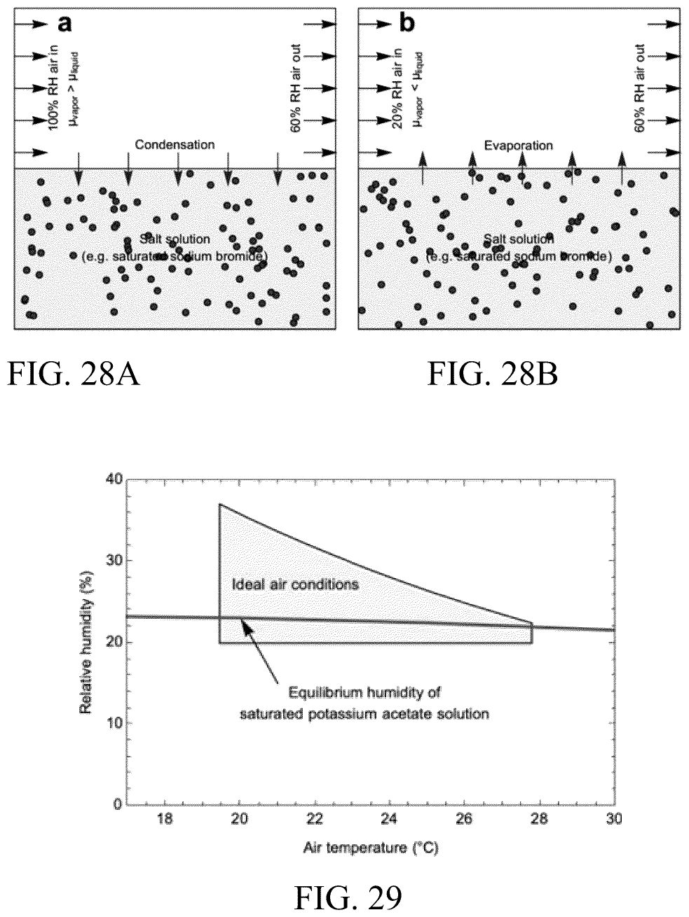

Rather than rely on physical and/or thermal separation techniques, the disclosed approach relies on a chemical separation technique. This technique works on the tendency of a chemical species—water in this case—to migrate toward lower chemical potentials. One way to create a chemical potential sink is to add salt to liquid water, resulting in a salt solution. This lowering of chemical potential is evident in the humidity in the vicinity the liquid solution. In pure water, the relative humidity very close to the liquid-vapor interface would be 100%. However, in a saturated-sodium-chloride solution, this relative humidity would be around 75% [11]. With different salts, this humidity could be lowered even further, e.g. with lithium chloride, the relative humidity could even be as low as 7% [11]. With their low humidities, salt solutions—or liquid desiccants—can spontaneously absorb water from humid air (dehumidification) as long as the humidity is above the equilibrium value of the salt solution as illustrated in FIG. 28. To deliver ideal aircraft cockpit/cabin air at the tightly-defined conditions shown in FIG. 26 and Table 2, saturated potassium acetate solution would be a desirable liquid desiccant candidate as it has an equilibrium humidity value around 21-22% over a wide temperature range as shown in FIG. 29. In addition, as a food-safe chemical, potassium acetate would not jeopardize the health and safety of the crew.

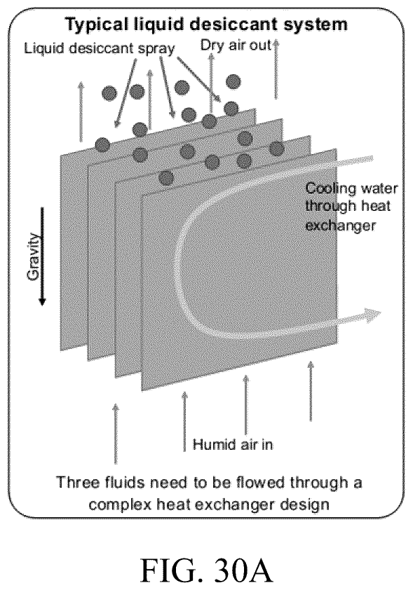

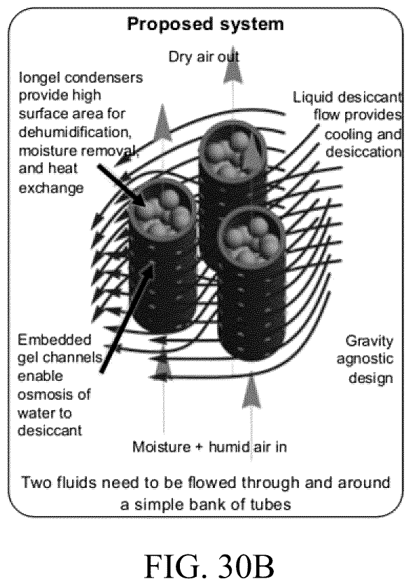

Liquid desiccant systems are a relatively mature technology and have been proven to be effective as dehumidifiers for commercial air conditioning systems [12]. However, such systems have not been implemented for aerospace applications. A challenge with implementing liquid desiccants is that they must flow through a complex heat exchanger involving air flow, sprayed liquid desiccant flow, and cooling water flow (see FIG. 30). As liquid desiccant is sprayed, the large liquid-vapor surface area provides ample heat and mass transfer area for rapid dehumidification of the air that passes in cross-flow with respect to the spray.

Dehumidification is an exothermal process, as such, it is necessary to cool the air with an amount equivalent to the latent heat of phase-change. This cooling is provided by a separate water flow through a finned heat exchanger. The sprayed desiccant falls downward with gravity and is collected at the bottom. As such, these systems rely on a consistent orientation of gravity. Given the numerous complications of these liquid desiccant systems, existing designs would not be conducive to aerospace applications. Many of the complexities with these systems stem from the fact that liquid desiccants are liquid in nature that need to be sprayed and therefore require flow and droplet shape to be controlled.

### 4.2.4 Description of the Proposed Approach: Solid-State Iongel Condensers

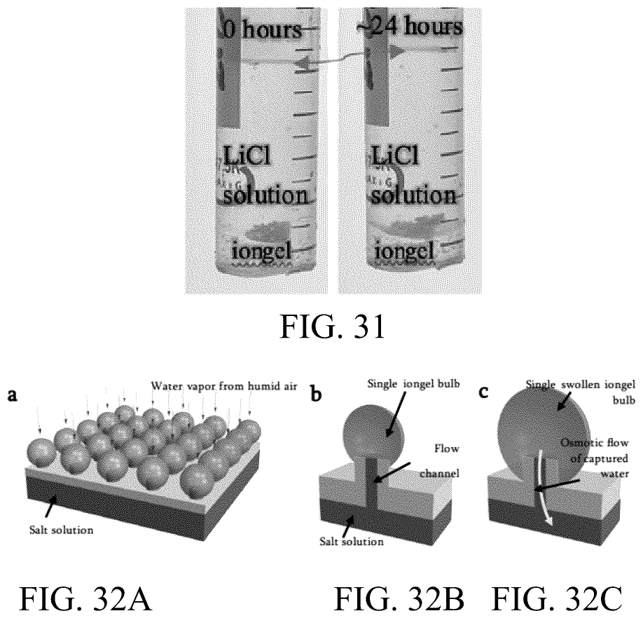

The disclosed examples combine the benefits of a liquid desiccant system with the simplicity of a solid-state system. It is contemplated that using a solid-state, high-surface-area iongel condenser in contact with a liquid desiccant can provide moisture removal, dehumidification, and temperature control in a small, simple package. The proposed solution would enable lighter, more maneuverable aircraft and provide more optimal air delivery for pilot performance and aircraft longevity. The key to the disclosed approach is the development of bulb-shaped iongel condensers (FIG. 30, right), resembling droplets, with high surface area for rapid heat and mass transfer. As such, the disclosed approach has superficial similarities to a conventional spray liquid desiccant system in that the humid air flows over a spherically shaped desiccant, with the exception that in the disclosed case, the captured water is transported directly to a surrounding reservoir. The gel itself can be a polymeric network (e.g. polyacrylamide) swollen with liquid desiccant solution. Since a large portion of the volume can be taken up by the liquid solution, the gel can have thermophysical properties similar to the liquid itself. However, unlike the liquid solution, the gel can mechanically behave as a soft solid, allowing it to retain its bulbous shape. Preliminary results show that the liquid desiccant-enabled dehumidification effect does indeed work with iongels. In the lab, iongels equilibrated with lithium chloride solution have been created, and dehumidification and resultant water capture over a span of time have been demonstrated, as shown in FIG. 31.

TABLE 3
Overview of features of the proposed approach in comparison to existing approaches

| | Existing approaches | | Proposed approach | |
|---|---|---|---|---|
| Function | Equipment | Control scheme | Equipment | Control scheme |
| Temperature control | Multiple heat ex- | Manipulation of | Iongel condenser | Manipulation of |
| | changers between | valves | structures | valves to control |
| | | | surrounded | temperature of [symbol] |
| Humidity regulation | None or VCC | None or elec- | by temperature- | Autonomously |
| | | tronically con- | controlled | controlled by salt |
| | | [symbol] | liquid desiccant | |
| Moisture removal | Water separator | Passive | | Passive |

[symbol]

indicates data missing or illegible when filed

### 4.3.1 Hydrogels and Iongels

Hydrogels are polymeric materials with a polymer-mesh backbone that can swell with water many times its dry volume [13]. Hydrogels are used in a variety of applications ranging from agriculture to biomedicine. Recently, hydrogels have been investigated for water harvesting applications that rely on the same physical principles of dehumidification [14-16]. Since swollen hydrogels are composed mostly of water, they should have thermophysical properties (density, thermal conductivity, specific heat) nearly identical to water. However, unlike water, hydrogels behave like elastic or viscoelastic solids [17]. The solid-like behavior is enabled by the inclusion of crosslinks within the polymer matrix. The higher the crosslinking density, the higher the mechanical stiffness. As previously studied by the PI [18], hydrogels have a mechanical stiffness defined by an elastic bulk modulus, K, where

$$K = V \frac{\partial p}{\partial v} = - V \frac{\partial π}{\partial v} \qquad ( 2 )$$

V is the volume of the gel, p is the internal pore pressure inside a gel (as a porous medium), and π is the osmotic pressure. As the internal pore pressure inside a gel increases (more swelling), the volume increases. At the same time, a more swollen hydrogel has a lower concentration of monomer units, leading to a lower osmotic pressure. The degree of swelling is denoted using a volumetric strain term, εₛ, where

$${ε}_{s} ≡ \frac{Δ V}{V} \qquad ( 3 )$$

and ΔV is a change in volume purely due to swelling (not stress). Combining Equations 2 and 3, it is found that

$$\partial p = - \partial π = K \partial {ε}_{s} \qquad ( 4 )$$

that is, a change in pressure is related to a change in volumetric strain.

Iongels, on the other hand, are hydrogels that are equilibrated in salt solutions [15, 16, 19]. As such, iongels have salt embedded within themselves. Given that salt increases the osmotic pressure, iongels are shrunken from their salt-free state, pure water state.

4.3.2 Multifunctional Iongel Bulb Design and Transport within the Gel

Dehumificiation and moisture removal involves an osmotic process: an interplay between stiffness, water transport and salt diffusion. Water transports through hydrogels either though the polymer mesh itself (pore size ˜10-100 nm) or through larger pores (˜1-100 μm) created through a post-synthesis treatment. By way of this transport, the absorbed water resultant from dehumidification moves through the material like a sponge as shown in FIG. 32. Within the gel, the driving force for transport is an osmotic pressure gradient, which stem from chemical potential differences. Equivalently, through poroelastic relations, this osmotic pressure gradient translates to a mechanical pressure gradient seen in typical porous media flow problems.

To understand the performance of the iongel material system, it is necessary to model how the several key components are transported within the gel:
1. The flow of liquid desiccant solution that is swollen within the poroelastic gel (velocity field)
2. The concentration of salt within the liquid solution (concentration field)
3. Thermal energy within the gel (temperature field)
   Using Darcy's law of porous media flow and Equation 4, the superficial velocity u (flux of volumetric flow), is related to the gradient of the volumetric strain field, εₛ:

$$u = - \frac{k}{μ} ∇ p = - \frac{k}{μ} K ∇ {ε}_{s} \qquad ( 5 )$$

where κ is the absolute permeability and μ is the viscosity of the flowing solution. That is, liquid solution flows from high volumetric strain, es (regions of high swelling), to low volumetric strain. At steady-state, the conservation of liquid desiccant solution results in the divergence of the superficial flow being zero:

$$∇ \cdot u = - ∇ \cdot ( \frac{k}{μ} K ∇ {ε}_{s} ) = 0 \qquad ( 6 )$$

Solving for Equation 6 with appropriate boundary conditions results in the volumetric strain field due to swelling, or what is termed the swelling field. Boundary conditions can be applied as long as the state of swelling is known as a function of relative humidity, which can be experimentally measured. Simultaneously, the total strain tensor field, &, can be determined using elasticity theory where the strain is defined as having separate stress-induced and swelling-induced components.

$$ε = \frac{1 + v}{E} σ - \frac{v}{E} tr ( σ ) I + {ε}_{s} I \qquad ( 7 )$$

(stress-induced strain field) (swelling field)

Knowing the strain tensor field allows us to determine the deformation of the gel and any critical points of stress in the gel.

The salt within liquid can transport via advection from the superficial liquid velocity, and diffusion with a porous-media-effective diffusion coefficient D_{eff}

$$u \cdot ∇ c = ∇ \cdot ( {e}_{eff} ∇ c ) \qquad ( 8 )$$

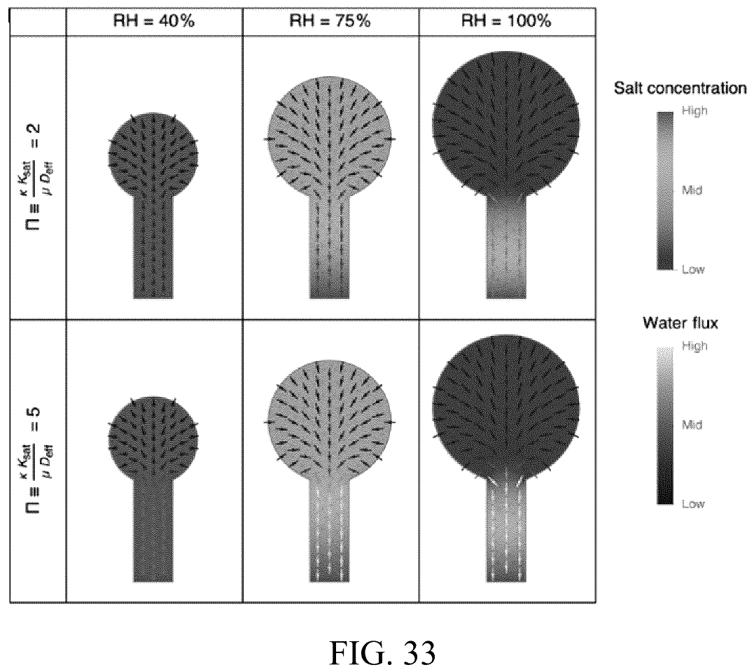

Here, appropriate boundary conditions are applied based on the relative humidity of the air. Using standard finite-element method (FEM) techniques, Equations 6-8 can be solved readily as shown in FIG. 33.

It is contemplated that at high water fluxes, the swelling of the bulb can be higher. Preliminary analysis and simulations of the above governing equations confirm this expectation as shown in FIG. 33. Here, three different humidities around an equilibrium humidity of 50% were simulated. When the air is below the equilibrium humidity, the gel bulb shrinks and water is evaporated into the vapor region, humidifying the dry air. When the air is higher than the equilibrium humidity, the gel bulb swells and water is condensed from the vapor region, dehumidifying the air. This two-way effect illustrates a multifunctional, self-regulating behavior inherent to this gel. In addition, the rate of water transport is proportional to the difference between equilibrium and incoming humidities; thus, the system can transport water faster when conditions require it, representing an autonomic control of the system.

Preliminary analysis shows that a combination of permeability, viscosity, bulk modulus, and diffusivity provides an insightful figure of merit representing the speed of water transport. From a dimensional analysis, the following dimensionless Π group arises:

$$\prod = \frac{k}{μ} \frac{K}{{D}_{eff}} \qquad ( 9 )$$

Here, Π is a relative permeability of the gel. In preliminary simulations, Π was modified, and it was confirmed that higher permeability gels enable higher water throughput, improving humidification/dehumidification performance. It is contemplated that ideal gels for water transport can be permeable (Task 1a, 2) and mechanically stiff (Task 1b, 2). Therefore, to optimize humidity regulation, it can be an aim to produce gels with high permeability by including large pore channels for flow and high stiffness by including a large degree of crosslinking.

To effectively remove moisture from air flow (small water droplets in air), the iongel condenser array can act as a filter trap. As such, iongel bulbs can be designed to take up a large cross-sectional area fraction of the air flow channel and incorporate tortuosities in the air flow channel to maximize the probability of collision between airborne droplets and the iongel bulb condensers. Naturally, this results in relatively large iongel bulbs. However, the larger the iongel bulbs, the greater the transport resistance. As such, it is contemplated that an optimization of gel size, distribution/spacing, and air channel geometry would need to be performed in order to simultaneously maximize moisture removal and dehumidification performance (Task 3). Once airborne droplets are trapped, it is necessary to understand how quickly they are absorbed into the material. It is contemplated that the contact angle between water droplets and the iongel material can dictate the droplet-gel interfacial area and the resultant speed of absorption during moisture removal (Task 1c).

Finally, to effectively control the temperature of the air flow, the iongel bulb condenser array can act as a high-surface-area, fin-like heat exchanger between the liquid desiccant and the air. To solve this heat transfer problem, the temperature field within the gel must be known. To do so, the standard convection-heat equation at steady-state can be invoked, where

$${ρ}_{eff} {c}_{p , ef} ( u \cdot ∇ T ) = ∇ \cdot {k}_{eff} ∇ T \qquad ( 10 )$$

where U is the same superficial velocity as before. Here, thermophysical properties are expressed in terms of the effective (composite) density, specific heat, and thermal conductivity. Given the high-degree of swelling, it is contemplated that these thermophysical properties can be similar to the liquid desiccant (Task 1d).

### 4.4 Research Plan

To investigate the proposed multifunctional iongel concept technology, three objectives and various tasks associated with those objectives can be completed.

### 4.4.1 Objective 1: Synthesize and Optimize Material Properties of Iongel Materials

It is contemplated that II must be maximized to optimize water throughput. As such, wicking (a combination of wetting and porous media flow) performance can be improved and may include introducing micron-scale pores that substantially enhance flow permeability-features that can be detected using scanning electron microscopy (SEM). A custom-built permeation cell can allow characterization of permeability of various gels.

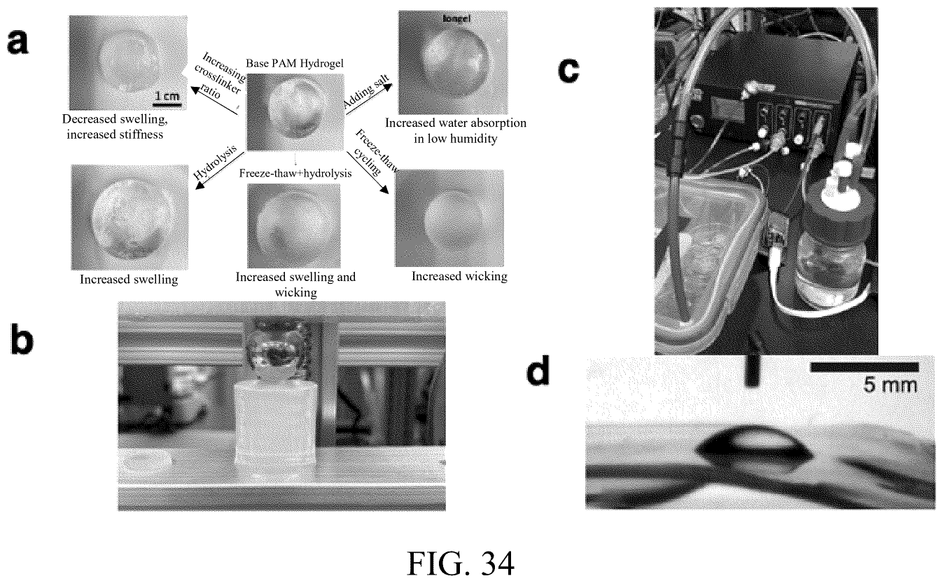

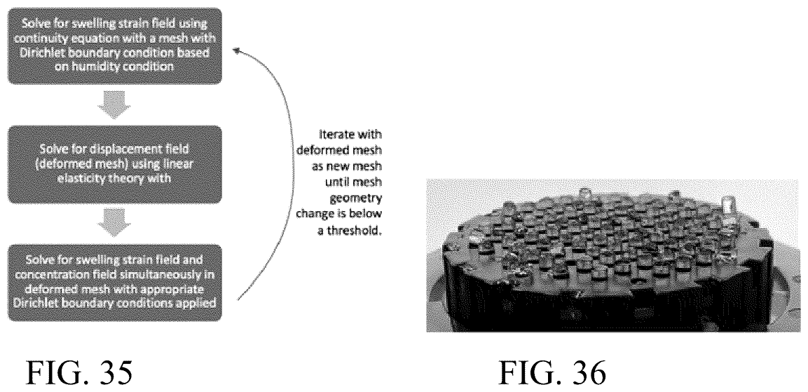

Task 1b: Optimize stiffness. To optimize mechanical stiffness, crosslinking can be incorporated into hydrogels. From preliminary results on polyacrylamide-based hydrogels, it appears that crosslinking with N,N′-Methylenebisacrylamide results in a maximum stiffness at mixture of 3 mole %. It has been found that incorporation of salt shrinks gels and stiffens them highly nonlinearly—a behavior that can be characterized further in detail. Stiffness, or bulk modulus in particular, can be measured using a custom-built indentation tester as shown in FIG. 34b. With a custom-built humidity chamber (FIG. 34c) controlled by piezo-actuated microfluidic regulators for air (Elveflow), gels can be equilibrated in any humidity condition.

Task 1c: Optimize wettability. To optimize wettability for moisture removal performance, contact angles for a range of gel materials can be measured. Using a custom-built goniometer, contact angles on hydrogels at various states of swelling can be measured (FIG. 11d). It is contemplated that gels with low contact angle can more quickly absorb water. This absorption rate can be quantified through custom imaging and image processing.

Task 1d: Characterize thermophysical properties. To understand how the iongel condensers can behave as a heat exchanger, thermal conductivity, heat capacity, and density can be measured at different states of iongel swelling, salt concentration, and relative humidity. Custom temperature sensing and standard wet-lab equipment can perform these measurements. Heat capacity can be measured by differential scanning calorimetry (DSC).

2.4.2 Objective 2: Model and Simulate Water, Salt and Thermal Transport Through Iongel Materials with an Understanding of Basic System Design, Key Transport Limitations in the Device can be Studied, and the Results of that Analysis can be Fed into a Larger Optimization Scheme.

Task 2a: Simulate transport. To provide an initial analysis of an important transport problem, FEM simulations can be modeled and performed to solve for flow, stress/strain, salt concentration, and temperature (Equations 6, 7, 8, 10). Preliminary analysis shows that the dimensionless variable II dictates transport. Further investigation and simulation can allow us to identify key geometric parameters, informing optimal bulb design. The FEM simulations can be expanded to full 3D, transient space to identify any further complexities of the real system. The FEM simulation procedure of this preliminary analysis is shown in FIG. 12.

Task 2b: Validate model with experiments. By performing select validation experiments on single iongel bulbs, the model and simulations can be validated with experimental data. Through an iterative approach, the model can start with simple assumptions and complications, such as strain-dependent stiffness, can be added as necessary.

### 2.4.3 Objective 3: Fabricate and Optimize Iongel Condensers in a Bulb Array

Task 3a: Fabrication of planar gel array. To fabricate a planar array of bulb-shaped gels, 3D printing can form a substrate through which iongels with embedded flow channels as shown in FIG. 33 can be extruded. A preliminary demonstration of this fabrication concept is showing in FIG. 36. This simplified planar geometry can allow us to test a variety of process parameters to dial-in a synthesis and fabrication recipe.

Task 3b: Optimization of gel array tubes. To optimize moisture removal, dehumidification, and thermal heat exchange performance, modeling of a simple tube with embedded iongel bulbs (similar to FIG. 30) can be performed. Simplified heat and mass transfer equations can be developed assuming fully-developed flow through rough pipes and thermal fin-like behavior. Moisture removal can be modeled using Monte Carlo simulation. This modeled understanding can be validated with experimental data from a fabricated gel condenser tube, constructed and designed from insights gained in the previous tasks.

### Example 5A

Atmospheric water harvesting is urgently needed given increasing global water scarcity. Current sorbent-based devices that cycle between water capture and release have low harvesting rates. The present disclosure provides a radically different multi-material architecture with segregated and simultaneous capture and release. This way, proven fast-release mechanisms that approach theoretical limits can be incorporated; however, no capture mechanism exists to supply liquid adequately for release. Inspired by tree frogs and airplants, the disclosed capture approach transports water through a hydrogel membrane “skin” into a liquid desiccant. This disclosure reports an extraordinarily high capture rate of 5.50 kg m⁻² d⁻¹ at a low humidity of 35%, limited by the convection of air to the device. At higher humidities, the disclosure demonstrates up to 16.9 kg m⁻² d⁻¹, exceeding theoretical limits for release. Simulated performance of a hypothetical one-square-meter device shows that water could be supplied to two to three people in dry environments. This work is a significant step toward providing new resources to water-scarce regions.

### Bio-Inspired Design to Utilize Proven High-Flux Release Mechanisms

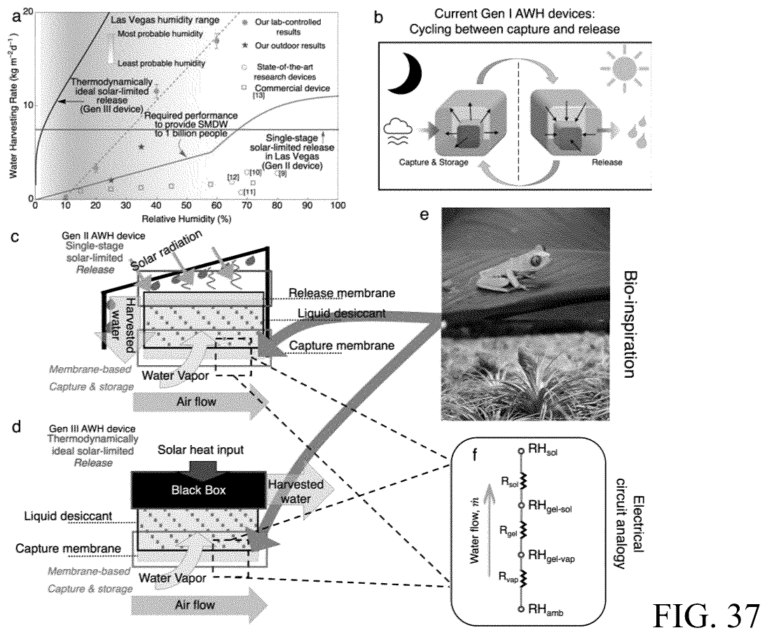

As opposed to the monolithic, single-material approaches, a multi-material approach where the capture, storage, and release are segregated into separately optimized materials is disclosed. The disclosed approach is inspired by nature where soft membranes (e.g., a tree frog's skin (14) or a cuticle of a Tillandsia airplant (15); FIG. 37e) can continuously capture water from the air for hydration (47). These membranes that surround the extracellular fluid act as a protective barrier to the organism, are permeable to water, and facilitate transport of water (48). Meanwhile, the extracellular fluid that the membrane encases stores the water necessary for proper hydration and survival (49). It also serves as a chemical potential sink creating the driving force to draw water from the air through the skin/cuticle into the fluid (capture). As long as the chemical potential of the extracellular fluid is lower than that of the ambient water vapor, the organism can hydrate from the air. In the disclosed approach, this natural design of transport-storage segregation is mimicked by having a separate transport-optimized capture membrane and a liquid desiccant to provide the chemical potential driving force and liquid storage (FIG. 37c,d box).

Using the bio-inspired material segregation principle, the disclosure provides a vertically integrated, stacked design where a release mechanism on the top and a capture membrane on the bottom surround an interstitial storage basin of liquid desiccant (FIG. 37c,d). Having the release membrane on top of a liquid desiccant (ionic solution) enables the incorporation of proven, high-yield solar release techniques that rely on heat localization at the top of a liquid phase (16-23). The highest-performing approaches utilize hydrogel membranes with water fluxes reported as high as 3.64 kg m-2 h-1 under full irradiation (21-23). Therefore, it is unnecessary to develop a new release technique as many proven techniques have been conclusively demonstrated. Rather, the goal of the study is to develop a capture and storage approach that can meet or exceed the solar limit so as to adequately supply water for existing release techniques that can be later incorporated into a complete AWH system.

Recognizing this need, the disclosure focuses on attaining the highest water fluxes through the disclosed material-segregated AWH capture and storage approach. In the disclosed approach, water vapor condenses and permeates through a transport-optimized hydrogel membrane into a liquid desiccant. This desiccant is a saturated lithium bromide (LiBr) salt solution, as its equilibrium relative humidity is around 6% to 8% for typical ambient temperatures (50) (SI Section 1A). Thus, a saturated LiBr solution can be able to capture water vapor from the ambient down to this low humidity range of <10%, which is lower than other strong desiccant salts such as lithium chloride and sodium hydroxide. LiBr solution also has extremely high uptake that is comparable to the leading hydrogel-based sorbents (45, 51) as have been calculated. Biofouling is often a concern with membranes; however, the extreme salinity of saturated LiBr solution would most certainly prevent microbial growth (52). Also, lithium is a known microbe inhibitor (53); thus, it is contemplated that biofouling is not an issue as the highest possible concentration of lithium is applied in the liquid desiccant. Beneath this solution, a hydrogel membrane “skin” is used to condense and permeate water to the solution from the ambient. Importantly, this hydrogel membrane, in vast contrast to other hydrogel-based AWH techniques (51,54-57), does not store water—it simply acts as a transport medium. Thus, water uptake characterizations of the disclosed gel membrane are somewhat irrelevant to the water capture performance since the liquid desiccant is providing the capture driving force and storage. In any case, water absorption/uptake characterizations of the disclosed gel and liquid desiccant can be provided. A polyacrylamide hydrogel membrane was used, as it was possible to tune its properties to provide several benefits. The hydrogel, being permeable to the solution through its nanoporous polymer network (58), serves as an extension of the liquid desiccant by bringing it in contact to the ambient air. The hydrogel is also a solid material providing protection from particulate matter with mechanical properties that are tuned to provide flexibility and strength. The high strength of the membrane allows for a large quantity of liquid desiccant to be stored above it with an extremely thin membrane (0.03 mm to 0.7 mm) to optimize transport. Additionally, it is contemplated that the membrane acts as a physical barrier to the liquid desiccant. The membrane is porous at the polymer mesh scale of around 10 nm, which can block any dust or physical contaminants and enhance the lifetime of the liquid desiccant. As shown in FIG. 1c,d, water vapor flows from the ambient to the gel-air interface in the direction of lower vapor pressure, then through the hydrogel membrane into the solution chamber. In the disclosed complete AWH device, this solution would subsequently release water through an existing solar-powered release mechanism with localized heating and condense it into fresh liquid water (Gen II device, FIG. 1c). It is noted that any localized heating would need to provide thermal separation from the capture membrane and the bulk of liquid desiccant solution in order to maintain high capture performance easily achieved through thermally insulating but permeable materials (e.g, fabric insulation, foams, aerogels, etc.). Such a device would not be cycled in the typical fashion as capture and release can be occurring independently and simultaneously.

### Reducing Mass Transfer Resistances

To analyze and develop a fast capture and storage technique, an electrical circuit analogy was used to understand water transport. As shown in FIG. 37f, the mass flow of water, \dot{m} (kg d⁻¹), is analogous to the electrical current. The driving force “voltage” can be represented by the difference in relative humidities between the ambient and the liquid desiccant solution, RH_{amb}−RHₛₒₗ. Finally, the overall flow “resistance” is comprised of three resistors in series: a convection resistance in the vapor phase, Rᵥₐₚ, a liquid diffusion resistance within the gel membrane, R_{gel}, and a convection resistance in the liquid solution phase Rₛₒₗ. Thus, to maximize the rate of water capture and storage, the “voltage” difference of RH_{amb}−RHₛₒₗ should be maximized by ensuring the solution is as saturated with LiBr as possible to lower RHₛₒₗ, and the “resistance” of Rᵥₐₚ+R_{gel}+Rₛₒₗ should be as small as possible. To do so, these resistances were modeled, and ways to minimize the resistances were determined.

The convection resistance in the vapor resistance can be directly calculated using the Blausius solution for flow over a flat plate (59) (SI Section 2). The result is that the water flux is proportional to the square root of the velocity of crossflowing air, U, and the difference in relative humidity between the ambient and the gel-air interfacial surface, RH_{amb}−RH_{surf}, as described by the following circuit equation:

$$j = \frac{\dot{m}}{A} = \frac{0.6 \; 64 {D}_{w , a}^{\frac{2}{3}} {M}_{H 20} {P}_{sat} {ρ}_{air}^{\frac{1}{6}}}{{μ}_{air}^{\frac{1}{6}} RT} \sqrt{\frac{U}{W}} ( {RH}_{amb} - {RH}_{surf} ) \qquad ( 2 )$$

Here, A is the surface area of the gel membrane, D_{w,a} is the binary molecular diffusion coefficient of water vapor in air, M_{H}_{₂}_{O} is the molar mass of water, Pₛₐₜ is the saturation pressure of water, μₐᵢᵣ is the dynamic viscosity of air, ρₐᵢᵣ is the density of air, W is the width of the membrane along the direction of air flow (38 mm for the prototype), R is the molar gas constant, and T is the absolute temperature. The convection resistance is

$${R}_{vap} = \frac{{μ}_{air}^{\frac{1}{6}} RT}{0.6 \; 64 {D}_{w , a}^{\frac{2}{3}} {M}_{H 20} {P}_{sat} {ρ}_{air}^{\frac{1}{6}}} \sqrt{\frac{W}{U}} \frac{1}{A} \qquad ( 3 )$$

To minimize Rᵥₐₚ, the ratio of wind speed over width should be as large as possible. Since, from boundary layer theory, the boundary layer thickness is proportional to W/U, the result indicates that the convection resistance is proportional to the boundary layer thickness. Therefore, placing a membrane in a windy location or using forced convection to minimize the boundary layer thickness should increase water capture and storage yield.

It is noted that this convection resistance would be present in any atmospheric water harvesting device that uses vapor condensation. This is because water vapor, ultimately, is sourced from the air and would need to convect to some surface of an AWH device to be captured. Thus, the fastest possible AWH device is one where all subsequent resistances after Rᵥₐₚ are negligible. A goal of this study is to develop a capture membrane with a resistance, R_{gel}, that is at least an order of magnitude smaller than Rᵥₐₚ so as to be negligible.

To develop a membrane of negligible resistance, an expression for R_{gel} can first be derived to understand how material design parameters affect the transport behavior. Here, the disclosure builds upon previous work on the mechanical stiffness, hydraulic permeability, and relative-humidity dependencies of crosslinked hydrogels (58,60) that is based on semi-dilute polymer theory (61). Hydrogels are a nanoporous mesh comprised of crosslinked polymer strands where the “pores” are the spacing between the strands, which can be described as the mesh size, ξ. Through any porous medium, the mass flow of water is dictated by Darcy's law:

$$j = - {ρ}_{1} \frac{k}{{μ}_{1}} ∇ P \qquad ( 4 )$$

where ρₗ is the density of liquid water, κ is the hydraulic permeability, μₗ is the dynamic viscosity of liquid water, and VP is pressure gradient (≈−ΔP/L where L is the thickness of the membrane). As hydrogels are poroelastic materials, the stiffness of a hydrogel (bulk modulus), K, is related to the changes in pressure and volume such that K=V dP/dV (60). Defining a filling fraction, s≡V/V_{wet}, as the volume of a hydrogel over its wet-state, 100%-RH volume, the change in pressure can be expressed as

$$dP = \frac{K}{V} dV = \frac{K}{S} ds \qquad ( 5 )$$

Here, s can approach zero for highly de-swollen gels and be equal to unity when equilibrated in pure water. In terms of the this filling fraction, Darcy's law can be expressed as

$$j = - {ρ}_{1} \frac{kK}{{μ}_{1} S} ∇ s \qquad ( 6 )$$

where Vs≈−Δs/L is the gradient in filling fraction such that water moves from regions of high filling fraction to low filling fraction. It is also noted that κK/μₗ is known as the poroelastic diffusion coefficient (62, 63), which describes the diffusion rate of water through poroelastic media. In a previous study (60), it was established that the filling fraction is a function of relative humidity, s(RH) (related to the water uptake isotherm), which can be experimentally measured using a vapor sorption analyzer. Expressing the gradient of filling fraction in terms of the dependence on humidity results in the following circuit equation for water flow “current”:

$$j = \frac{m}{A} = {ρ}_{1} \frac{{}^{.} kK}{{μ}_{1} sL} \frac{ds}{dRH} ( {RH}_{surf - {RH}_{sol}} ) \qquad ( 7 )$$

Thus, the corresponding resistance within the gel membrane, R_{gel}, is

$${R}_{gel} = \frac{{μ}_{1} sL}{{ρ}_{1} kKA} \frac{dRH}{ds} \qquad ( 8 )$$

This equation, however, relies on properties that change depending on the humidity. That is, stiffness, K, permeability, κ, and thickness, L, would change with filling fraction, s(RH), which is a function of humidity. As was investigated in detail previously (58), the permeability scales as κ=κ_{wet}s², where κ_{wet} is the experimentally measurable wet-state value. In addition, the stiffness scales as K=K_{wet}s_{-9/4}, where K_{wet} is the experimentally measurable wet-state bulk modulus (60). Finally, it can be shown that for a de-swollen hydrogel with a Poisson ratio of 1/3 (64-66), the thickness of the gel membrane when constrained to constant area, A, is L=L_{wet}s_{4/3}. All other parameters do not change with the humidity. Thus, incorporating all of the humidity dependencies into the expression of gel resistance Eq. 8,

$${R}_{gel} = \frac{{μ}_{1} sL}{{k}_{wet} {K}_{wet}} \frac{{L}_{wet}}{{ρ}_{1} A} {s}^{31 / 12} \frac{dRH}{ds} \qquad ( 9 )$$

From Eq. 9, it can be seen that the wet-state permeability and stiffness should be maximized while the thickness should be minimized. Furthermore, highly de-swellable gels, such that s is very small at operating conditions, would also minimize R_{gel} due to the s^{31/12} factor. Note that in the disclosed expression for R_{gel}, uniform properties within the gel membrane are assumed. This is valid as long as a poroelastic Peclet number is less than unity, which is justified in SI Section 4. It is also reemphasized that the gel membrane does not act as a storage medium; thus, water uptake of the gel itself is not important in determining the storage performance-instead, storage is provided by the desiccant solution, which has similar uptake to the leading hydrogel-based sorbents (45, 51). Here, the filling fraction s is used as a convenient gel property to describe its thermodynamic state and not as a water capture performance metric.

Based on the analysis of mass-transfer resistances of the gel, it was sought to synthesize hydrogels with very strong type-II or type-III isotherm behavior in order to minimize the filling fraction, s. Thus, polyacrylamide hydrogels were used, as they are known to have very strong type-II isotherm behavior (67) with small s at low RH as was experimentally verified previously (60) and for the current work. To create thin, 0.03 mm gels, the hydrogel was strengthened using insights gained from a recent study on highly entangled polymer networks with minimal crosslinker (68) (SI Section 1B). According to their analysis, hydrogels in which entanglement greatly outnumbers crosslinking have significantly higher toughness, strength, and fatigue resistance, compared to traditional crosslinking-dominant hydrogels.

The gels had a wet-state bulk modulus, K_{wet}=27.6±0.2 kPa and a maximum strain of ˜160% to 200%. The thickness of the gel membranes, when constrained to a fixed area and subjected to the saturated LiBr environment is around L=0.03 mm. These membranes, when supported by a metal mesh, can withstand the compressive stress associated with ˜10 cm liquid desiccant above it, equivalent to μgh=1.4 kPa, which is much smaller than the compressive strength of the material. The hydraulic permeability of the gels were measured using a custom flow cell (58) to be κwet=7.2×10⁻¹⁸ m². With full experimental characterization of the synthesized gels, it was possible to directly calculate the gel resistance to be Rgel=0.21×10⁶ s kg⁻¹. Compared to the vapor resistance of Rvap=1.84×10⁶ s kg⁻¹, assuming an ambient temperature of 23° C. and cross-flow velocity of 0.3 m s⁻¹, Rgel was approximately an order of magnitude lower than Rᵥₐₚₒᵣ. Thus, it is expected that the disclosed gel membranes have negligible resistance. Furthermore, the resistance in the solution phase was calculated to be Rsol=0.093×10⁶ s kg⁻¹. This resistance is low due to the Rayleigh-Bénard mixing that occurs from lower-density, lower-salt-concentration liquid at the gel-solution interface (a calculation of Rₛₒₗ is in SI Section 7). Since Rₛₒₗ is lower than Rᵥₐₚ by at least one order of magnitude, it is also negligible. Therefore, the mass transfer in the capture stage should be vapor-convection-limited-neither gel-diffusion-limited nor solution-convection-limited, where \dot{m}˜=(RH_{amb}−RHₛₒₗ)/Rᵥₐₚ since R_{gel}<<Rᵥₐₚ. Convection-limited water capture fluxes at 23° C. (lab conditions) at different air velocities and humidities are modeled.

### Results

### Lab Testing Convection-Limited Capture (Indoor)

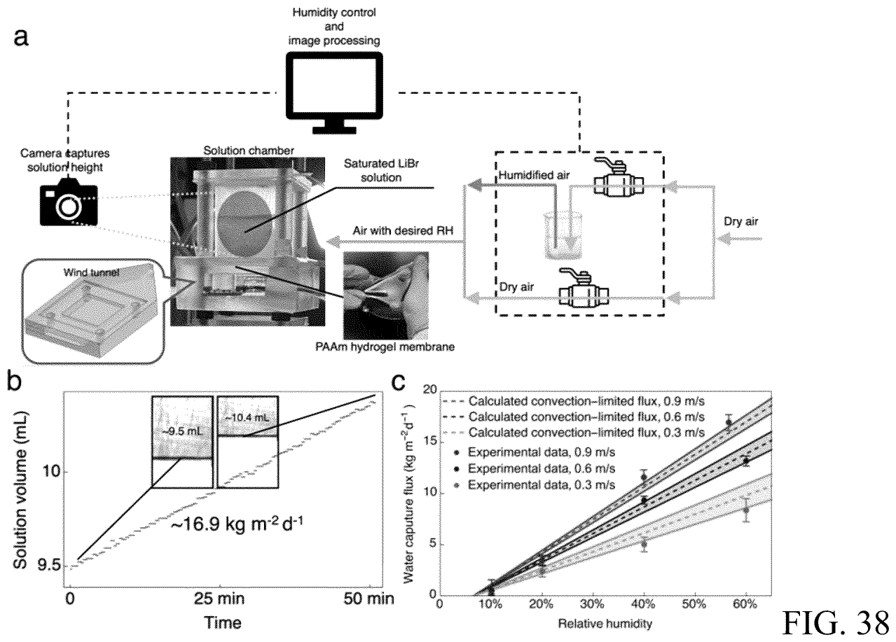

To test the expectation of convection-limited behavior, 12 independent indoor capture/storage tests were performed under varied conditions with crossflowing air speeds from 0.3 m s⁻¹ to 0.9 m s⁻¹ and humidities from 10% to 60% (SI Section 1D; plotted experimental results in FIG. 2c). To facilitate analysis and comparison with established fluid dynamic models, a wind tunnel was designed to provide laminar flow (SI Section 1C). With negligible gel resistance, the mass flow rate is m (RH_{amb}−RHₛₒₗ)/Rᵥₐₚ, where Rᵥₐₚ can be determined ab initio to predict flow rate (dotted lines in FIG. 38c) according to Eq. 2, where RH_{surf}=RHₛₒₗ. The change of the liquid desiccant volume, ΔV, was determined by photography and image processing. This volume change was converted into captured water mass, m_{capture} (SI Section 1E). Comparing experimental capture rates with predicted rates from Blausius' exact solution for convective flow (SI Section 2), a remarkably close agreement was found with the results with no fitting, confirming convection-limited behavior. As illustrated in the plots, water capture rate increased linearly with ambient relative humidity. Additionally, the rate increased with the square root of wind speed, U, as expected from Eq. 2. Further enhancement could be provided by turbulent air flow as the boundary layer would become very thin.

### Outdoor Water Capture Results (Outdoor)

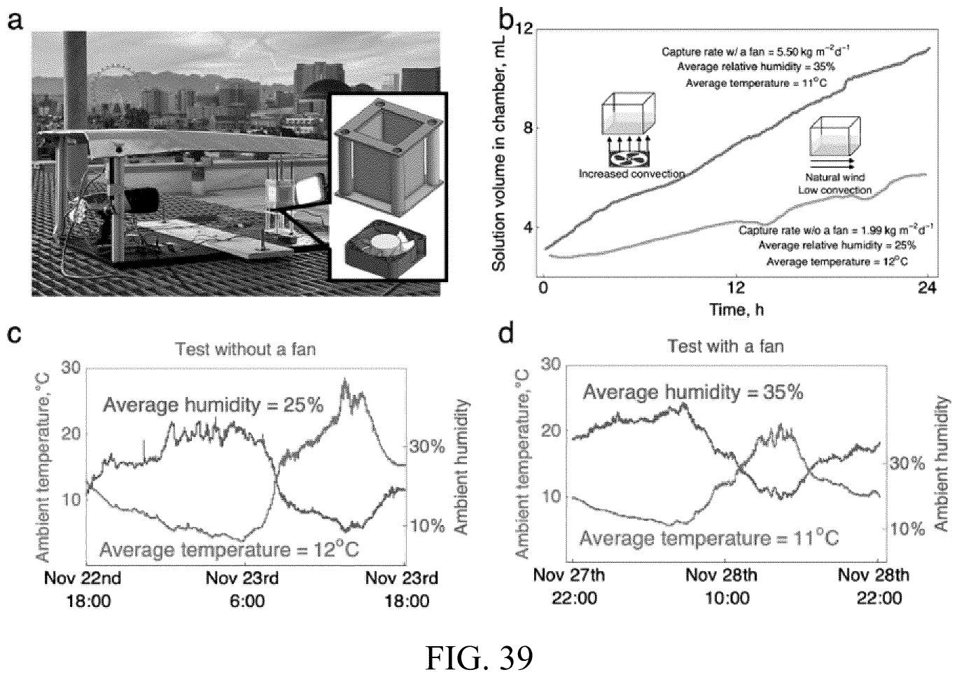

To demonstrate the potential of the disclosed AWH approach in an arid environment, outdoor capture tests were performed locally in Las Vegas (lowest-rainfall metropolitan area in the US), where the ambient humidity ranges from 20% to 40% in late November. Each outdoor test ran for at least 24 h continuously, and both ambient temperature and humidity changes were recorded as shown in FIG. 39. Sensor reading on temperature and humidity and the weather data from the nearby KLAS airport obtained from Wolfram Research (69) were compared, and confirmed that the measurements of the ambient environment during outdoor tests were reliable. Relying only on natural wind to flow across the gel membrane, an average capture rate of 1.99 kgₘ_{^{−2}} d₋₁ at an average RH of 25% over a 24-h period was measured (FIG. 39(b), red). It is noted that positive water capture was recorded even as the humidity dipped below 10% (FIG. 39(c)), demonstrating water capture at the lowest relative humidities compared to other approaches (FIG. 37(c)). Based on the insight gained from Eq. 3, where mass transfer is inversely proportional to the boundary layer thickness, a small 1.4 W fan was incorporated to apply forced convection over the membrane (FIG. 30(a)). The water capture and storage yield increased to 5.50 kgₘ_{^{−2}}d₋₁ at 35%, representing the highest water yield for any AWH approach at any humidity. It is noted that the purpose of adding a fan was to demonstrate convection-limited transport behavior and not a technological feature.

### Further Implications

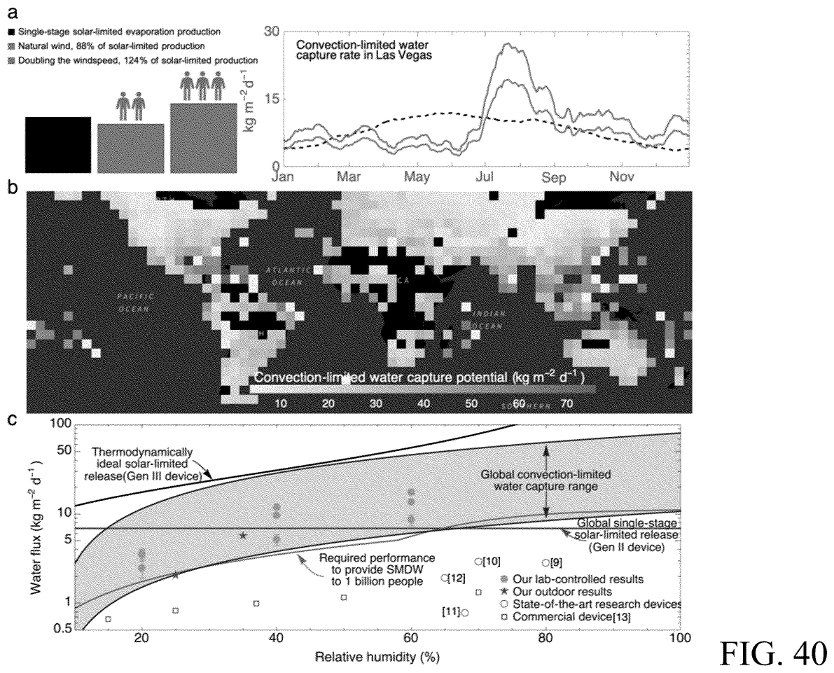

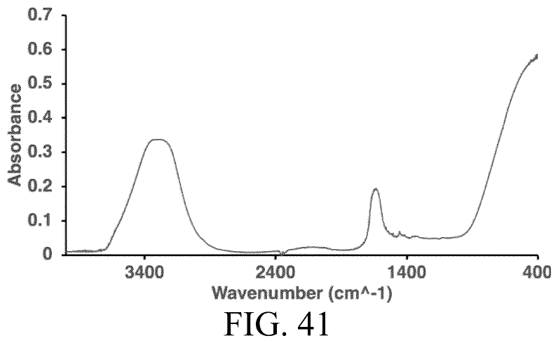

Both lab and outdoor test results confirm that, through the disclosed bio-inspired design, water can be captured at relative humidities as low as ˜ 10% and at rates that are close to the solar limit of water release at higher humidities. Faster rates can be achieved at higher humidities, and as high as 16.9 kgₘ−2 d-1 at 57% RH has been recorded. Faster rates can also be achieved with more convection. Using weather data for 2021 in Las Vegas, the performance of the AWH capture device using the experimentally verified Eq. 2 was modeled. As shown in FIG. 40(a), simulated year-round capture rates of the AWH capture device with and without a fan for 2021 (blue and red, respectively) were determined. Relying only on natural wind (current setup), a capture rate of 6.6 kgₘ−2 d-1 (annual average), which is 88% of the solar limit of 7.5 kg m⁻² d⁻¹, was modeled. Doubling the wind speed either by forced convection or locating the device in a high-wind area (e.g., higher elevations or at constrictions between buildings), a capture rate of 9.3 kg m⁻² d⁻¹, which is 124% of the solar limit, was modeled. In any case, coupling the disclosed capture approach with a proven release technique would enable a complete AWH package with near-solar-limit performance. A hypothetical one-square-meter device, with a W=38 mm width (same as the disclosed prototype) could provide individual drinking water (3 kg d⁻¹ (36)) for two to three people in Las Vegas, the driest city in the United States. It is noted that any future scale up of this device would need to incorporate a release mechanism and consider appropriate mechanical frame design to distribute hydraulic stresses over a large area of gel membrane.

Assuming an appropriate release mechanism is incorporated with the disclosed capture and storage approach to form a complete AWH device, the global convection-limited water capture potential of the disclosed design was simulated based on global weather data sets of temperature, humidity, and wind speed (70, 71) as shown in FIG. 40(b). In nearly all land regions, the water flux is greater than 10 kg m⁻² d⁻¹. Simulating the performance of the disclosed device across the globe (FIG. 40(c), blue region) results in the range of water fluxes that generally well exceed Lord's required performance curve to provide safely managed drinking water to 1 billion people (8) (FIG. 40(c), green line). In fact, the convection-limited fluxes can exceed the single-stage solar limit and even approach the thermodynamic solar limit for a distillation process (33). Furthermore, the disclosed AWH approach has potentially substantial economic advantages—it is estimated that a cost of capture and storage materials to be approximately $17 m⁻² or $1 kg⁻¹ considering only the cost of raw materials purchased at bulk scales, and the combined dry mass of LiBr salt and hydrogel membrane. Thus, high-yield, convection-limited atmospheric water harvesting is highly feasible and could potentially be developed at low cost for wide-scale implementation if the release mechanism could be similarly affordable. Complications that could arise from scaling up (e.g., turbulent wind flows, large membrane fabrication) can be addressed. A release mechanism can be incorporated to realize a complete AWH system.

In summary, the disclosure reimagines the atmospheric water harvesting process and discloses a new, multilayer architecture resembling the function of skins and cuticles in nature. With this architecture, the capture, storage, and release of water into separately optimized materials can be segregated. The architecture also accommodates proven, highly effective water release techniques with near-solar-limit performance for single-stage distillation (21-23). To supply adequate water to the release stage, the disclosure focuses on the capture and storage stages and developed a hydrogel membrane “skin” coupled with a liquid desiccant. Using detailed transport and material analysis, the membrane was designed to provide the fastest possible water capture rates as limited by the supply of ambient air flow to the device. This is possible through the use of high entangled polymer networks for high strength, allowing gels to be made extremely thin. Detailed lab and outdoor testing demonstrate that the disclosed device has the highest capture fluxes and the largest operational humidities compared to the state of the art. The global impact of this convection-limited performance has been modeled and it has been found that a hypothetical one-square-meter device could provide daily water needs to several individuals in even the driest environments. Using criteria developed from a previous analysis by Lord et al. (8), implementing a device with convection-limited performance in regions without safely managed drinking water could provide water to over a billion people. The disclosed work could be an important step toward building a scalable and affordable AWH device that can provide additional water security to arid communities with dwindling water supplies or communities with limited infrastructure.

### Methods

### Synthesis of Hydrogels

The mixtures of acrylamide monomers, photoinitiator (Irgacure 2959) and crosslinker (N,N′-methylene(bis)acrylamide) were first made as a solution and poured into a mold with 0.5 mm thickness. UV irradiation was applied for 1 h. The crosslinked hydrogel samples were carefully removed from the mold and rinsed to remove unreacted chemicals. All samples were immersed in DI water for 3 d until reaching the equilibrium wet state before use.

### Saturated Salt Solution

From Greenspan (50) (SI Section 1A), the equilibrium relative humidity of saturated lithium bromide (LiBr) solution is ≈8% at room temperature. To prepare LiBr saturated solutions, LiBr salt was gradually added into DI water and mixed by a magnetic stirrer, until a solid phase was precipitated. The liquid was allowed to cool after natural exothermic heating from dissolution.

### Tensile Testing

A custom-built tensile/compression tester was used previously (60) to stretch six dogbone-shape hydrogel samples. From stress-strain curves, the bulk modulus, K wet, was determined from the Young's modulus assuming Poisson's ratio is 1/3 (64-66). To ensure the hydrogel samples were tested at their wet state, all tests were finished within 5 min of removal from water.

### Permeability Testing

The hydraulic permeability of hydrogel membranes, κ_{wet}, was measured with a custom-built permeability tester used previously (58). In the previous work, it was found that the volumetric flow rate, Q, was linear with ΔP within ±2% when ΔP/K_{wet} was in the range of 0.5-1; thus, a pressure, ΔP=70% K_{wet}, was applied by the Elveflow Microfluidic Flow Controller and recorded the real-time water volumetric flow rate for 30 min to calculate the hydraulic permeability of the sample based on Darcy's law.

### Indoor Capture and Storage Testing

A custom-built wind tunnel with PID control of humidity in the range of 10% to 60% and varied mean velocities from 0.3 m s⁻¹ to 0.9 m s⁻¹ was used. Air flow consideration in the wind tunnel is shown in SI Section 1C. A camera captured the height of liquid meniscus every 30 s, enabling us to determine the change of saturated solution, V change, in the chamber and calculate the water capture rate over time. The solution humidity was monitored to ensure it remained at ≈8% during the entirety of the tests.

### Calculation of Captured Water Mass

As the LiBr solution in the chamber was maintained at saturation, the volume change of the liquid, ΔV, came from both the volume change of saturated solution that consisted of captured water and dissolved salt, and the volume change of undissolved salt. The mass of captured water, m_{capture}, can be calculated as

$${m}_{capture} = Δ V \frac{( 1 - w ) {ρ}_{salt} {ρ}_{solution}}{{ρ}_{salt} - w {ρ}_{solution}} \qquad ( 10 )$$

where w is the mass fraction of LiBr in water at the solubility limit, ρₛₐₗₜ is the density of LiBr salt, and ρₛₒₗᵤₜᵢₒₙ is the density of LiBr saturated solution as a function of temperature. Detailed discussion and derivation are shown in SI Section 1E.

### Outdoor Capture and Storage Tests

The outdoor test setup was identical to the indoor setup with the absence of the wind tunnel and humidity control system. It was tested with and without a 50 mm computer fan that consumed 1.4 W of electrical power during operation. Each outdoor test was operated on the roof of a laboratory building for at least 24 h continuously. Ambient humidity and temperature were measured and recorded during the entire experiment process for analysis.

### Water Sorption Testing

Dynamic vapor sorption (DVS) was applied to determine the sorption response of the hydrogel in varied humidities with the DVS Adventure from Surface. The sample was exposed to progressively lower RH conditions in 10% decrements, with smaller changes when near the saturation point, and allowed to equilibrate at each condition from 98% to 10%. The mass fraction isotherm was fit to a GAB isotherm model (67). Further details of water sorption testing and modeling are shown.

### Lord et al.'s Harvesting Performance Benchmark

Lord et al. (8) determined the required specific yield of water to supply one billion people with safely managed drinking water (SMDW) taking into account global data on local population distribution, local solar irradiance, local humidity, and local water need. Humidity-dependent specific yield was expressed in kg of water produced per kW h of solar energy. In the disclosed work, quantify capture or harvesting performance was used as a mass flux in kg m⁻² d⁻¹; thus, to convert specific yield to a mass flux, the specific yield is multiplied by the global horizontal irradiance (GHI), equivalent to the incoming solar radiation on a flat surface per unit area. In FIGS. 1 and 4 (green curve), the maximum of the two curves presented by Lord et al., linear and logistic, was determined, where

$${j}_{1 billion} = max ( ( 1.86 {kgkW}^{- 1} {h}^{- 1} ) {RH}_{amb} , \frac{24 {kgkW}^{- 1} {h}^{- 1}}{1 + exp ( - 10. ( {RH}_{amb} - 0.6 ) )} ) \times {q}_{solar}^{″} \qquad ( 11 )$$

$${j}_{1 billion} = max ( {\underbrace{( 1.86 {kgkW}^{- 1} {h}^{- 1} ) {RH}_{amb}}}_{Lord ' s linear curve} , {\underbrace{\frac{2.4 {kgkW}^{- 1} {h}^{- 1}}{1 + exp ( - 10. ( {RH}_{amb} - 0.6 ) )}}}_{Lord ' s logistic curve} ) \times {q}_{solar}^{″} \qquad ( 11 )$$

and q″ₛₒₗₐᵣ is global-average GHI of 4.7 kW h m⁻² d⁻¹. Thus, a conservative mass flux requirement is shown to supply one billion people with SMDW.

### Modeling Location-Specific Water Capture Potential

Global solar-limited water release was determined using Eq. 1 using global horizontal irradiance data from the Global Solar Atlas 2.0 (72). Convection-limited water capture flux potential was calculated using Eq. 2, where RH_{surf}=RH_{amb}, assuming R_{gel}<<Rᵥₐₚ. Values for the diffusion coefficient, D_{w,a}, were determined using values and an equation from (73). Water and humid air properties were determined using CoolProp (74). Local wind speed data were taken from Wolfram Research (69), while global wind speed data were taken from the Global Wind Atlas (70). 10-m wind speeds were converted to 1-m wind speeds using the power-law wind profile with an exponent of 1/7 (75). Global humidity and temperature data were taken from the HadISDH.blend 1.3.0.2021f version of the Met Office Hadley Centre Integrated Surface Dataset of Humidity (71).

Solar Limit with Ideal Distillation

For a single-stage distillation system with no heat recovery, the energy required to distill water is the latent heat, as in Eq. 1. However, in a thermodynamically reversible (100% second-law efficiency; no entropy generation) black box with an inflow of saturated salt solution, the solar heat required, Qₕ, to produce a flow of distilled water, \dot{m}_{water}, is

$$\frac{{Q}_{h}}{\dot{{m}_{water}}} = \frac{{RT}_{amb} ln ( \frac{1}{{RH}_{sat}} )}{{M}_{water} ( 1 - \frac{{T}_{amb}}{{T}_{h}} )} \qquad ( 12 )$$

where R is the molar gas constant, T_{amb} is the ambient temperature, _{RHsat} is the equilibrium relative humidity of the saturated salt solution, M_{water} is the molar mass of water, and Tₕ is the temperature of the heat source (assumed to be at the boiling point of water at 373 K in FIG. 40C). Note that this device inherently utilizes a Carnot heat engine to produce work: W=Qₕ(1−T_{amb}/Tₕ). For a solar-powered release system, where Qₕ=Qₛₒₗₐᵣ, the thermodynamically limited mass flux is

$${j}_{III} = \frac{\dot{{m}_{water}}}{A} = {q}_{solar}^{″} ( 1 - \frac{{T}_{amb}}{{T}_{h}} ) \frac{{M}_{water}}{{RT}_{amb} ln ( \frac{1}{{RH}_{sat}} )} \qquad ( 13 )$$

where A is the area of the device, and q″ₛₒₗₐᵣ=Qₛₒₗₐᵣ/A. A full derivation is provided in SI.

### REFERENCES AND NOTES FOR EXAMPLE 5A

1. L. C. Stringer, et al., One Earth 4, 851 (2021).
2. M. M. Mekonnen, A. Y. Hoekstra, Science advances 2, e1500323 (2016).
3. A. P. Williams, B. I. Cook, J. E. Smerdon, Nature Climate Change 12, 232 (2022).
4. H. Jarimi, R. Powell, S. Riffat, International Journal of Low-Carbon Technologies 15, 253 (2020).
5. R. Li, et al., Environmental science & technology 52, 11367 (2018).
6. M. J. Kalmutzki, C. S. Diercks, O. M. Yaghi, Advanced Materials 30, 1704304 (2018).
7. P. Wang, Environmental Science: Nano 5, 1078 (2018).
8. J. Lord, et al., Nature 598, 611 (2021).
9. H. Qi, et al., Advanced Materials 31, 1903378 (2019).
10. X. Wang, et al., Angewandte Chemie 131, 12182 (2019).
11. A. LaPotin, et al., Joule 5, 166 (2021).
12. V. Ayyagari, Y. Hwang, J. Kim, Energy 221, 119726 (2021).
13. Source hydropanels technical specification sheet, https://www.source.co/wp-content/uploads/2020/11/SOURCE-Tech-Spec-Sheet.pdf.
14. C. R. Tracy, N. Laurence, K. A. Christian, The American Naturalist 178, 553 (2011).
15. P. S. Raux, S. Gravelle, J. Dumais, Nature communications 11, 1 (2020).
16. C. Chen, Y. Kuang, L. Hu, Joule 3, 683 (2019).
17. G. Ni, et al., Nature Energy 1, 1 (2016).
18. P. Tao, et al., Nature energy 3, 1031 (2018).
19. M. Gao, L. Zhu, C. K. Peh, G. W. Ho, Energy & Environmental Science 12, 841 (2019).
20. Y. Guo, et al., Chemical reviews 120, 7642 (2020).
21. Y. Shi, O. Ilic, H. A. Atwater, J. R. Greer, Nature communications 12, 1 (2021).
22. Y. Guo, F. Zhao, X. Zhou, Z. Chen, G. Y u, Nano letters 19, 2530 (2019).
23. F. Zhao, et al., Nature nanotechnology 13, 489 (2018).
24. R. Tu, Y. Hwang, Energy 201, 117630 (2020).
25. A. LaPotin, H. Kim, S. R. Rao, E. N. Wang, Accounts of chemical research 52, 1588 (2019).
26. X. Zhou, H. Lu, F. Zhao, G. Y u, ACS Materials Letters 2, 671 (2020).
27. O. Klemm, et al., Ambio 41, 221 (2012).
28. H. Andrews, E. Eccles, W. Schofield, J. Badyal, Langmuir 27, 3798 (2011).
29. M. Eslami, F. Tajeddini, N. Etaati, Energy Conversion and Management 174, 417 (2018).
30. V. Joshi, et al., Energy Procedia 109, 161 (2017).
31. T. Anbarasu, S. Pavithra, International Conference on Sustainable Energy and Intelligent Systems (SEISCON 2011) (IET, 2011), pp. 75-79.
32. A. K. Rao, A. J. Fix, Y. C. Y ang, D. M. Warsinger, Energy & Environmental Science 15, 4025 (2022).
33. J. H. Lienhard, K. H. Mistry, M. H. Sharqawy, G. P. Thiel, Desalination Sustainability, H. A. Arafat, ed. (Elsevier, Amsterdam, 2017), pp. 127-206.
34. H. Kim, et al., Scientific reports 6, 19097 (2016).
35. X. Zhou, F. Zhao, Y. Guo, B. Rosenberger, G. Yu, Science Advances 5, eaaw 5484 (2019).
36. Dietary Reference Intakes for Water, Potassium, Sodium, Chloride, and Sulfate (The National Academies Press, Washington, D C, 2005).
37. H. Kim, S. R. Rao, A. LaPotin, S. Lee, E. N. Wang, International Journal of Heat and Mass Transfer 161, 120253 (2020).
38. N. Hanikel, M. S. Prévot, O. M. Yaghi, Nature nanotechnology 15, 348 (2020).
39. W. Xu, O. M. Yaghi, ACS central science 6, 1348 (2020).
40. H. Kim, et al., Science 356, 430 (2017).
41. L. Öhrström, F. M. Amombo Noa, Science 374, 402 (2021).
42. Y. Meng, Y. Dang, S. L. Suib, Cell Reports Physical Science 3, 100976 (2022).
43. A. Entezari, M. Ejeian, R. Wang, ACS Materials Letters 2, 471 (2020).
44. F. Zhao, et al., Advanced Materials 31, 1806446 (2019).
45. Y. Guo, et al., Nature communications 13, 1 (2022).
46. P. A. Kallenberger, M. Fröba, Communications Chemistry 1, 1 (2018).
47. F. T. Malik, R. M. Clement, D. T. Gethin, W. Krawszik, A. R. Parker, Bioinspiration Biomimetics 9, 031002 (2014).
48. E. Domínguez, J. A. Heredia-Guerrero, A. Heredia, New Phytologist 189, 938 (2011).
49. Y. Takei, The Japanese Journal of Physiology 50, 171 (2000).
50. L. Greenspan, Journal of research of the National Bureau of Standards. Section A, Physics and chemistry 81, 89 (1977).
51. G. Graeber, et al., Advanced Materials p. 2211783 (2023).
52. H. Larsen, FEMS Microbiology Reviews 2, 3 (1986).
53. L. Cox, D. Dooley, R. Beumer, Food microbiology 7, 311 (1990).
54. H. Lu, et al., Advanced Materials 34, 2205344 (2022).
55. S. Aleid, et al., ACS Materials Letters 4, 511 (2022).
56. T. Lyu, et al., ACS Applied Materials & Interfaces 14, 32433 (2022).
57. H. Shan, et al., Advanced Materials p. 2302038 (2023).
58. Y. Gao, H.-J. J. Cho, Soft Matter (2022).
59. H. Blasius, Grenzschichten in Flüssigkeiten mit kleiner Reibung (Druck von BG Teubner, Leipzig, 1907).
60. Y. Gao, N. K. Chai, N. Garakani, S. S. Datta, H. J. Cho, Soft matter 17, 9893 (2021).
61. P.-G. De Gennes, P.-G. Gennes, Scaling concepts in polymer physics (Cornell university press, Ithaca and London, 1979).
62. J.-F. Louf, N. B. Lu, M. G. O'Connell, H. J. Cho, S. S. Datta, Science Advances 7, eabd2711 (2021).
63. J.-F. Louf, S. S. Datta, Soft Matter 17, 3840 (2021).
64. H. M. Wyss, T. Franke, E. Mele, D. A. Weitz, Soft Matter 6, 4550 (2010).
65. E. Geissler, A. M. Hecht, Macromolecules 14, 466 (1981).
66. D. C. Andrei, B. J. Briscoe, P. F. Luckham, D. R. Williams, Modern Aspects of Colloidal Dispersions (Springer Netherlands, Dordrecht, 1998), pp. 15-24.
67. H. Mittal, A. Al Alili, S. M. Alhassan, Microporous and Mesoporous Materials 299, 110106 (2020).
68. J. Kim, G. Zhang, M. Shi, Z. Suo, Science 374, 212 (2021).
69. WeatherData from Wolfram Research, https://reference.wolfram.com/language/ref/WeatherData.html.
70. Global wind atlas 3.0, https://globalwindatlas.info/.
71. K. Willett, et al., Hadisdh.blend: gridded global monthly land and ocean surface humidity data version 1.3.0.2021f (2022).
72. Global solar atlas 2.0, https://globalsolaratlas.info/.
73. T. L. Bergman, A. S. Lavine, F. P. Incropera, D. P. DeWitt, Fundamentals of heat and mass transfer, vol. 8 (Wiley Global Education US, Hoboken, 2018).
74. I. H. Bell, J. Wronski, S. Quoilin, V. Lemort, Industrial & Engineering Chemistry Research 53, 2498 (2014).
75. J. S. Touma, Journal of the Air Pollution Control Association 27, 863

### Example 6

### 1. Additional Notes on Experimental Methods

The disclosed hydrogel-based atmospheric water harvesting (AWH) approach utilizes a thin hydrogel film at the bottom of the solution chamber. The saturated salt solution (LiBr) in the chamber creates a lower chemical potential, which provides a driving force and captures ambient water vapor. Segregated from the water storage role, the hydrogel membrane serves as a permeable medium facilitating fast capture.

### Saturated Salt Solution (Liquid Desiccant)

To create the low-chemical-potential environment to drive water into the liquid phase (liquid desiccant), a saturated aqueous solution of lithium bromide (LiBr) salt was used. Greenspan provided a detailed list of relative humidities of different saturated salt solutions at varied temperatures [1]. LiBr provides the lowest equilibrium relative humidities compared to other salts, which would provide the largest driving force for water capture and the largest range of humidities where capture is possible. The equilibrium relative humidity of saturated LiBr solution ranges from 7.75+/−0.83% to 5.53+/−0.31% in the temperature range of 0° C. to 50° C. LiBr saturated solution was prepared by adding salt into DI water gradually in an amount greater than the solubility at room temperature. During salt addition, the solution temperature increased due to the strong exothermic dissolution associated with LiBr. Using the resulting elevated temperature allowed us to ensure that the solution was fully saturated when eventually cooled to room temperature. This is because, according to the Handbook of Chemistry and Physics Online [2], the solubility of LiBr (and most salts) increases with temperature. Furthermore, saturation was confirmed as a solid phase of salt precipitated from the solution.

### Hydrogel Film

Polyacrylamide hydrogel (PAAm) films were prepared from aqueous stock solutions of the following chemicals: acrylamide (AAm, initial monomer, Merck), N,N′-methylene(bis)acrylamide (MBA, crosslinker, Sigma-Aldrich), and Irgacure 2959 (photo initiator, Sigma-Aldrich). Some important ratios were controlled during mixing:crosslinker ratio (moles of MBA over moles of AAm, 0.1%), water ratio (moles of water over moles of AAm during preparation, 11), and initiator ratio (moles of Irgacure 2959 over moles of MBA, 0.4). After fully dissolving all chemicals in DI water, the mixed solution was poured into a transparent mold with a fixed thickness of 0.5 mm, equal to the thickness of the hydrogels right after synthesis. UV irradiation (365 nm, 100 W LED array) was applied 5 cm above the solution for 1 h. Cured samples were then removed from the mold and rinsed to remove unreacted chemicals. Clean samples were immersed in DI water for 3 d until reaching the equilibrium state with a thickness of approximately 0.7 mm.

In previous work [3], the crosslinker ratio of pure PAAm hydrogels was varied from 0.5% to 7% and the stiffness (bulk modulus) was measured. It was confirmed that adding crosslinker could increase stiffness; however, an increasing brittleness was observed. A need for a high-strain gel with high fracture toughness was anticipated, and highly entangled hydrogels with low crosslinking were synthesized according to methods developed by Kim et al. [4]. Such gels, when synthesized in a reduced water environment, have a high degree of polymer strand entanglement that greatly outnumbers crosslinks, providing high toughness, strength, and fatigue resistance. As such, hydrogels were synthesized with a crosslinker ratio=0.1% (mol of MBA/mol of AAm), a water ratio=11 (mol of DI water/mol of AAm), and an initiator ratio=0.4 (mol of Irgacure/mol of MBA). Compared with more conventionally crosslinked gels (crosslinker ratio=0.5%) with a bulk modulus around 7 kPa, the disclosed highly entangled hydrogels have a bulk modulus of 28 kPa. In addition, the disclosed entangled gels have a high maximum strain at failure in the range of 160% to 200%, ensuring that the disclosed gels could withstand the high degree of stretching when constrained to a fixed area and de-swollen due to contact with the liquid desiccant. Details of the gel's response to stretching in this environment are provided in SI Section 3.

### Wind Tunnel Flow Considerations

For simplicity of analysis, the wind tunnel was designed to ensure laminar air flow for lab-controlled capture and storage testing. The Reynolds number, Re, of the air flow in the wind tunnel is

$$Re = \frac{{ρ}_{air} {UD}_{h}}{{μ}_{air}} \qquad ( S1 )$$

where Pₐᵢᵣ is the air density (1.205 kg/m³), pair is the dynamic viscosity of air (0.000 018 2 s Pa), U is the velocity of air flow, and Dh is the hydraulic diameter of the channel. This hydraulic diameter is

$${D}_{h} = \frac{4 A}{P} \qquad ( S2 )$$

where A is the wind tunnel cross-sectional area and P is the perimeter of the tunnel (P=2×(4 mm+38 mm)). By inserting the values of all parameters at the maximum attainable velocity of 0.9 m s-1, Re of the air flow was found to be 449.7 (<2300), which confirmed that the air flow in the wind tunnel was laminar. Furthermore, because an entrance region was not incorporated before the section of the wind tunnel underneath the gel membrane, the flow conditions under the gel were approximated using flow over a flat plate with a developing boundary layer.
Lab-Controlled Capture and Storage Tests with Wind Tunnel

To test the hypothesis of convection-limited water mass transfer, indoor wind-tunnel experiments underneath a prototype capture and storage device were performed with synthesized hydrogel membranes below a saturated LiBr solution. Tests were performed at a room temperature of ≈23° C. Mass flow rates were measured under different relative humidities and wind speeds (volumetric flow rate of air). It was necessary to control the relative humidity and the air flow rate below the prototype (FIG. 38(a)) independently. Input air was supplied by a building's air supply at around 5% RH. The air flowed through a flow meter where volumetric flow rate of air input, Qₐᵢᵣ, could be adjusted to a desired value using a valve—coupled with the wind tunnel, the uncertainty in velocity control was around ±0.07 m/s. Then, the air flow was split into two paths: in one path, air flow was kept at its dry state; in the other path, air was humidified close to 99% by bubbling through three water-filled glass media bottles.

Using an Arduino microcontroller programmed with a custom PID control algorithm, it was possible to adjust the ratio between dry and humid air flow to achieve a desired humidity level within 1% RH. The resultant, mixed air flowed beneath the hydrogel membrane via a 3D-printed wind tunnel of cross section 4 mm by 38 mm, with a cross-sectional area A tunnel and a flow length across the hydrogel, W, of 38 mm. The average wind speed was calculated as U=Qₐᵢᵣ/Aₜᵤₙₙₑₗ. The top wall of the wind tunnel channel was the 38 mm by 38 mm bottom surface of the hydrogel membrane supported by a thin metal mesh.

A camera faced the solution chamber horizontally and was focused on the solution liquid-vapor interface to record the change in liquid level. The change in height of the solution surface was determined by image processing. Multiplying the height by the chamber cross-sectional area (38 mm by 38 mm) indicated the amount of volume change, ΔV (FIG. 38(b) in example 4), which was then converted into captured water mass (SI Section 1E). A sensor was placed at the exit of the wind tunnel to provide feedback to the PID humidity control system. 12 independent indoor capture tests were performed, varying wind speed at three values (0.3 m s⁻¹, 0.6 m s⁻¹, and 0.9 m s⁻¹) and relative humidity at four values (10%, 20%, 40%, and 60%).

A video showing the liquid volume change over time for U=0.9 m s-1 at 57% RH can be viewed in the supplementary video or at https://youtube.com/shorts/gomgG9pwWUQ. The video is sped up by 750×.

### REFERENCES FOR EXAMPLE 5B

1. L. Greenspan, “Humidity fixed points of binary saturated aqueous solutions,” J. research Natl. Bureau Standards. Sect. A, Phys. chemistry 81, 89 (1977).
2. Chemnetbase, “Aqueous Solubility of Inorganic Compounds as a Function of Temperature Values Are in Mass % of Solute,” https://hbcp.chemnetbase.com/faces/documents/05_33/05-33_0008.xhtml (2014).
3. Y. Gao, N. K. Chai, N. Garakani, S. S. Datta, and H. J. Cho, “Scaling laws to predict humidity-induced swelling and stiffness in hydrogels,” Soft matter 17, 9893-9900 (2021).
4. J. Kim, G. Zhang, M. Shi, and Z. Suo, “Fracture, fatigue, and friction of polymers in which entanglements greatly outnumber cross-links,” Science 374, 212-216 (2021).
5. J. M. Wimby and T. S. Berntsson, “Viscosity and density of aqueous solutions of libr, licl, znbr [sub 2], cacl [sub 2], and lino [sub 3]; 1: Single salt solutions,” J. Chem. Eng. Data; (United States) 39 (1994).
6. T. L. Bergman, A. S. Lavine, F. P. Incropera, and D. P. DeWitt, Fundamentals of heat and mass transfer, vol. 8 (Wiley Global Education US, 2018).
7. R. S. Subramanian, “Convective mass transfer,” (2014).
8. H. M. Wyss, T. Franke, E. Mele, and D. A. Weitz, “Capillary micromechanics: Measuring the elasticity of microscopic soft objects,” Soft Matter 6, 4550-4555 (2010).
9. E. Geissler and A. M. Hecht, “E. Geissler and A. M. Hecht: The Poisson Ratio in Polymer Gels,” Macromolecules 14, 466-466 (1981).
10. D. C. Andrei, B. J. Briscoe, P. F. Luckham, and D. R. Williams, “Deformation of Gel Particles,” in Modern Aspects of Colloidal Dispersions, (Springer Netherlands, Dordrecht, 1998), pp. 15-24.
11. H. Mittal, A. Al Alili, and S. M. Alhassan, “Adsorption isotherm and kinetics of water vapors on novel superporous hydrogel composites,” Microporous Mesoporous Mater. 299, 110106 (2020).
12. B. Işuk, “Swelling behavior and determination of diffusion characteristics of acrylamide-acrylic acid hydrogels,” J. applied polymer science 91, 1289-1293 (2004).
13. T. Jayaramudu, H.-U. Ko, H. C. Kim, J. W. Kim, and J. Kim, “Swelling behavior of polyacrylamide-cellulose nanocrystal hydrogels: swelling kinetics, temperature, and ph effects,” Materials 12, 2080 (2019).
14. S. Skelton, M. Bostwick, K. O'Connor, S. Konst, S. Casey, and B. P. Lee, “Biomimetic adhesive containing nanocomposite hydrogel with enhanced materials properties,” Soft Matter 9, 3825-3833 (2013).
15. D. Bratsun, A. Mizev, E. Mosheva, L. Pismen, R. Siraev, and A. Shmyrov, “On mechanisms of mixing by forced and natural convection in microfluidic devices,” in Journal of Physics: Conference Series, vol. 1809 (IOP Publishing, 2021), p. 012001.
16. M. G. Bowler, D. R. Bowler, and M. W. Bowler, “Raoult's law revisited: accurately pre-dicting equilibrium relative humidity points for humidity control experiments,” J. applied crystallography 50, 631-638 (2017).
17. W. M. Haynes, CRC handbook of chemistry and physics (CRC press, 2016).
18. M. H. Sharqawy, J. H. Lienhard, and S. M. Zubair, “Thermophysical properties of seawater: a review of existing correlations and data,” Desalination water treatment 16, 354-380 (2010).
19. Y. Kaita, “Thermodynamic properties of lithium bromide-water solutions at high temperatures,” Int. J. refrigeration 24, 374-390 (2001).
20. Y. Guo, W. Guan, C. Lei, H. Lu, W. Shi, and G. Yu, “Scalable super hygroscopic polymer films for sustainable moisture harvesting in arid environments,” Nat. communications 13, 1-7 (2022).
21. G. Graeber, C. D. Díaz-Marín, L. C. Gaugler, Y. Zhong, B. E. Fil, X. Liu, and E. N. Wang, “Extreme water uptake of hygroscopic hydrogels through maximized swelling-induced salt loading,” Adv. Mater. p. 2211783 (2023).
22. S. Kubota, S. Ozaki, J. Onishi, K. Kano, and O. Shirai, “Selectivity on ion transport across bilayer lipid membranes in the presence of gramicidin a,” Anal. Sci. 25, 189-193 (2009).
23. W. Research, “WeatherData,” https://reference.wolfram.com/language/ref/WeatherData.html (2014). [version 13.0].
24. “Global solar atlas 2.0,” https://globalsolaratlas.info/.
25. K. Willett, R. Dunn, J. Kennedy, D. Berry, P. Thorne, S. Bell, M. de Podesta, D. Parker, P. Jones, and C. Williams Jr., “Hadisdh.blend: gridded global monthly land and ocean surface humidity data version 1.3.0.2021f,” (2022).
26. “Global wind atlas 3.0,” https://globalwindatlas.info/.

### Example 6

### Single-Layer Capture Approach

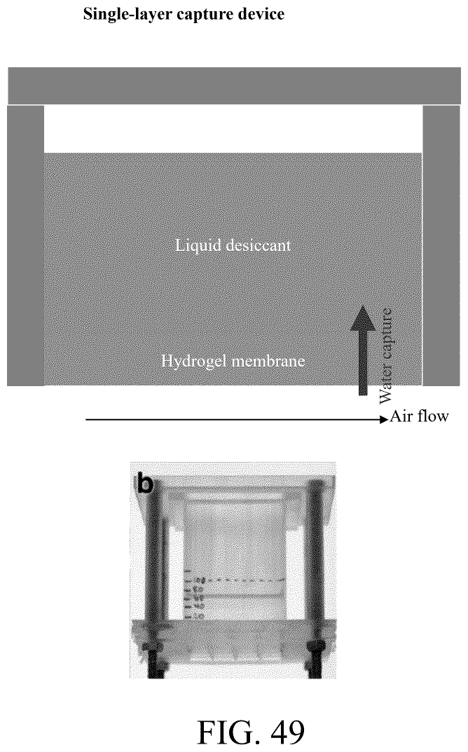

An exemplary approach to atmospheric water harvesting involves flowing atmospheric air across a hydrogel membrane. As shown in FIG. 49, a simple, single-layer approach has a single hydrogel membrane with a liquid desiccant above. As air flows (arrow) underneath the hydrogel membrane, water vapor that exists in the air due to finite relative humidity is condensed onto the hydrogel membrane, diffuses through the membrane, and is captured into the liquid desiccant. This capture process occurs as long as the equilibrium relative humidity of the liquid desiccant is lower than the ambient relative humidity. This adds to the observed volume of the liquid desiccant solution due to the capture of water. The captured water can subsequently be released through a distillation process of the liquid desiccant (not shown). This single-layer approach was realized at bench scale that we previously disclosed in our original patent application (FIG. 8b). The relevant performance metric for water capture for a single-layer device would be mass of water captured per device footprint area per unit time (e.g., kg/m²/day).

### Multi-Layer Capture Approach

In our evolution of this atmospheric water harvesting approach, we now incorporate multiple hydrogels as shown in FIG. 42. With multiple hydrogels, the available surface area for water capture can be multiplied, magnifying the water capture rate. The same liquid desiccant is in contact with all hydrogel membranes; thus, each membrane captures water independently and contributes to the same liquid desiccant storage basin. Whereas the single-layer device used a performance metric of water mass captured per device footprint area per unit time, the multi-layer device performance can be quantified as mass of water captured per unit device volume per unit time (e.g., kg/m³/day).

A Complete Device with Distillation

To build a complete water harvesting device that not only captures water, but also distills it into pure water, additional components can be incorporated, as shown in FIG. 46. A fan blowing air across the stack of hydrogel membranes can speed up air flow and thereby increase water capture rate. The fan can also act to cool the liquid desiccant to ensure that the chemical potential of water within the liquid desiccant is low enough to continue capture. The fan can also act to cool the liquid desiccant to remove heat from condensation during distillation. A peristaltic pump can circulate the liquid desiccant in order to ensure that concentrations and temperatures are uniform as well as to ensure fast capture by continuously refreshing the desiccant adjacent to the hydrogels. Captured water, as before, adds to the desiccant solution volume, which will fill up into a distillation chamber. An annular counterflow heat exchanger feeds desiccant up to the distillation chamber, preheating the desiccant with the heat from condensing water in the condenser tube. The preheated desiccant is further heated to boiling and vaporized. The water vapor is subsequently condensed by the condenser tube that is oriented vertically such that condensed (distilled) water runs down it and out of the device. In this case, the heat is provided by a cartridge heater; however, other sources of heat that could bring the temperature to the boiling point of liquid desiccant solution (˜150° C.) can be used.

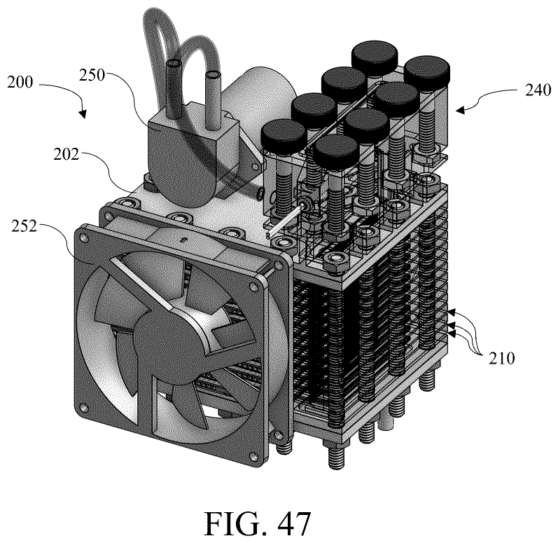

A perspective view of an exemplary device as disclosed is shown in FIG. 47. The operation of the device can self-regulating such that distillation only occurs once the liquid desiccant level is above a minimum amount and capture only occurs if the level is below a maximum amount. Distillation can be controlled by the heater while capture is controlled by the fan. Exemplary control logic is depicted in FIGS. 48A-C. The system can provide distillation can only occur if the liquid level is above the cartridge heater to inhibit heater burnout. Capture can be turned off (by turning off fans) below a maximum amount to prevent overfill with solution.

### Example 7

With the highest gravimetric energy density of all known, non-nuclear fuels, hydrogen holds immense promise as a sustainable energy carrier [1], especially for the transportation sector. Vehicles require large energy densities to provide adequate travel ranges and high power densities to provide ample speeds. While electric vehicles certainly hold promise as part of a future, greener transportation portfolio, automotive companies are also increasingly investing in technology with recent influx of patent filings [2]. There has also been an increasing interest in using hydrogen in internal combustion engines owing to their superior engine performance [3].

Separately, hydrogen has been touted as a possible grid storage solution with some advantages over battery-based storage [4]. With the increasing penetration of renewable energy sources into the grid, their intermittent nature introduces new challenges for reliable grid delivery. Without a doubt, increased storage and dispatchability will need to be a part of the future electric grid. For hydrogen-based grid storage to work, however, it must be massively scalable and affordable. Currently, hydrogen storage has high investment cost and low round trip efficiency [5].

Sourcing hydrogen sustainably also remains a challenge. A round 96% of hydrogen is currently sourced from fossil fuels [6] through reforming processes. However, carbon monoxide or dioxide is still generated as a byproduct in these processes. This carbon is either emitted (“grey hydrogen”) or captured and stored (“blue hydrogen”). Additionally, on a well-to-gate life cycle basis, conventional steam reforming of natural gas leads to “grey hydrogen” with a carbon footprint of ˜114 g CO2 eq/MJ from produced H2 [7]. A truly “green hydrogen” approach is one in which water is used as a feedstock (as opposed to a carbon-based compound) and renewable electricity is used to convert that water into hydrogen via electrolysis with oxygen as a byproduct as shown in FIG. 1. Life cycle assessments of various water electrolysis pathways for hydrogen production have produced a range of results, with some carbon footprints that are two orders of magnitude below that of hydrogen from natural gas steam reforming [7]. In addition to clear advantages in sustainability, green hydrogen can also provide a means to generate hydrogen in regions with limited access to fossil-fuel sources. The main ingredients necessary for green hydrogen are renewably produced electricity and water.

However, in our regions in the western US, water is a scarce resource (FIG. 2a). Water is a vital substance typically collected from freshwater surface resources (e.g., lakes and rivers), and, in the context of climate change, arid regions are experiencing worsening water-scarcity challenges [8]. In the Central Valley of California, the water demands for agricultural activities that produce over ¼th of the US food supply comprise 20% of the total US groundwater withdrawals [9] and the groundwater consumption rate has been increasing since 2003 as drought worsened in the state and limited surface freshwater supply, leading to falling water tables and wells running dry. In Southern Nevada, the fragility of the water supply has driven aggressive conservation efforts since 2002 that have cut per-capita consumption by one half. Y et, despite these conservation efforts, population growth and climate change continue to diminish the region's water supply [11-13] to the lowest levels in 1,200 years [14]. Las Vegas, like much of the western US, has extremely little rainfall—a mere 6 cm per year. To produce hydrogen from water, about 9 kg of water is needed for every kg of hydrogen produced stoichiometrically [15]. Ordinarily, this would be sup-plied through existing surface water resources. However, California and Nevada are under enormous water stress given their arid climates, high water demand, and interstate water competition [16]. With the prospect of increased water controls in the future, there is a need to use water from alterative resources. We seek to develop a green electrolytic technique that sources water from the atmosphere, thereby avoiding added water demand to the water-scarce region.

The atmosphere holds a vast quantity of water, even in arid environments. As a result, this makes atmospheric sourcing in arid environments highly favorable. This resource is also sustainable as it is constantly being refreshed through the water cycle where water molecules in the air have an average residence time of around nine days [17]. Even over the state of Nevada, the driest state in the US, there is approximately 3*10¹¹ gallons of water in the air above it (NASA data [18]). Considering the typical residence time of water vapor in the atmosphere, this translates to about 1013 gallons of water being refreshed over Nevada per year. To understand the energy potential that is available if all this water is converted to hydrogen-assuming 120 M J/kgH₂ and 9 kg of H₂O per kg of H₂—this translates to around 18 TW of power, which is about three orders of magnitude higher than the entire state's average electricity consumption of 4 GW, indicating that atmospheric water harvesting has the potential to meet regional energy needs without substantially interfering with the ecosystem services met by atmospheric moisture. Thus, the atmosphere, even in an arid environment, is a practically limitless source of energy that is sustainably refreshed through the natural water cycle. While we are not advocating for a total conversion to a hydrogen economy in the region, we believe that sustainably sourced hydrogen with storage should be included in a future, greener energy technology portfolio to provide high-density fuels in remote environments and provide additional grid security.

Clean hydrogen can play an integral role in decarbonizing our energy portfolio by (1) providing dispatchable grid storage for a future greener grid and (2) serving as energy-dense fuels for the transportation sector. Here, in the Western US and specifically in California and Nevada, the need for dispatchable grid storage is especially high given the large fraction of renewable solar and wind energy sources that provide intermittent power and face curtailment when supply exceeds demand [19]. In addition, aggressive legislation in the region towards a fully renewable-powered fleet necessitates smarter grids and storage. Fully decarbonizing electricity in Nevada by 2050 will require similarly reliable baseload power alter-natives to natural gas and coal which provide ˜56% and ˜5% of the electricity generated in the state, respectively [20]. California's goal of 100% renewable energy by 2045 will also require non-intermittent electricity to replace the 50.2% of its in-state generation sourced from natural gas [22]. California and Nevada are also home to some of the most trafficked freight corridors in the country [23]; a switch toward energy-dense hydrogen powered freight vehicles would make a large impact on reducing carbon emissions.

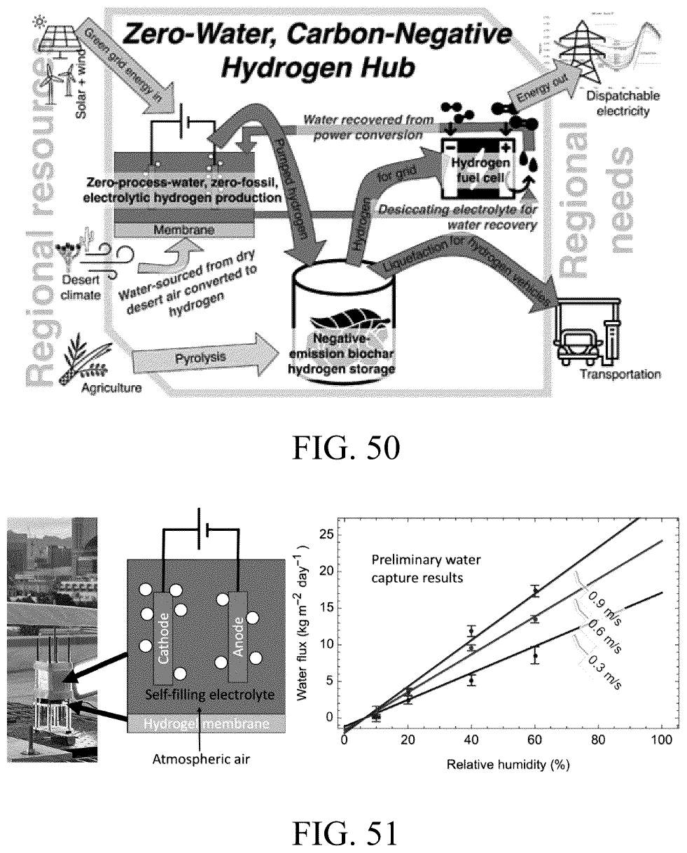

To solve this issue, disclosed herein is a negative-emission hydrogen hub as shown in FIG. 50 utilizing clean electrolytic hydrogen production with atmospherically sourced water. negative-emission activated biochar adsorbents for grid-scale hydrogen storage), and water-recovering fuel cells for grid energy production. By developing intelligent control strategies to enable these systems to work in tandem, these transformative capabilities leverage regional resources of solar (California and Nevada have some of the highest solar penetration in the country [24]) and biomass (California has the largest agricultural and biomass production [25]), while avoiding added strain on limited water resources in these drought-prone states. Disclosed herein is a prototype with an easily scalable design to a pilot scale of 1 KW of power delivery and 6 kWh of storage.

To produce hydrogen cleanly through electrolysis (water-splitting), substantial amounts of water are needed. Our approach is to utilize a hydroxide salt solution to capture water from the air, owing to its extreme hygroscopicity, through our novel hydrogel membrane with class-leading water capture performance (preliminary results in FIG. 4 that can be vertically scaled. This salt solution also serves as an electrolyte where hydrogen and oxygen evolve on electrodes as electricity is applied. Our production goal is 10 kg of hydrogen per square meter of device footprint per day (333 kWh/m²/day requiring 90 L/m²/day of atmospheric water capture) while maintaining a cell voltage below 2 volts and >95% Faradaic efficiency.

This production rate would exceed previously demonstrated atmospheric hydrogen production by nearly two orders of magnitude and require less land than existing fossil-fuel-based methods [27].

All publications and patent applications mentioned in the specification are indicative of the level of those skilled in the art to which this invention pertains. All publications and patent applications cited in the specification are herein incorporated by reference to the same extent as if each individual publication or patent application was specifically and individually indicated to be incorporated by reference.

### Exemplary Aspects

In view of the described products, systems, and methods and variations thereof, herein below are described certain more particularly described aspects of the invention. These particularly recited aspects should not however be interpreted to have any limiting effect on any different claims containing different or more general teachings described herein, or that the “particular” aspects are somehow limited in some way other than the inherent meanings of the language literally used therein.

Aspect 1. An atmospheric water capturing device for transforming water vapor into liquid water, the device comprising:
a housing including an inlet configured to receive ambient atmosphere; and
a basin disposed within the housing, the basin comprising:
   a first section configured to wick water from the received ambient atmosphere, at least one channel configured to store an ionic solution and the water wicked by the first section, and
   a second section configured to evaporate water stored in the at least one channel.

Aspect 2. The device of aspect 1, further comprising an outlet configured to dispense the evaporated water from the second section.

Aspect 3. The device of aspect 2, further comprising a condensing tube connected to the outlet and configured to condense the evaporated water from the outlet.

Aspect 4. The device of aspect 3, further comprising a reservoir connected to the condensing tube and configured to store the condensed water.

Aspect 5. The device of any one of the preceding aspects, further comprising an air cooling mechanism configured to cool the received ambient atmosphere.

Aspect 6. The device of any one of the preceding aspects, further comprising a heater configured to heat the second section of the basin.

Aspect 7. The device of any one of the preceding aspects, wherein the basin further comprises a thermal insulator surrounding the at least one channel.

Aspect 8. The device of any one of the preceding aspects, wherein the at least one channel includes a porous hydrogel infused with the ionic solution.

Aspect 9. The device of any one of the preceding aspects, wherein the ionic solution is lithium bromide.

Aspect 10. The device of any one of the preceding aspects, wherein the first section comprises a capturing gel.

Aspect 11. The device of any one of the preceding aspects, wherein the second section comprises an evaporating gel.

Aspect 12. The device of any one of the preceding aspects, wherein the basin is configured to distill water vapor from the received ambient atmosphere.

Aspect 13. A method comprising:
capturing atmospheric water with an atmospheric water capturing device, the atmospheric water capturing device comprising:
   a housing including an inlet configured to receive ambient atmosphere; and
   a basin disposed within the housing, the basin comprising:
      a first section configured to wick water from the received ambient atmosphere,
      at least one channel configured to store an ionic solution and the water wicked by the first section, and
      a second section configured to evaporate water stored in the at least one channel.

Aspect 14. The method of aspect 13, wherein the capturing atmospheric water comprises:
receiving ambient atmosphere through the inlet;
cooling the received ambient atmosphere;
diffusing, via the first section, water from the received ambient atmosphere; and
storing the water in the at least one channel.

Aspect 15. The method of aspect 13 or aspect 14, wherein the atmospheric water capturing device further comprises an outlet, wherein the outlet dispenses the evaporated water from the second section.

Aspect 16. The method of aspect 15, wherein the atmospheric water capturing device further comprises a condensing tube connected to the outlet, wherein the condensing tube condenses the evaporated water from the outlet.

Aspect 17. The method of aspect 16, wherein the atmospheric water capturing device further comprises a reservoir connected to the condensing tube, wherein the reservoir stores the condensed water.

Aspect 18. The method of any one of aspects 13-17, wherein the atmospheric water capturing device further comprises an air cooling mechanism, wherein the air cooling mechanism cools the received ambient atmosphere.

Aspect 19. The method of any one of aspects 13-18, wherein the atmospheric water capturing device further comprises a heater, wherein the heater heats the second side of the basin.

Aspect 20. The method of any one of aspects 13-19, wherein the basin of the atmospheric water capturing device further comprises a thermal insulator surrounding the at least one channel.

Aspect 21. The method of any one of aspects 13-20, wherein the at least one channel of the atmospheric water capturing device includes a porous hydrogel infused with the ionic solution.

Aspect 22. The method of any one of aspects 13-21, wherein the ionic solution is lithium bromide.

Aspect 23. The method of any one of aspects 13-22, wherein the first section comprises a capturing gel.

Aspect 24. The method of any one of aspects 13-23, wherein the second section comprises an evaporating gel.

Aspect 25. The method of any one of aspects 13-24, wherein the basin of the atmospheric water capturing device distills water vapor from the received ambient atmosphere.

Aspect 26. The method of any one of aspects 13-25, further comprising cooling the received ambient atmosphere.

Aspect 27. The method of any one of aspects 13-26, further comprising:
heating the second side of the basin;
evaporating, via the second section, water stored in the at least one channel; and
condensing the evaporated water.

Aspect 28. The method of aspect 27, wherein the steps of diffusing water from the received ambient atmosphere and condensing evaporated water occur concurrently.

Aspect 29. The device of any one of aspects 1-12, wherein the device is powered by natural solar energy.

Aspect 30. The device of aspect 29, wherein the device does not comprise an electric power adapter.

Aspect 31. A device comprising:
a solid-state iongel condenser configured to condense water vapor; and
a liquid desiccant contacting the solid-state iongel condenser configured to capture the condensed water vapor.

Aspect 32. The device of aspect 31, wherein the device is located within an aircraft carrier cockpit.

Aspect 33. The device of aspect 31 or aspect 32, wherein the solid-state iongel condenser is a hydrogel material.

Aspect 34. The device of aspect 33, wherein the hydrogel material is water-absorbing polymeric material.

Aspect 35. The device of any one of aspects 31-34, wherein the liquid desiccant is a salt solution.

Aspect 36. A method of condensing and capturing water vapor using the device of any of aspects 31-35.

Aspect 37: An atmospheric water capturing device for transforming water vapor into liquid water, the device comprising:
a plurality of channels;
a plurality of porous water-permeable membranes, each porous water-permeable membrane having a surface that at least partly defines a respective channel of the plurality of channels; and
a liquid desiccant in contact with a side of each porous water-permeable membrane opposite the surface of the porous water-permeable membrane that at least partly defines the respective channel.

Aspect 38: The device of aspect 37, wherein the liquid desiccant is a salt solution.

Aspect 39: The device of aspect 37 or aspect 38, further comprising a fan configured to circulate airflow through the plurality of channels.

Aspect 40: The device of any one of aspects 37-39, wherein the plurality of channels comprise at least five channels.

Aspect 41: The device of any one of aspects 37-40, wherein respective pairs of porous water-permeable membranes of the plurality of porous water-permeable membranes at least partly define each passage of the plurality of passages.

Aspect 42: The device of any one of aspects 37-41, further comprising a housing that contains the liquid desiccant.

Aspect 43: The device of any one of aspects 37-42, further comprising a pump configured to circulate the liquid desiccant within the housing.

Aspect 44: The device of any one of aspects 37-43, further comprising:
a distillation chamber;
a heater configured to heat the liquid desiccant in the distillation chamber; and
a conduit,
wherein at least one surface of the distillation chamber is configured to direct condensate into the conduit.

Aspect 45: The device of any one of aspects 37-44, wherein an outer surface of the conduit is in thermal communication with the liquid desiccant.

Aspect 46: The device of any one of aspects 37-45, further comprising:
a pump configured to circulate the liquid desiccant within the housing;
a heater configured to heat the liquid desiccant;
a high level sensor;
a low level sensor; and
a controller in communication with the fan, the heater, and the first and second level sensors, wherein the controller is configured to control operation of the fan and the pump based on feedback from the first and second level sensors.

Aspect 47: The device of aspect 46, wherein the controller is configured to slow or stop the fan upon detection of the liquid desiccant reaching the high level sensor.

Aspect 48: The device of aspect 46 or aspect 47, wherein the controller is configured to reduce or stop current to the heater upon the low level sensor detecting of the liquid desiccant being at or below the low level sensor.

Aspect 49: The device of any one of aspects 37-, wherein each porous water-permeable membrane of the porous water-permeable membranes comprises hydrogel.

Aspect 50: The device of any one of aspects 37-, wherein each porous water-permeable membrane of the porous water-permeable membranes comprises a solid-state iongel condenser.

Aspect 51: The device of aspect 50, wherein each solid-state iongel condenser comprises porous hydrogel infused with the ionic solution.

Aspect 52: The device of aspect 50, wherein the ionic solution is lithium bromide.

Aspect 53: An atmospheric water capturing device for transforming water vapor into liquid water, the device comprising:
a plurality of channels;
a plurality of hydrogel membranes, each hydrogel membrane having a surface that at least partly defines a respective channel of the plurality of channels; and
a housing that is configured to contain a liquid desiccant so that the liquid desiccant is in contact with a side of each hydrogel membrane opposite the surface of the hydrogel membrane that at least partly defines the respective channel.

Aspect 54: A method of using the atmospheric water capturing device as in any one of the preceding claims, the method comprising:
capturing atmospheric water with the atmospheric water capturing device.

Aspect 55: The method of claim 54, wherein capturing the atmospheric water comprises:
moving the atmospheric water through the plurality of water permeable membranes;
storing the atmospheric water in the liquid desiccant; and
distilling the atmospheric water from the liquid desiccant.

Aspect 56: The method of claim 54 or 55, wherein capturing the atmospheric water comprises:
operating a fan to move air through the plurality of channels;
operating a pump to circulate the liquid desiccant through the device; and
operating a heater to distill the atmospheric water from the liquid desiccant.

Although the foregoing invention has been described in some detail by way of illustration and example for purposes of clarity of understanding, certain changes and modifications may be practiced within the scope of the appended claims.

What is claimed is:

1. An atmospheric water capturing device for transforming water vapor into liquid water, the device comprising:
a plurality of channels;
a plurality of porous water-permeable membranes, each porous water-permeable membrane having a surface that at least partly defines a respective channel of the plurality of channels; and
a liquid desiccant in contact with a side of each porous water-permeable membrane opposite the surface of the porous water-permeable membrane that at least partly defines the respective channel.

2. The device of claim 1, wherein the liquid desiccant is a salt solution.

3. The device of claim 1, further comprising a fan configured to circulate airflow through the plurality of channels.

4. The device of claim 1, wherein the plurality of channels comprise at least five channels.

5. The device of claim 1, wherein respective pairs of porous water-permeable membranes of the plurality of porous water-permeable membranes at least partly define each passage of the plurality of passages.

6. The device of claim 1, further comprising a housing that contains the liquid desiccant.

7. The device of claim 6, further comprising a pump configured to circulate the liquid desiccant within the housing.

8. The device of claim 1, further comprising:
a distillation chamber;
a heater configured to heat the liquid desiccant in the distillation chamber; and
a conduit,
wherein at least one surface of the distillation chamber is configured to direct condensate into the conduit.

9. The device of claim 8, wherein an outer surface of the conduit is in thermal communication with the liquid desiccant.

10. The device of claim 1 further comprising:
a pump configured to circulate the liquid desiccant within the housing;
a heater configured to heat the liquid desiccant;
a high level sensor;
a low level sensor; and
a controller in communication with the fan, the heater, and the first and second level sensors, wherein the controller is configured to control operation of the fan and the pump based on feedback from the first and second level sensors.

11. The device of claim 10, wherein the controller is configured to slow or stop the fan upon detection of the liquid desiccant reaching the high level sensor.

12. The device of claim 10, wherein the controller is configured to reduce or stop current to the heater upon the low level sensor detecting of the liquid desiccant being at or below the low level sensor.

13. The device of claim 1, wherein each porous water-permeable membrane of the porous water-permeable membranes comprises hydrogel.

14. The device of claim 1, wherein each porous water-permeable membrane of the porous water-permeable membranes comprises a solid-state iongel condenser.

15. The device of claim 14, wherein each solid-state iongel condenser comprises porous hydrogel infused with the ionic solution.

16. The device of claim 15, wherein the ionic solution is lithium bromide.

17. An atmospheric water capturing device for transforming water vapor into liquid water, the device comprising:
a plurality of channels;
a plurality of hydrogel membranes, each hydrogel membrane having a surface that at least partly defines a respective channel of the plurality of channels; and
a housing that is configured to contain a liquid desiccant so that the liquid desiccant is in contact with a side of each hydrogel membrane opposite the surface of the hydrogel membrane that at least partly defines the respective channel.

18. A method comprising:
capturing atmospheric water with an atmospheric water capturing device comprising:
a plurality of channels;
a plurality of porous water-permeable membranes, each porous water-permeable membrane having a surface that at least partly defines a respective channel of the plurality of channels; and
a liquid desiccant in contact with a side of each porous water-permeable membrane opposite the surface of the porous water-permeable membrane that at least partly defines the respective channel.

19. The method of claim 17, wherein capturing the atmospheric water comprises:
moving the atmospheric water through the plurality of water permeable membranes;
storing the atmospheric water in the liquid desiccant; and
distilling the atmospheric water from the liquid desiccant.

20. The method of claim 17, wherein capturing the atmospheric water comprises:
operating a fan to move air through the plurality of channels;
operating a pump to circulate the liquid desiccant through the device; and
operating a heater to distill the atmospheric water from the liquid desiccant.
